(19) United States
(12) Patent Application Publication
(10) Pub. No.: US 2012/0128138 A1
(43) Pub. Date: May 24, 2012

(54) Telephone call handling system

(76) Inventor: Christopher Guy Williams, Spokane, WA (US)

(21) Appl. No.: 13/374,419

(22) Filed: Dec. 28, 2011

Related U.S. Application Data
(63) Continuation-in-part of application No. 13/136,520, filed on Aug. 3, 2011.
Application No. 13/136,520 is a continuation-in-part of application No. 12/802,685, filed on Jun. 12, 2010.
Application No. 12/802,685 is a continuation-in-part of application No. 12/658,475, filed on Feb. 4, 2010.

(51) Int. Cl. H04M 11/06

(52) U.S. Cl. 379/93.01

(57) ABSTRACT

A telephone call handling system includes a sendings receiver configured to receive sendings sent from the telephones of other party's via a telephone service. A sendings registry automatically inventories each received sending and forwards the inventoried sending to a storage where the sending is stored. Subsequently, a delivery trigger is triggered. The triggered trigger initiates a sendings provider to provide one or more of the inventoried and stored sendings to a deliverer. The deliverer then delivers the provided sending or sendings to one or more of: a speaker, a display, a text message display, an image display, a video display, an email delivery, an web-site poster, a service provider delivery, a delivery port, a ring-back delivery, a ring-back forward delivery and a ring-tone.

### CROSS REFERENCE TO RELATED APPLICATIONS

This is a continuation in part of co-pending U.S. patent application Ser. No. 13/136,520 filed Aug. 3, 2011 which is hereby incorporated by reference herein in it's entirety. U.S. patent application Ser. No. 13/136,520 filed Aug. 3, 2011 is a continuation in part of co-pending U.S. patent application Ser. No. 12/802,685 filed Jun. 12, 2010, Publication No. US-2011-0190012-A1, Publication Date: Aug. 4, 2011, which is hereby incorporated by reference herein in it's entirety. U.S. patent application Ser. No. 12/802,685 filed Jun. 12, 2010 is a continuation in part of co-pending U.S. patent application Ser. No. 12/658,475 filed Feb. 4, 2010, Publication No. US-2011-0188645-A1, Publication Date: Aug. 4, 2011 which is hereby incorporated by reference herein in it's entirety.

### BACKGROUND

A call screening service commonly known as “Caller I.D.” is widely utilized by present-day telephone users. Caller I.D. is a service provided to users by the telephone service providers via telephones typically fitted with a display. For calls from landline phones, the caller I.D. information typically displayed includes the telephone number of the landline phone a caller is calling from and the subscriber name documented to that number. For calls from mobile phones, the information typically displayed includes the telephone number of the mobile phone a caller is calling from and whatever name the mobile phone owner happens to program into his phone (or not).

Present-day, telephone users having caller I.D. typically first respond to an incoming telephone call by looking at the display. They then consider that information along with their encumbrances of that moment and mood at that moment, and decide whether to answer the call or not. If not, typically after a set number of additional rings, the incoming call is automatically transferred to a voice mail service (or answering machine for many landline phones) where the caller may leave a message to be reviewed by the user at some later time.

### SUMMARY OF THE INVENTION

The present disclosure provides for a telephone call handling system, certain embodiments of which achieve improved utilization of caller I.D. information (improved beyond a user receiving caller I.D. information and therefrom simply deciding whether to answer the phone or not). In a first example description of one embodiment, at the onset of an incoming call, caller I.D. information is provided to the user (i.e. the party being called). From the information, the user is able to essentially determine the identity of the caller and, thus, able to surmise based on the determined identity that the subject matter to be discussed may be of a nature where recording the conversation would be advantageous.

As an example of operation of this first example, the user's telephone is rung by an incoming ring signal. Delivered with the ring signal is caller I.D. information. The information is provided on a display. The user recognizes the phone number (or caller identification) on the display; i.e. the user essentially knows who's calling. The user determines that this person is someone whose conversations should be recorded (perhaps a client calling to give instructions to a professional). Accordingly, the user presses a control button. An interface responds to the pressed button by going off-hook and an out-going message sender responds to the pressed button by sending a message to the caller such as “This conversation may be recorded”. The caller hears the message and understands that any subsequent telephonic conversation with the user may be recorded.

As can be seen for this first example description of one embodiment, caller I.D. information is initially utilized to enable the user to decide whether to answer the incoming call or not. If the user decides to answer, based on the caller I.D. information the user can then decide whether or not to record the ensuing telephone conversation (or, in the alternative, based on a lack of caller I.D. information).

In a second example description of one embodiment, at the onset of an incoming call, caller I.D. information is provided to the user (i.e. the party being called). From the information, the user is able to essentially determine the identity of the caller and, thus, based on the determined identity is able to decide whether or not to pick content for delivery to the user and/or delivery to the caller. If the user decides to pick content, based on the determined identity the user is able to decide what content to pick from a plurality of content choices.

As an example of operation of this second example, at some date (or dates) prior to a telephone call between an-other party and the user, the other party sends content from his phone to the user's phone such as audio clips, text messages, images and videos. Such sendings can be received, inventoried and stored. Subsequently, the other party calls the user. Prior to answering, the user views caller I.D. information provided on a display. A plurality of icons are provided on a touch-screen. Each icon represents a received sending received prior from, and inventoried to, the calling telephone. Each icon can include the date that sending was received and the sending type, i.e. audio type, text message type, image type, video type. For this example, based on the provided caller I.D information the user decides to touch a text message type icon. In response to the touched icon, the inventoried text message sending represented by the icon is obtained from storage and dispatched to two deliverers. One of the deliverers displays the text message for the user to view. The other deliverer delivers the text message to the caller via the telephone service provider. Consequently, the text message received from the calling telephone at some date prior to the incoming call is now displayed at the user's phone for the user to view and displayed at the caller's phone for the caller to view.

As can be seen for this second example description of one embodiment, caller I.D. information is initially utilized to enable the user to decide whether or not to answer the incoming call. If the user decides to answer, based on the caller I.D. information, the user can then decide whether or nor to pick content for delivery to the user and/or to a caller (or, in the alternative, based on a lack of caller I.D. information). If the user decides not to answer, based on the caller I.D. information, the user can then decide whether or not to pick content for delivery to the user and/or to a caller (or, in the alternative, based on a lack of caller I.D. information).

The present disclosure provides for a telephone call handling system, certain embodiments of which can receive, inventory, and store sendings, said sendings subsequently delivered to the system user and/or to a caller and/or via email and/or to the internet and/or via an external port and/or as a ring-back to a caller. In an example description of one embodiment, at some date (or dates) prior to a telephone call between and other party and the user, the user has made a request to the other party. Could you send me some content? Any content would be good. Maybe a song clip or a picture of yourself or a video clip you like of perhaps your favorite poem or a good joke. I want to put you in my universe”. In response to the request, the other party sends content from his phone to the user's phone. Each of these “sendings” is received, inventoried and stored. Subsequently, a call occurs between user and other party. Upon the user dialing the other party's telephone number, the dialed telephone number is registered or upon receipt of the incoming call from the other party the calling telephone's number obtained from caller I.D. information is registered. An icon array with each icon representative of a sending inventoried to the registered telephone number (other party's number) is displayed on a touch-screen. For this example, the call is answered (either by other party or by user). While conversing, the user decides to touch one of the displayed icons, as an example, an icon comprising the date Nov. 20, 2011 and a miniature of a picture (the miniature being a reduction of the actual image stored). In response to the touched icon, the image sending represented by the icon and, thus, inventoried to the other party's telephone number, is provided, for this example, to two deliverers. The first deliverer displays the image to the user. The second deliverer delivers the image to the other party's telephone via the telephone service provider.

### BRIEF DESCRIPTION OF THE DRAWINGS

A form of the invention is illustrated in the accompanying drawings in which:

FIG. 1a is a block diagrammatic view depicting an example of a first embodiment comprised of message-then-record circuitry and a commencer.

FIG. 1b is a block diagrammatic view depicting an example of a first embodiment comprised of message-then-record circuitry, a commencer and caller I.D. circuitry.

FIG 1c is a block diagrammatic view depicting the examples of FIGS. 1a and 1b configured with a record message picker.

FIG. 1d is a block diagrammatic view depicting an example of a first embodiment comprised of message then record circuitry, a commencer and a call detector.

FIG. 2a is a block diagrammatic view depicting an example of a second embodiment comprised of a sendings receiver, a sendings registry, a storage, a sendings provider, a deliverer and a delivery trigger and wherein the provider includes an-other party address register and the trigger includes a linked trigger.

FIG. 2b is a block diagrammatic view depicting an example of a second embodiment comprised of a sendings receiver, a sendings registry, a storage, a sendings provider, a deliverer and a delivery trigger and wherein the provider includes an address register and the trigger includes a user-deploy trigger.

FIG. 2c is a block diagrammatic view depicting an example of a second embodiment comprised of a sendings receiver, a sendings registry, a storage, a sendings provider, a deliverer, a delivery trigger and a sendings picker.

FIG. 2d is a block diagrammatic view depicting an example of a second embodiment comprised of a sendings receiver, a sendings registry, a storage, a sendings provider, a deliverer, a delivery trigger and a deliverer picker.

FIG. 2e is a block diagrammatic view depicting an example of a second embodiment comprised of a sendings receiver, a sendings registry, a storage, a sendings provider, a deliverer, a delivery trigger and a sendings call-up.

FIG. 2f is a block diagrammatic view depicting an example of a second embodiment comprised of a sendings receiver, a sendings registry, a storage, a sendings provider, a deliverer, a delivery trigger and a sendings identifier.

FIG. 2g is a block diagrammatic view depicting an example of a second embodiment comprised of a sendings receiver, a sendings registry, a storage, a sendings provider, a deliverer, a delivery trigger and a user-selected sendings supplier.

FIG. 2h is a block diagrammatic view depicting an example of a second embodiment comprised of a sendings receiver, a sendings registry, a storage, a sendings provider, a deliverer, a delivery trigger and a configurator.

FIG. 2i is a block diagrammatic view depicting an example of a second embodiment comprised of a sendings receiver, a sendings registry, a storage, a sendings provider, a deliverer, a delivery trigger, a sendings picker, a deliverer picker, a sendings call-up, a sendings identifier, a user-selected sendings supplier, asendings poster supplier and a configurator.

FIG. 2j is a block diagrammatic view depicting an example of a second embodiment comprised of a sendings receiver, a sendings registry, a storage, a sendings provider, a deliverer, a delivery trigger, a sendings picker, a deliverer picker, a sendings call-up, a sendings identifier, a user-selected sendings supplier and a sendings poster supplier.

### DETAILED DESCRIPTION

Examples provided herein describe certain functionality, structure and components for the purpose of facilitating understanding of how the various disclosed embodiments can operate. However, it will be understood that the functionality, structure and components described in the examples is exemplary only, and should not be considered as limiting the scope of the embodiment to which the example applies.

The present invention pertains to telephone calls. Accordingly, a general description of telephone service is appropriate. For decades, telephone service in the U.S. was provided by an entity commonly known as “the phone company”, “Ma Bell” and “AT&T”. Deregulation broke up the giant telephone service provider into a network of service providers then commonly referred to as “the baby bells”. For this discussion, the present-day network of service providers including the circuitry they employ is referred to as a telephone service provider 121.

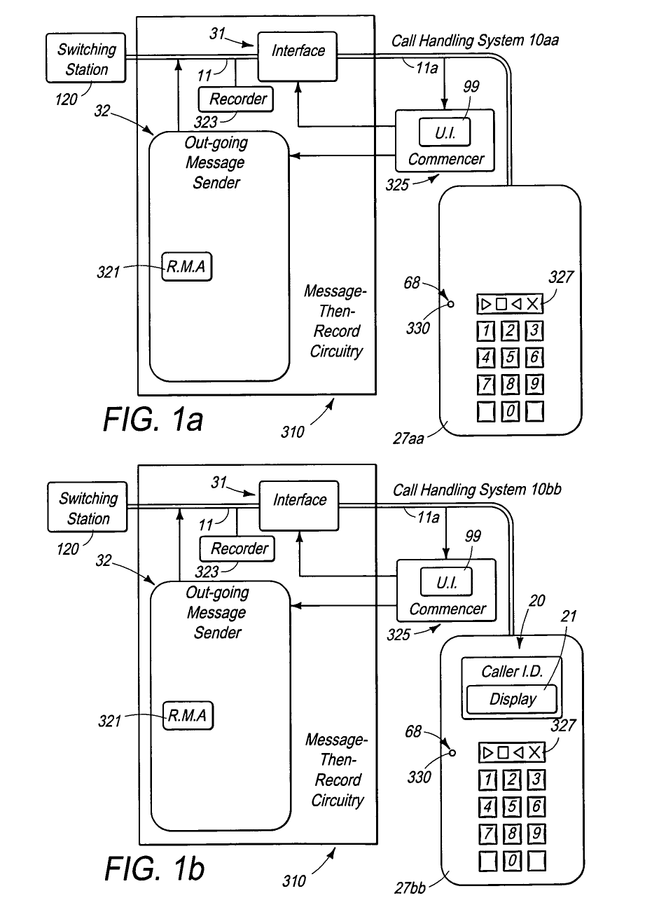

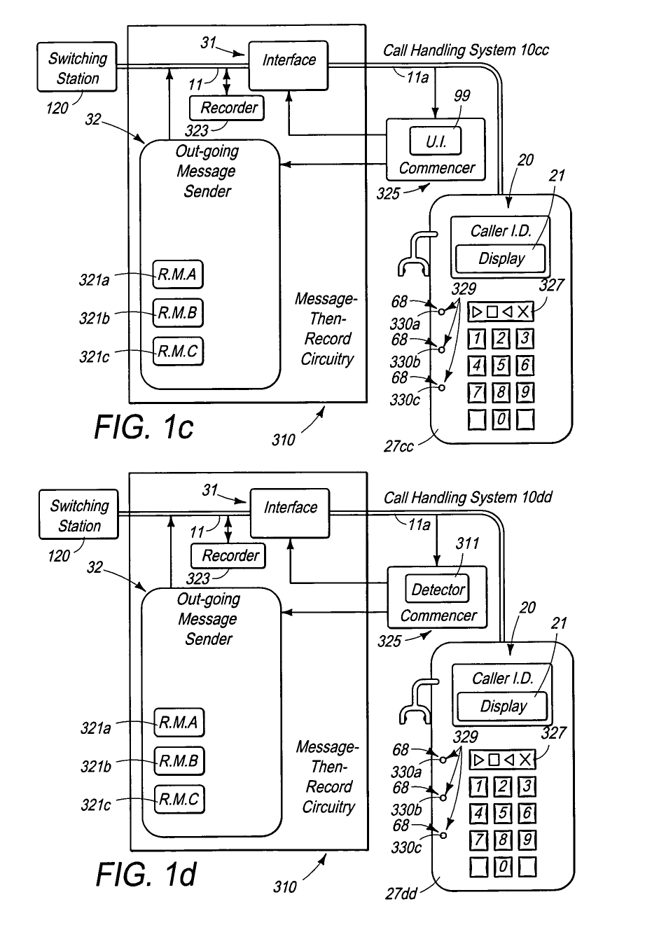

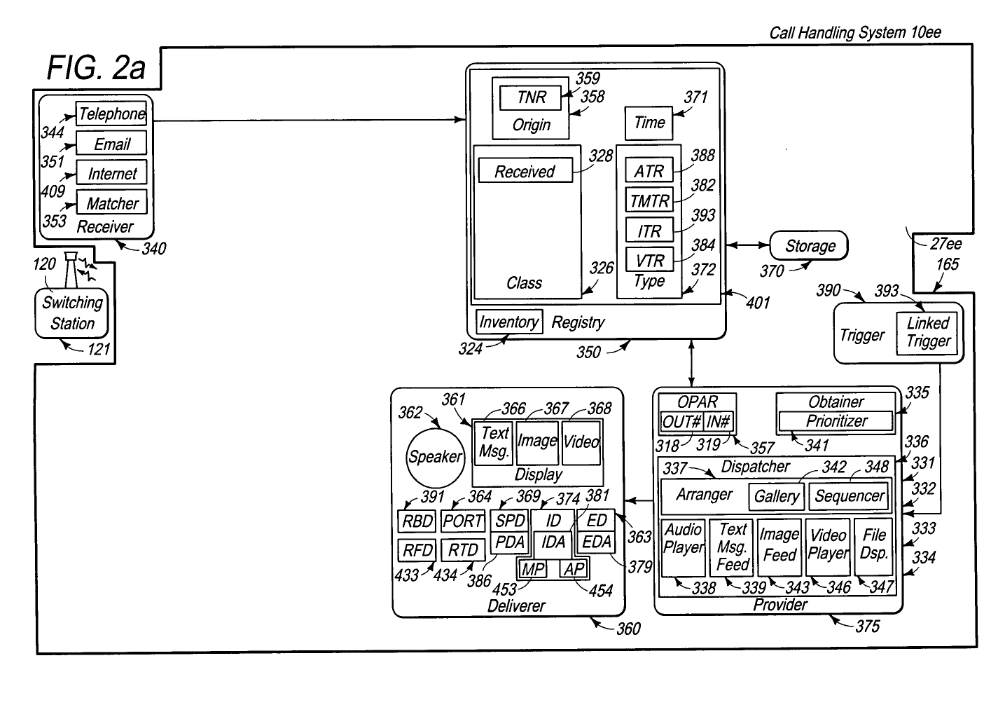

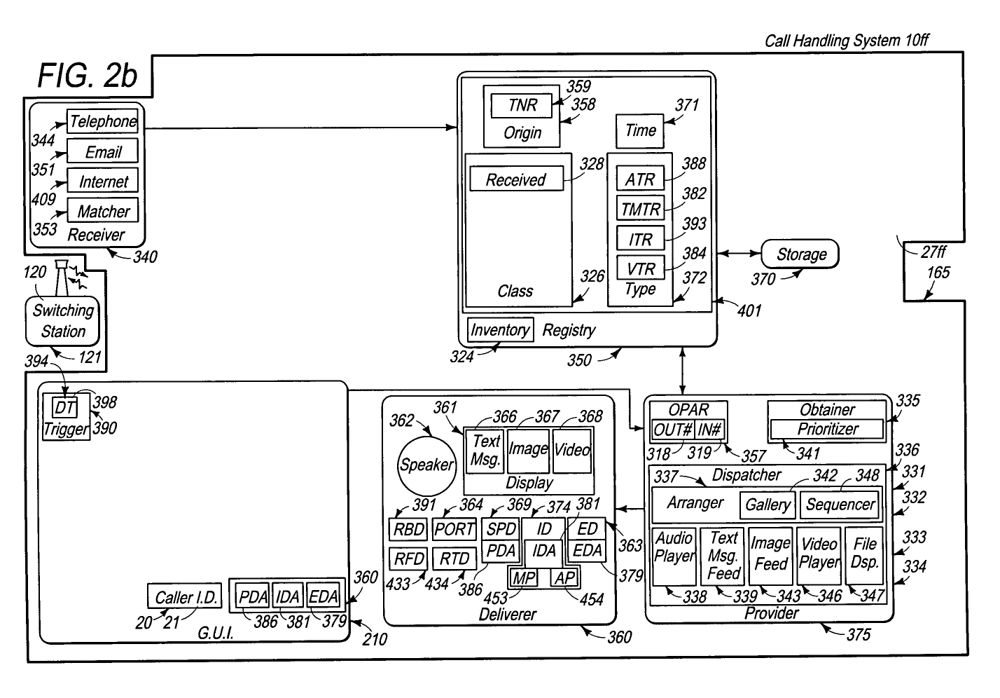

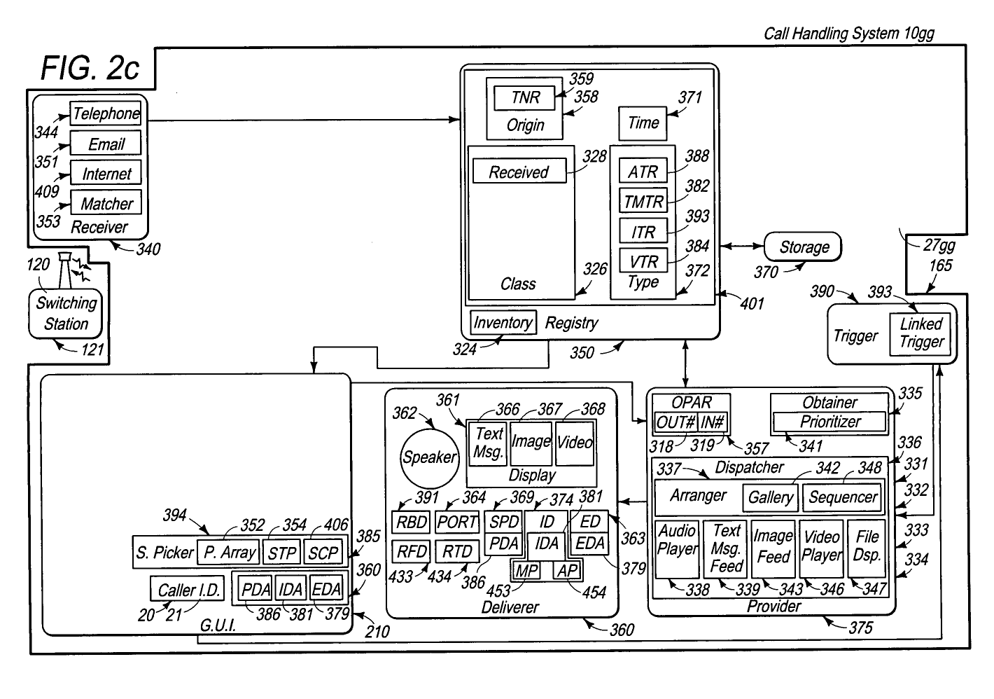

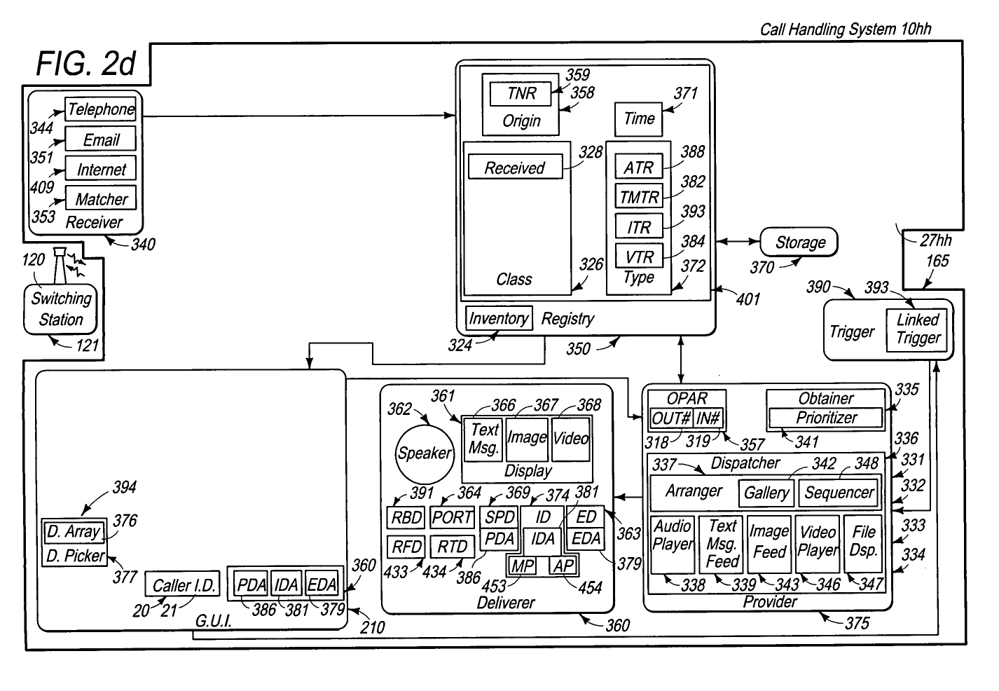

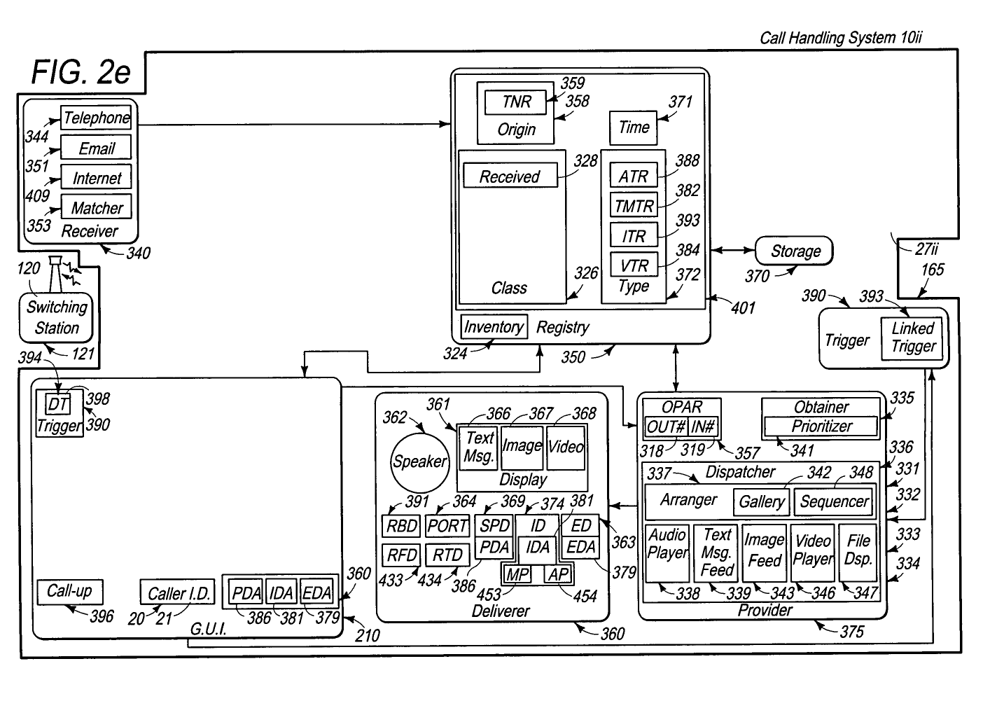

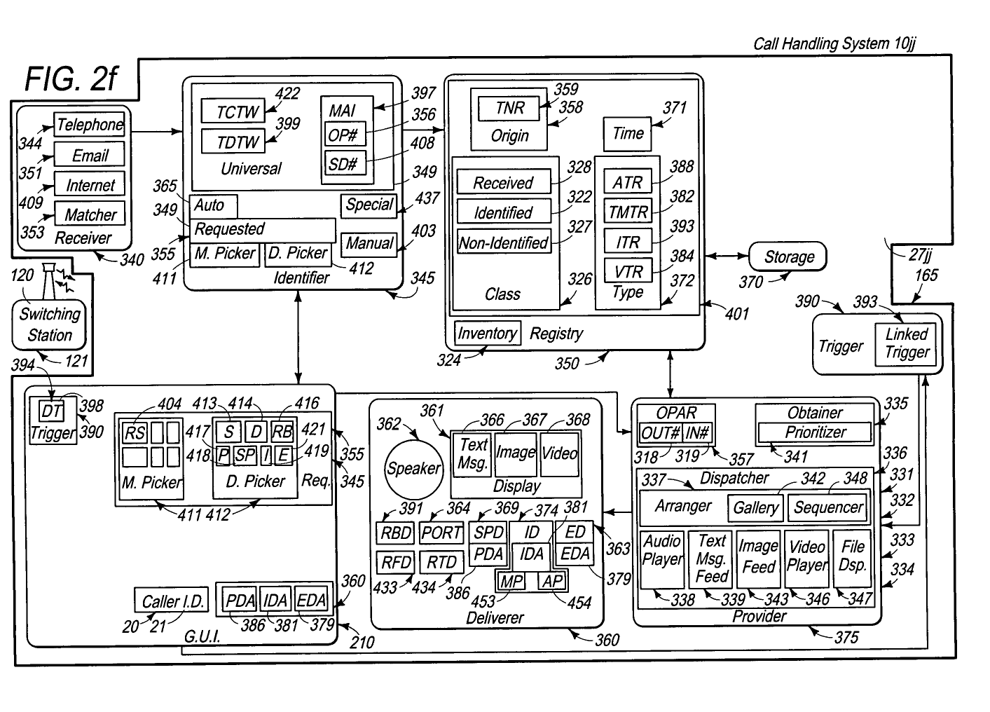

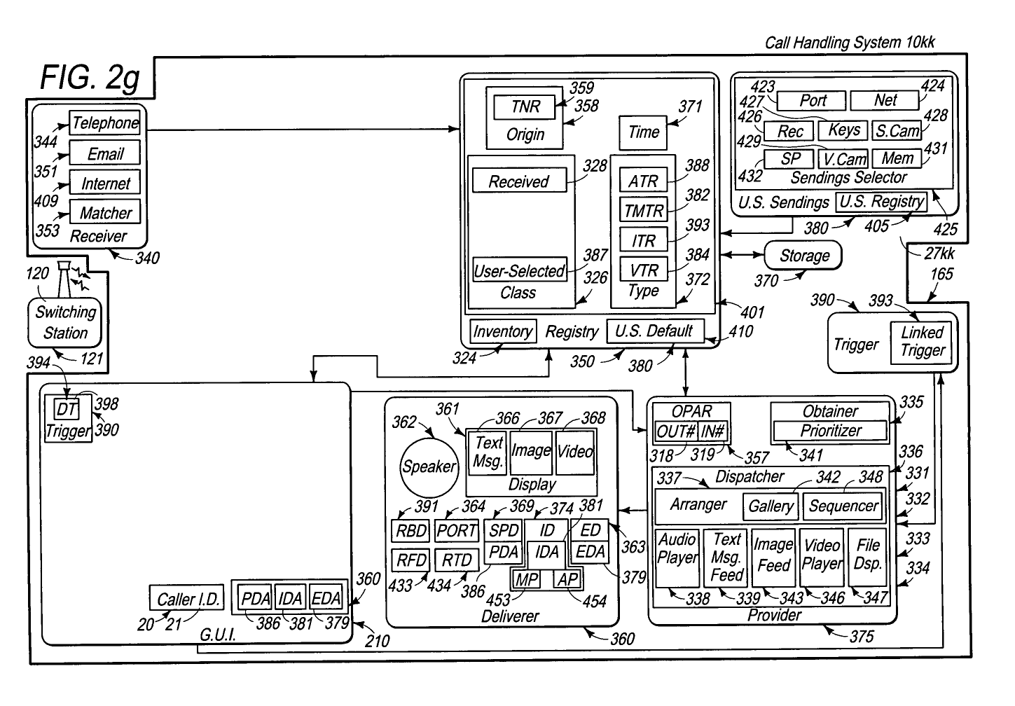

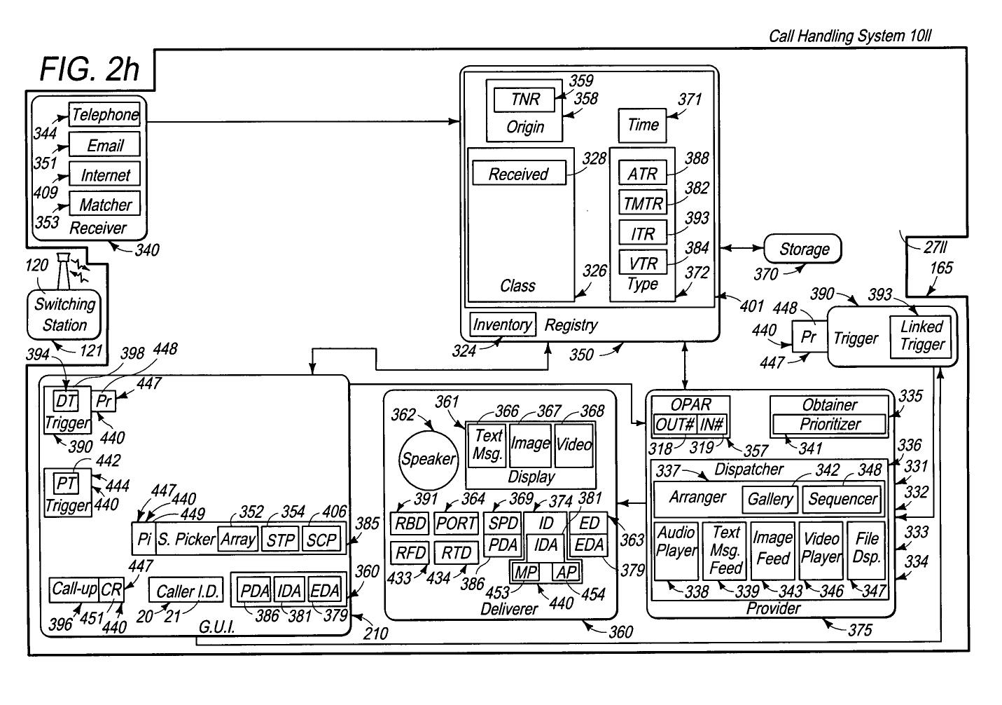

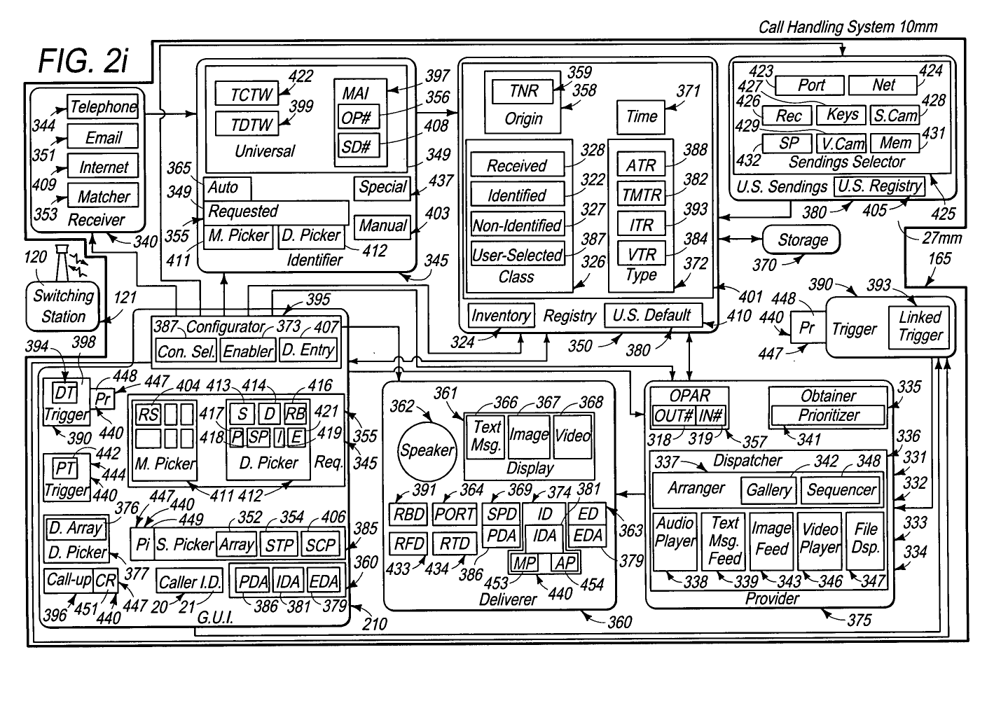

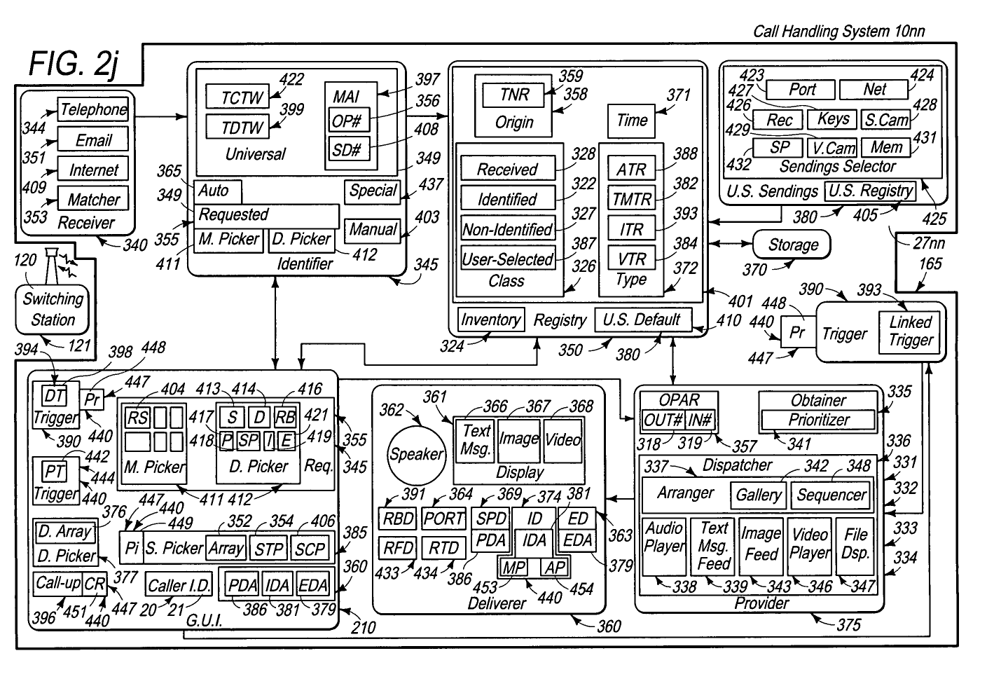

One example of circuitry that can be employed in the routing of a telephone call by service provider 121, a local switching station 120, is depicted in FIGS. 1a, 1b, 1c, 1d, 2a, 2b, 2c, 2d, 2e, 2f, 2g, 2h, 2i and 2j. One example of operation of the example circuitry will now be given. The caller places a call from the caller's phone. That call is received at a local switching station, sent over a long distance network and received at local switching station 120. Station 120 then provides a signal that rings the user's telephone, the user's telephone depicted as a telephone 27 (provided via the air-waves if telephone 27 comprises a mobile phone, provided via a telephone line 11 if telephone 27 comprises a landline telephone). If telephone 27 is answered, station 120 then communicably connects the caller's telephone with telephone 27. (If the call is a local call, station 120 would then received the call from the calling telephone and then provide the signal that rings the user's telephone.)

In another example of operation of the example circuitry, the user places a call from the user's telephone 27. That call is received at local switching station 120 (received via the air-waves if telephone 27 comprises mobile phone 165, received via telephone line 11 if telephone 27 comprises a landline telephone). Station 120 then sends the call over a long distance network to a local switching station. The local switching station provides the call to the called telephone. If the call is answered, the local switching station communicably connects the user's telephone 27 with the called telephone. (If the call is a local call, station 120 would then received the call from the user's telephone 27 and then provide a signal that rings the called telephone.)

Examples of the present invention, referred to herein as telephone call handling system 10, are illustrated in the accompanying FIGS. 1a through 2j. In example handling systems 10aa through 10dd telephone 27 is depicted comprising a landline telephone. In example handling systems 10ee through 10nn telephone 27 is depicted comprising a mobile phone 165. Handling system 10 can comprise telephone 27. Telephone 27 can comprise a corded landline telephone, a cellular telephone, a cordless landline phone, or other. Any embodiment herein disclosed employing (or operating in conjunction with) a landline telephone can be configured to employ (or to operate in conjunction) with a cellular telephone. Any embodiment herein disclosed employing (or operating in conjunction) with a cellular telephone can be configured to employ (or operate in conjunction) with a landline telephone.

Telephone 27 can comprise a mobile phone 165. Beyond providing the functionality of telephone 27, mobile phone 165 can function to facilitate the selection of content for play as a music player and/or for a ring-back and/or for a user-selected sending. Mobile phone 165 can further function to facilitate delivery of the ring-back to a caller. An exemplary mobile phone 165 is depicted in FIG. 11. The exemplary mobile phone 165 can comprise a cell phone, a satellite phone, or other. Mobile phone 165 transmits and receives signals for electronic communication with, for example, switching station 120 of service provider 121. Phone 165 can provide that content can be accessed, via service provider 121, from provider 121, and/or from the internet, or from other.

Example handling system 10bb comprises a caller I.D. circuitry 20. Caller I.D. circuitry 20 functions to provide caller I.D. information to a user. An exemplary caller I.D. is depicted in FIG. 1b. The exemplary caller I.D. circuitry 20 can comprise a caller I.D. display 21. To indicate the presence of an incoming call, local switching station 120 sends a ring signal to telephone 27, causing telephone 27 to ring. Along with the ring signal, switching station 120 sends caller I.D. information. The information is received at caller I.D. circuitry 20 and, subsequently, provided for a user to read on caller I.D. display 21. (Caller I.D. can comprise an audible announcement of the I.D. information to the user including or absent display 21.

Example handling systems 10ee through 10nn comprise a graphical user interface 210. Graphical user interface 210 can function to receive instruction from a user and can function to display information to a user. An exemplary graphical user interface 210 is depicted in FIGS. 2ee through 211, shown as G.U.I. 210 and hereafter referred to as GUI 210. The exemplary GUI 210 can include circuitry and/or programming to receive instruction from a user. The exemplary GUI 210 can enable the user to supply instruction to system 10. System 10 can respond by implementing the user's instruction. GUI 210 can include computer executable instructions. The computer executable instructions (stored in the computer-readable memory and executable by the programmable processor) can include a series of executable steps to perform the following: present a menu of selection options to a user via a graphical user display of messages and/or information to be provided to a calling party; receive an input (or instruction) from a user (i.e., a called party) via a user interface (e.g., a keyboard or a graphical user interface), use the received input to determine a specific message or information to be transmitted to a calling party; enable telephony circuitry to establish a telephonic communication connection with the called party and implement telephonic transmission of the specific message or information to the calling party; and enable a user to store in the computer-readable memory a series of user-selected messages and/or information to be potentially later communicated to a caller, and enable the user to label the stored messages and/or information such as with descriptive titles for later reference by the user.

It will be appreciated that the apparatus of the present disclosures has been described by examples (FIGS. 1a-1d) of telephonic equipment (specifically, handset or telephone 27) which provide buttons for implementing various user-selection options described herein. (For example, telephone 27aa of FIG. 1c provides buttons 330a, 330b and 330c which allow a user to select various call record messages.) However, when a user handset or telephone is provided with a graphical user interface (GUI), for example GUI 210, then the user can be provided with hierarchical menus in place of buttons. Example handling systems 10aa through 10dd, shown employing buttons to receive instruction from the user, can be configured to employ GUI 210. Example handling systems 10ee through 10nn, shown employing GUI 210 to receive instruction from the user, can be configured to employ buttons in place of GUI 210.

A first embodiment of telephone call handling system 10 is illustrated in FIGS. 1a, 1b, 1c and 1d. This first embodiment comprises message-then-record circuitry 310 and a commencer 325. This embodiment can include the above-described caller I.D. circuitry 20. This embodiment can be further enhanced with a record message picker 329. Commencer 325 can include one or more of a user interface 99 and a call detector 311. (In one variation, this first embodiment comprises circuitry 20 and commencer 325, both located at a phone (27aa, 27bb, 27cc) and interacts with, and can include, message-then-record circuitry 310 located, for example, at service provider 121.)

Message-then-record circuitry 310 functions to deliver a message to a caller and then record a conversation. An exemplary message-then-record circuitry 310 is depicted in FIGS. 1a, 1b and 1c. The exemplary circuitry 310 comprises an interface 31, an out-going message sender 32 and a recorder 323.

Interface 31 functions to control connection and release operations. An exemplary interface 31 is depicted in FIGS. 1a through 6 and 8 through 10. The exemplary interface 31 is electrically connected to (or connectable to) line 11 and, responsive to input, can go off-hook. (“Electrically connected to” includes the capability to become electrically connected to, for example, as by way of a switch, as well as connectivity by wireless transmission such as Blue Tooth or other radio frequency or infra red-type transmission.) Handling system 10 can be located remote from service provider 121, as for example at a user location or in a user telephone 27. Handling system 10 can also be located at service provider 121. (Other arrangements for distribution and/or consolidation of the components of system 10 can also be provided, all within the scope of the present disclosure.) When system 10 is located at either location, going off-hook can serve to cause service provider 121 to discontinue the sending of a ring sound to the caller's telephone and further can serve to provide that system 10 and service provider 121 are communicably connected such that message sender 32 of system 10 can send a message to the caller's telephone. When system 10 is located at either location, going off-hook can further function to discontinue the sending of a ring signal to telephone 27 and to provide that system 10 can receive information from the caller's telephone via service provider 121.

Out-going message sender 32 functions to send stored information to a caller. An exemplary message sender 32 is depicted in FIGS. 1a, 1b, 1c and 1d. The exemplary sender 32 is electrically connected to (or connectable to) telephone line 11 and sends a message to line 11 and, thus, ultimately to the caller.

Recorder 323 functions to record a conversation. An exemplary recorder 323 is depicted in FIGS. 1a, 1b, 1c and 1d. The exemplary recorder 323 is electrically connected to (or connectable to) telephone line 11 and can record a conversation transpiring on line 11, said conversation for example between the user and the other party. Recorder 323 can be located at service provider 121, in the user telephone 27, or in equipment electronically connected thereto. Recorder 323 can receive signal information from message sender 32. Recorder 323 can respond to a signal from sender 32 by recording a conversation.

Commencer 325 functions to receive instruction from a user to commence message-then-record circuitry 310. An exemplary commencer 325 is depicted in FIGS. 1a, 1b, 1c and 1d. The exemplary commencer 325 can include a user interface 99 (shown as U.I. 99 in FIGS. 1a, 1b and 1c, user interface 99 referred to hereafter as UI 99). UI 99 functions to receive instruction from a user. (UI 99 can include a microprocessor and memory available to the microprocessor.) The exemplary commencer 325 can include a call detector 311 (shown in FIG. 1d as Detector 311).

A first example of this first embodiment is illustrated as system 10aa in FIG. 1a. For this example, out-going message sender 32 of message-then-record circuitry 310 is configured to store and to deliver to a caller a record message A 321 (shown as R.M. A 321). Record message A 321 states, for example, “This conversation may be recorded.” Interface 31 is configured to maintain the off-hook condition until detecting the call being answered by the user.

Further for this example, UI 99 of commencer 325 is configured to receive instruction from a user via a control button 330, button 330 electrically connected to (or connectable to) line 11a and located at telephone 27aa. When pressed, button 330 sends a control signal to UI 99. UI 99 responds by sending a signal to interface 31 and, after a two-second delay, sending a signal to sender 32. Interface 31 responds by going off-hook. Sender 32 responds by sending record message A 321 to the caller. (Button 330 can be part of commencer 325.)

A first example of operation of this first example of this first embodiment will now be given (FIG. 1a). A user's telephone is rung by an incoming ring signal provided by station 120 via line 11 and line 11a. The user may desire to record the conversation for any of a number of different reasons. To record the conversation, the user presses button 330. Pressed button 330 sends a signal to UI 99 via line 11a and commencer 325. UI 99 responds by sending a signal to interface 31 and, after a two-second delay, by sending a signal to out-going message sender 32. Interface 31 responds by going off-hook. Sender 32 responds by playing and sending record message A 321, “This conversation may be recorded” to the caller (via line 11 and switching station 120). The caller hears the message and understands that any subsequent telephonic conversation with the user may be recorded. At the conclusion of the sending of the message, handling system 10aa remains idle (on hold) by interface 31 maintaining the off-hook condition until the user answers the call.

When the user answers, the off-hook condition of telephone 27aa is detected by interface 31. Interface 31 responds by discontinuing the off-hook condition. (If the caller hangs up prior to the user answering, interface 31 can respond by discontinuing the off-hook condition.) Circuitry 310 responds to discontinuance of the off-hook condition (and provided the caller has not terminated the call) by engaging recorder 323. (Circuitry 310 is configured to determine the following conditions in order to engage recorder 323: (i) that button 330 has been pressed to send the “record” message; (ii) that the off-hook condition has been terminated; (iii) that the call has not been terminated; and (iv) that the user has not subsequently signaled the circuitry to terminate the recording. Circuitry 310 can alternately be configured to maintain the recorder 323 in the engaged condition following termination of the call by the caller so that the user can record verbal information relating to the call, such as the date, time and identity of the caller, and any other notes the user wishes to record. The recorder can then be disengaged by the user by signaling circuitry 310 (e.g., via button 330) to disengage the recorder. Also, in one version, message-then-record circuitry 310 is configured such that the recorder 323 also records the playing of the record-message.) Recorder 323 remains engaged until circuitry 310 determines that (i) the incoming call has been terminated (i.e., no incoming call signal detected), (ii) the user disengages the recorder 323 during the conversation (e.g., by pressing button 330 again), or the user disengages the recorder after the caller has terminated the call. Thus, button 330 can act as a multi-function button, serving to: (i) send the “record” message R.M. A 321 (if circuitry 310 determines that there is an unanswered incoming call); (ii) act as an “on-off” toggle for the recorder 323 during a conversation (if circuitry 310 determines that there is an ongoing connected call); and (iii) to enable playback of the last-recorded conversation (if circuitry 310 determines that there is currently no incoming or ongoing call). Phone 27aa can also use common message playback features (e.g., “play”, “repeat”, “delete”) 327 to manage conversations recorded by the recorder 323.

“Record” message R.M. A (321) can either be provided as a standard default message supplied by a service provider or a telephone manufacturer, or as a user customized message. In the latter instance the user can customize the “record” message R.M. A (321) by pressing button 330 (when no call is incoming or in progress), and then speaking the desired customized “record” message into the microphone (a standard feature for any telephone, and thus not depicted in FIG. 1a). Once the desired “record” message has been recorded, the user can again press button 330 to terminate recording of the message.

A second example of operation of this first example of this first embodiment will now be given (FIG. 1a). A user dials an-other party's telephone number. Provider 121 connects the call and provides a ring-back tone to telephone 27. Provider 121 responds to the other party answering by discontinuing the ring-back. The user can respond to the other party's answering by pressing control button 330. Pressed button 330 sends a signal to UI 99 via line 11a and commencer 325. UI 99 responds by sending a signal to interface 31 and, after a two-second delay, by sending a signal to out-going message sender 32. Interface 31 responds by going off-hook. Sender 32 responds by playing and sending record message A 321, “This conversation may be recorded” to the caller (via line 11 and switching station 120). The caller hears the message and understands that any subsequent telephonic conversation with the user may be recorded. At the conclusion of the sending of the message, handling system 10aa remains idle (on hold) by interface 31 maintaining the off-hook condition until the user answers the call. When the user answers, the off-hook condition of telephone 27aa is detected by interface 31. Interface 31 responds by discontinuing the off-hook condition. (If the caller hangs up prior to the user answering, interface 31 can respond by discontinuing the off-hook condition.) Circuitry 310 responds to discontinuance of the off-hook condition (and provided the caller has not terminated the call) by engaging recorder 323.

A third example of operation of this first example of this first embodiment will now be given (FIG. 1a). A user's telephone is rung by an incoming ring signal provided by station 120 via line 11 and line 11a and the user decides to answer the call. Alternately, the user has placed a call to another party and the party has answered the call. While conversing with the caller or other party, respectively, user decides that he would benefit by recording information that he expects will be shared. Accordingly, the user presses control button 330. Pressed button 330 sends a signal to UI 99 via line 11a and commencer 325. UI 99 responds by sending a signal to out-going message sender 32. Sender 32 responds by playing and sending record message A 321, “This conversation may be recorded” to the caller (via line 11 and switching station 120). The caller hears the message (as does the caller) and understands that any subsequent telephonic conversation with the user may be recorded. Sender 32 then discontinues the playing and sending of the message and signals recorder 323. Recorder 323 commences to record the conversation. (In one version, message-then-record circuitry 310 is configured such that recorder 323 also records the playing of the record-message to the caller.) Recorder 323 remains engaged until circuitry 310 determines that (i) the incoming call has been terminated (i.e., no incoming call signal detected), (ii) the user disengages the recorder 323 during the conversation (e.g., by pressing button 330 again), or the user disengages the recorder after the caller has terminated the call. (Alternately, UI 99 can respond to the user pressing button 330 by employing interface 31 to communicably disconnect caller and user while message A 321 is played to the caller. Sender 32 can then indicate a conclusion to the message sending by sending a signal to interface 31 and a signal to recorder 323. Interface 31 can respond by communicably re-connecting caller and user. Recorder 323 can respond to the signal by recording the conversation.)

A second example of the first embodiment is illustrated as telephone call handling system 10bb in FIG. 1b. This second example comprises the first example and further configured with caller I.D. circuitry 20 and display 21 (depicted as being located on phone 27bb). This feature allows the user to determine whether or not to send the “record” message R.M. A (321) and subsequently record the call.

An example of operation of this second example of this first embodiment will now be given (FIG. 1b). A user's telephone is rung by an incoming ring signal provided by station 120 via line 11 and line 11a. Delivered with the ring signal is caller I.D. information. The information appears on display 21 (located at telephone 27bb). The user recognizes the phone number (or caller identification) on the display; i.e. the user essentially knows who's calling. The user may determine that this person is someone whose conversations should be recorded (perhaps a client calling to give instructions to a professional). Accordingly, the user presses control button 330. Pressed button 330 sends a signal to UI 99 via line 11a. UI 99 responds by sending a signal to interface 31 and, after a two-second delay (in this example), by sending a signal to out-going message sender 32. Interface 31 responds by going off-hook. Sender 32 responds by playing and sending record message A 321, “This conversation may be recorded” to the caller (via line 11 and switching station 120). The caller hears the message and understands that any subsequent telephonic conversation with the user may be recorded. At the conclusion to the sending of the message, handling system 10bb remains idle (on hold) by interface 31 maintaining the off-hook condition until the user answers the call. When the user answers, the off-hook condition of telephone 27bb is detected by interface 31. Interface 31 responds by discontinuing the off-hook condition. (If the caller hangs up prior to the user answering, interface 31 can respond by discontinuing the off-hook condition.) Circuitry 310 responds to discontinuance of the off-hook condition (and provided the caller has not terminated the call) by engaging recorder 323. Recorder 323 remains engaged until circuitry 310 determines that either (i) the incoming call has been terminated (i.e., no incoming call signal detected) or (ii) the user disengages the recorder 323 (e.g., by pressing button 330 again). (In one version, message-then-record circuitry 310 is configured such that recorder 323 also records the playing of the record-message to the caller.)

As with phone 27aa of FIG. 1a, phone 27bb of FIG. 1b can be provided with message management features 327 in order to manage conversations recorded by the recorder 323. Also, for this second example of this first embodiment, the user can employ system 10bb to initiate the recording of a conversation subsequent to answering the call (start the recording during the conversation). (In one variation, examples of this first embodiment can operate without message sender 32 sending a record message to the other party. Upon the user pressing control button 330 button 330 sends a signal to UI 99. UI 99 responds by sending a signal to recorder 323. Recorder 323 commences to record the conversation.)

A third example of the first embodiment is illustrated as telephone call handling system 10cc in FIG. 1c. This third example comprises the first or second example, and further configured with a record message picker 329 (depicted as being located on phone 27cc). This feature allows the user to determine a specific “record” message to be sent to the caller. (While the record message picker 329 can be used without caller I.D. 20, the caller I.D. enhances the user's ability to select an appropriate “record” message based on the user's identification of the caller.) The record message picker 329 can be implemented as a plurality of buttons (here, depicted as buttons 330a, 330b and 330c) on phone 27cc. Alternately, the record message picker 329 can be implemented on a touch-screen (e.g., display 21) with a scrolling feature to enable the user to select one of a plurality of “record” messages displayed on the screen. Further in this third example, message-then-record circuitry 310 can be provided with a plurality of “record” messages 321. (With the exception of the plurality of “record” messages, circuitry 310 can be configured essentially identical to the message-then-record circuitry 310 described above with respect to the first two examples of this embodiment.) As exemplary depicted in FIG. 1c, the plurality of “record” messages 321 can include “record” message “A” (R.M. A, 321a), “record” message “B” (R.M. B, 321b), and “record” message “C” (R.M. C, 321c). By way of example only, record message R.M. A (321a) can state “This call may be recorded”, record message R.M. B (321b) can state “This call may be recorded in order to protect our legal rights”, and record message R.M. C (321c) can state “This call may be recorded to ensure the quality of your order”. Thus, when coupled with the caller I.D. 20, the record message picker 329 can allow a user to select an appropriate record message (321a, 321b, etc.) to be sent to the caller.

An example of operation of this third example of this first embodiment will now be given (FIG. 1c). A user's telephone is rung by an incoming ring signal provided by station 120 via line 11 and line 11a. Optionally, but preferably, delivered with the ring signal is caller I.D. information. The information appears on display 21 (located at telephone 27bb). The user recognizes the phone number (or caller identification) on the display; i.e. the user essentially knows who's calling. The user may determine that this person is a customer who might be placing a telephone order for a product or service offered for sale by the user. Accordingly, the user presses button 330c on record message picker 329. Pressed button 330 sends a signal to UI 99 via line 11a. UI 99 responds by sending a signal to interface 31 and, after a two-second delay, by sending a signal to out-going message sender 32. Interface 31 responds by going off-hook. Sender 32 responds by playing and sending record message C 321c, “This call may be recorded to ensure the quality of your order” to the caller (via line 11 and switching station 120). The caller hears the message and understands that any subsequent telephonic conversation with the user may be recorded. At the conclusion to the sending of the message, handling system 10cc remains idle (on hold) by interface 31 maintaining the off-hook condition until the user answers the call. When the user answers, the off-hook condition of telephone 27cc is detected by interface 31. Interface 31 responds by discontinuing the off-hook condition. (If the caller hangs up prior to the user answering, interface 31 can respond by discontinuing the off-hook condition.) Circuitry 310 responds to discontinuance of the off-hook condition (and provided the caller has not terminated the call) by engaging recorder 323. Recorder 323 remains engaged until circuitry 310 determines that either (i) the incoming call has been terminated (i.e., no incoming call signal detected) or (ii) the user disengages the recorder 323 (e.g., by pressing button 330 again).

As with phone 27aa of FIG. 1a, phone 27cc of FIG. 1c can be provided with message management features 327 in order to manage conversations recorded by the recorder 323. Also, for this third example of this first embodiment, the user can employ system 10cc to initiate the recording of a conversation subsequent to answering the call (start the recording during the conversation).

“Record” messages (321) can either be provided as standard default messages supplied by a service provider or a telephone manufacturer, or as a user customized messages. In the latter instance the user can customize the “record” messages (321) by pressing one of buttons 330a, 330b or 330c (when no call is incoming or in progress), and then speaking the desired customized “record” message into the microphone (a standard feature for any telephone, and thus not depicted in FIG. 1c). Once the desired “record” message has been recorded, the user can again press the button to terminate recording of the message. This can be performed for any or all of “record” messages R.M. A (321a), R.M. B (321b), and R.M. C (321c).

In one variation, in order to assist the user in selecting the appropriate “record” message to be sent to a caller, once the user presses any one of buttons 330a, 330b or 330c during an incoming call, the corresponding “record” message can be announced to the user via the telephone speaker (a feature common to all telephones). If the message is the one desired, the user can then press the button a second time in order to cause the selected “record” message to be sent to the caller. However, if the initially selected “record” message is not the message the user desires to send to the caller, then the user can press a different button (330a, 330b or 330c) and repeat the process. As an alternative, rather than announcing the entire “record” message to the user, the user can store “shorthand” descriptions for each “record” message. (These “shorthand” descriptions can be stored in a memory device located in circuitry 310, in phone 27cc, or at a service provider.) For example: for a generic “record message R.M. A (321a) of “This message may be recorded”, the shorthand verbal clue can be “generic”; for a customized “record message R.M. B (321b) of “This message may be recorded to protect our legal rights”, the shorthand verbal clue can be “legal”; and for a customized “record message R.M. C (321c) of “This message may be recorded in order to ensure the quality of your order “, the shorthand verbal clue can be “customer”.

In yet another variation, the user can store text equivalents (or shorthand text notes) for each “record” message in a memory device located in circuitry 310, in phone 27cc, or at a service provider. Then, once any one of buttons 330a, 330b or 330c is pressed during an incoming call, the corresponding text description for the associated “record” message can be displayed on display 21. If the displayed text indicates that the desired message has been selected, the user can press the button again (or, if display 21 is a touch screen, by merely tapping the screen).

A fourth example of the first embodiment is illustrated as telephone call handling system 10dd in FIG. 1d. This fourth example comprises message-then-record circuitry 310, commencer 325 and a call detector 311. This example can comprise caller I.D. circuitry 20. Call detector 311 functions to detect a call between the user and an-other party. An exemplary call detector 311 is depicted in FIG. 1d, shown as Detector 311. The exemplary detector 311 acts in place of user interface 99. For this example, detector 311 detects a call between the user and an-other party and responds to said detection by commencing message-then-record circuitry 310. (More specifically, upon detecting an incoming call, the detector 311 causes the commencer 325 to begin recording any communications between the caller and the user.) Detector 311 is electrically connected to (or connectable to) telephone line 11 and can detect, for example, communicable connection between the user and an-other party. Detector 311 can respond to said detection as described prior to receiving instruction from the user. In other words, the exemplary detector 311 responds by sending a signal to interface 31 and, after a two-second delay, sending a signal to sender 32. Interface 31 responds by going off-hook. Sender 32 responds by sending record message A 321 to the caller. (Button 330 can be part of commencer 325.)

An example of operation of this fourth example of this first embodiment will now be given (FIG. 1d). A user's telephone is rung by an incoming ring signal provided by station 120 via line 11 and line 11a. Optionally, but preferably, delivered with the ring signal is caller I.D. information. The information appears on display 21 (located at telephone 27dd). Call detector 311 detects the incoming call, and responds by sending a signal to interface 31 and, after a two-second delay, by optionally sending a signal to out-going message sender 32. Interface 31 responds by going off-hook. Sender 32 responds by optionally playing and sending record message C 321, “This call may be recorded” to the caller (via line 11 and switching station 120). The caller hears the message and understands that any subsequent telephonic conversation with the user may be recorded. At the conclusion to the sending of the message (if such option is provided), handling system 10ddcc remains idle (on hold) by interface 31 maintaining the off-hook condition until the user answers the call. When the user answers, the off-hook condition of telephone 27dd is detected by commencer 325 which discontinues the off-hook condition and signals message-then-record circuitry 310 to begin recording the conversation. (If the caller hangs up prior to the user answering, commencer 325 can respond by discontinuing the off-hook condition.) Circuitry 310 responds to discontinuance of the off-hook condition (and provided the caller has not terminated the call) by engaging recorder 323. Recorder 323 remains engaged until circuitry 310 determines that either (i) the incoming call has been terminated (i.e., no incoming call signal detected) or (ii) the user disengages the recorder 323 (e.g., by pressing button 330 again).

Another example of operation of this fourth example of this first embodiment will now be given (FIG. 1d). A user dials an-other party's telephone number. Provider 121 connects the call and provides a ring-back tone to telephone 27. Provider 121 responds to the other party answering by discontinuing the ring-back. The discontinuance of the ring-back is detected by call detector 311. Call detector 311 responds by sending a signal to interface 31 and, after a two-second delay, by optionally sending a signal to out-going message sender 32. Interface 31 responds by going off-hook. Sender 32 responds by optionally playing and sending record message C 321, “This call may be recorded” to the caller (via line 11 and switching station 120). The caller hears the message and understands that any subsequent telephonic conversation with the user may be recorded. At the conclusion to the sending of the message (if such option is provided), sender 32 signals interface 31. Interface 31 responds by discontinuing the off-hook condition and signals message-then-record circuitry 310 to begin recording the conversation.

The apparatus of this fourth example can be configured to allow the user to terminate recording of the conversation at any time via the user interface 31, as well as to pause recording and restart recording during a conversation. The apparatus can also be configured to provide the user with a choice of record messages and enable the user the user to pick one of the messages (the apparatus can employ picker 329, picker 329 shown in FIG. 1d). For an incoming call, upon hearing the phone ring the user can know to pick a record message. If the user has dialed the call, the user can know to pick a record message. The apparatus can be further configured so that if the user fails to pick a message, a default message can be sent. The user telephone 27 can be configured to retrieve time and date information (either from memory in the telephone itself, or from a service provider or other source), and to stamp (or cause a service provider to stamp) conversations recorded by the recorder 323 with start and stop times (and dates) of each recorded conversation. The user telephone 27 can be further configured to stamp (or cause a service provider to stamp) conversations recorded by the recorder 323 with any available caller ID that may be associated with the recorded conversation. (Note that each of these features can also be provided directly by a service provider.)

Message management feature 327 (described prior) can be enabled to display a recorded conversation manager menu option to the user. Exemplary high-level options in the recorded conversation manager can include: (i) a sort option to sort recorded conversations; (ii) a find option to find recorded conversations (based on selected criteria, as discussed more fully below); and a (iii) an organize option to allow a user to organize recorded conversations (also as discussed more fully below). As indicated above, the recorder 323 can be configured to allow time-stamp information to be provided with each recorded conversation. Accordingly, a default method for organizing recorded conversations is by date and time, with the most recent recorded conversation being the first recorded conversation shown in a list of all recorded conversations. Accordingly, using the sort option, a user can sort by date (earliest first, or oldest first), as well as by caller ID. Further, the indicated organize option can allow a user to create folders for recorded conversations, assign tags or names to recorded conversations, move recorded conversations between folders, delete and edit recorded conversations, send copies of recorded conversations by e-mail, convert audio (voice) files of recorded conversations to text using voice recognition software. The indicated find option can be used to find recorded conversations based on date, time, other party identity information (for example telephone number), user assigned name (e.g., file name or tag), specific words (e.g., using word-matching voice software or voice-to-text conversion software). A conversation or group of conversations can be found based on date, other party telephone number, user assigned name or other and the specific words option can be employed to the found conversation or group. As another example, the specific words option can be employed to an entire inventory of conversations. (Other party telephone number can be obtained during an incoming call from caller I.D. information and during an outgoing call from obtaining the dialed number.)

(In one variation, the fourth example of this first embodiment can operate without message sender 32 sending a record message to the other party. Upon detector 311 sending a signal to UI 99, UI 99 responds by sending a signal to recorder 323. Recorder 323 commences to record the conversation.)

This first embodiment can be enhanced with a message selector 68. Message selector 68 functions to enable a user to select an audio message. An exemplary message selector 68 is shown in FIGS. 1a, 1b, 1c and 1d. The exemplary selector 68 includes circuitry and/or programming to enable the user to select an audio message. A user can employ selector 68 to select an audio message, for example, to be download into message sender 32 from libraries of audio messages found on the internet via a computer or a WiFi connection (if system 10 is WiFi enabled) or via phone 27 if internet enabled, a recording device, libraries stored in handling system 10 itself or libraries stored at service provider 121, or from other sources.) The exemplary selector 68 is configured to select audio messages R.M. A 321a, R.M.B 321b and R.M.C 321c. The user finds a message, for example in a library of messages, to download to become R.M.A 321a. The user selects the message and presses control button 330a four times. Pressing button 330a four times (for example) signals message sender 32 to load the selected message into R.M.A 321a. (During an incoming call, the user can then press button 330a and the selected audio message R.M.A 321a will be played to the caller as part of the operation of message-then-record circuitry 310.) The user can employ the same selection process to download an audio message into R.M. B 321b (user employs button 330b) and to download an audio message into R.M.C 321c (user employs button 330c).

A second embodiment of telephone call handling system 10 is illustrated in FIGS. 2a, 2b 2c 2d, 2e, 2f, 2g, 2h, 2i and 2j. This second embodiment includes a sendings receiver 340, a sendings registry 350, a storage 370, a sendings provider 375, a deliverer 360, a delivery trigger 390 and can include an-other party address register 357. This second embodiment can further include one or more of: a sendings picker 385; a deliverer picker 377; a sendings call-up 396; a sendings identifier 345; a user-selected sendings supplier 380; an inventory review poster 440; and a configurator 395.

The term “sending” (as used as a noun in this second embodiment) includes content configured to be sent electronically from one party to another. For example, content can be sent by an-other party to a user of system 10. The content of a sending can be included in an electronic file. A sending can also comprise an electronic file and wherein the file contains the content. A sending can include one or more of: audio content; text message content; image content; video content and combinations thereof. As one example, a sending can be a picture/image received from a person with whom the user communicates over the telephone. As another example, a sending can be a favorite audio clip received from a person with whom the user communicates over the telephone.

This second embodiment includes a sendings receiver 340. Sendings receiver 340 functions to receive sendings. An exemplary sendings receiver 340 is depicted in FIGS. 2a through 17h, shown as Receiver 340. The exemplary receiver 340 can include circuitry and/or programming to enable the receipt of sendings. The exemplary receiver 340 can forward a received sending to a sending registry 350 (depicted in FIGS. 2a through 2e, registry 350 described below). Receiver 340 can forward a received sending to a sendings identifier 345 (depicted in FIG. 2f, identifier 345 described later). A received sending can include sending identity information. Receiver 340 can forward said identity information along with the forwarded sending. As examples, the identity information can comprise the telephone number of a telephone from where the sending originated and/or can comprise a name registered to said telephone number and/or can comprise other sending identity information. A received sending can include sending type information. Receiver 340 can forward said sending type information along with the forwarded sending. Examples of sending types include: audio type, text message type, image type, video type or some other type. (In one variation, receiver 340 can forward identity information by itself, i.e. no sending.)

Sendings receiver 340 can include one or more of: a telephone provider receiver 344, an email receiver 351 and an internet receiver 409. Telephone provider receiver 344 functions to receive sendings delivered via telephone service. An exemplary telephone provider receiver 344 is depicted in FIGS. 2a through 2j, shown as Telephone 344. The exemplary provider receiver 344 can include circuitry and/or programming to enable the receipt of at least one sending delivered via telephone service, for example delivered via service provider 121. As one operational example of this exemplary provider receiver 344, an-other party can dispatch a sending from their telephone along with a telephone delivery address comprising the user's telephone 27 and a service provider can then deliver the sending to the user's telephone 27.

Typically delivered along with a sending is sending origin identity information, for example the telephone number of the dispatching telephone. Along with the sending, telephone provider receiver 344 can receive said identity information, for example said telephone number. Receiver 344 can then forward the received sending and identity information (telephone number) to one of sendings registry 350 or sendings identifier 345. If forwarded to registry 350, registry 350 can then register the sending to the (identity information) telephone number and include the registered sending in an inventory. If forwarded to identifier 345, identifier 345 can then determine whether or not the sending constitutes a distinguished sending. If so, identifier 345 can forward the sending and identity information to registry 350. Registry 350 can then register the sending to the identity information (telephone number) and include the registered sending in an inventory.

Typically delivered along with a sending is sending type information, for example, the type of content contained in the sending. Content types include (without limitation): audio, text message, image, video and audio/video. Along with the sending and identity information, telephone provider receiver 344 can receive said type information. Along with the sending and identity information, receiver 344 can forward the received type information to one of sendings registry 350 or sendings identifier 345. If forwarded to registry 350, registry 350 can then register the sending to the type information (along with registering to the identity information) and can include the registered sending in inventory 324. If forwarded to identifier 345, if the sending is identified, identifier 345 can forward the type information along with the sending and identity information to registry 350 to be inventied.

Sendings receiver 340 can include an email receiver 351. Email receiver 351 functions to receive sendings delivered via an email service. An exemplary email receiver 351 is depicted in FIGS. 2a through 2j, shown as Email 351. The exemplary email receiver 351 can include circuitry and/or programming to receive at least one sending delivered via email service, for example delivered to an email account. As an operational example of this exemplary email receiver 351, an other party sends an email comprising a sending and addresses the email for delivery to an email account, for example, the user's email account. Email service can then deliver the email to said user's email account. Receiver 351 can be provided access to, and/or can be configured to access, an email account to receive a sending, for this example to receive the sending dispatched by said other party. Receiver 351 can receive the delivered sending.

Typically delivered along with an email sending is sending origin identity information, for example the email account address from where the email was dispatched. Along with the delivered sending, email receiver 351 can receive said identity information, for example said email account address. Receiver 351 can then forward the received sending and identity information to one of sendings registry 350 or sendings identifier 345. If forwarded to registry 350, registry 350 can then register the sending to the identity information and can include the registered sending in an inventory, for example inventory 324. If forwarded to identifier 345, identifier 345 can then identify the sending or not. If the sending can be identified, identifier 345 can forward the sending and identity information to registry 350. Registry 350 can then register the sending to the identity information and include the registered sending inventory 324. Email receiver 351 can employ matcher 353 described below to transfer/convert identity information received via email service to identity information employed in telephone service.

Typically delivered along with an email sending is sending type information, for example, said sending type information comprising the type of content contained in the sending. Content types can include: audio, text message, image, video and combined audio and video. Along with the delivered sending and identity information, email receiver 351 can receive said sending type information. Along with the sending and identity information receiver 351 can forward the received type information to one of sendings registry 350 or sendings identifier 345. If forwarded to registry 350, registry 350 can then register the sending to the type information (along with registering to the identity information) and can include the registered sending in inventory 324. If forwarded to identifier 345, if the sending is identified, identifier 345 can forward the type information with the sending and identity information to registry 350. Registry 350 can the inventory the information. Email receiver 351 can be configured to transfer/convert type information received via email service to type information employed in telephone service.

Sendings receiver 340 can include an internet receiver 409. Internet receiver 409 functions to receive sendings delivered via an internet service. An exemplary internet receiver 409 is depicted in FIGS. 2a through 2j, shown as Internet 409. The exemplary internet receiver 409 can include circuitry and/or programming to receive at least one sending delivered via internet service, as examples, delivered via internet service provided by service provider 121 or provided by an internet service provider via provider 121 or provided by an internet service provider via a wifi enabled telephone 27. As an operational example of this exemplary internet receiver 409, an other party posts their favorite sending on an internet website. Receiver 409 can be provided access to, and/or can be configured to access, an internet website to receive a sending, for this example to receive the sending posted by said other party. Receiver 409 can receive the posted sending. The posted sending can include sending origin identity information, for example the telephone number of the posting party's telephone, the posting party's email account address, the posting party's name or other. Along with the delivered sending, internet receiver 409 can receive said identity information. Receiver 351 can then forward the received sending and identity information to one of sendings registry 350 or sendings identifier 345. If forwarded to registry 350, registry 350 can then register the sending to the identity information and can include the registered sending in an inventory. If forwarded to identifier 345, identifier 345 can then identify the sending or not. If the sending can be identified, identifier 345 can forward the sending and identity information to registry 350. Registry 350 can then register the sending to the identity information and include the registered sending in an inventory. Internet receiver 409 can employ matcher 353 described below to transfer/convert identity information received via internet service to identity information employed in telephone service or other.

Typically delivered along with a sending file is sending type information, for example, said sending type information comprising the type of content contained in the file. Content types can include: audio, text message, image, video and combined audio and video. Along with the delivered sending and identity information, internet receiver 409 can receive said sending type information. Along with the sending and identity information receiver 409 can forward the received type information to one of sendings registry 350 or sendings identifier 345. If forwarded to registry 350, registry 350 can then register the sending to the type information (along with registering to the identity information) and can include the registered sending in an inventory. Internet receiver 409 can be configured to transfer/convert type information received via internet service to type information employed in telephone service or other.

Sendings receiver 340 can include a matcher 353. Matcher 353 functions to match sending identity information. An exemplary matcher 353 is depicted in FIGS. 2a through 2j. The exemplary matcher 353 can include circuitry and/or programming to match sending identity information. The exemplary matcher 353 can be configured to match sending identity information received via email service to telephone service identity information. As one example, an-other party can include their telephone number with an email delivered to the user's email account. As an example, if the return address (the other party's email address) is beanpole@gmail.com, upon including their telephone number in the return address, the return address becomes 5095346666beanpole@gmail.com. Matcher 353 can be provided access to, and/or can be configured to access, said user's email account. Matcher 353 can be configured to scan return addresses, for example of unopened received emails, in said user's email account to recognize each address containing a telephone number included in the return address. Upon matcher 353 finding an included telephone number, matcher 353 can obtain said telephone number included with the return address. Receiver 351 can forward the sending (the sending for example attached to the email) along with said included telephone number to one of sendings registry 350 or sendings identifier 345. If forwarded to registry 350, registry 350 can then register the sending to the included telephone number and inventory the registered sending. If forwarded to identifier 345, identifier 345 can then identify the sending or not. If identified, identifier 345 can forward the sending to registry 350. Registry 350 can then register the sending to the included telephone number and inventory the registered sending. (As another example of an-other party including their telephone number with an email delivered to the user's email account, the other party can add the number to the delivery address. If the delivery address is waltZ@Comcast.com, upon including the telephone number the new delivery address becomes, for example, waltZ@Comcast.com/5095346666. As another example of an other party including their telephone number with an email delivered to the user's email account, the other party can include the number in the email and matcher 353 can be configured to scan the email to obtain the number. The exemplary matcher 353 can be configured to convert/transfer sending identity information received via internet service to telephone service sending identity information. The exemplary matcher 353 can be configured to convert/transfer sending identity information received via telephone service to email service sending identity information. Matcher 353 can be configured to convert/transfer otherwise. Matcher 353 has been disclosed located/included at receiver 340. Matcher 353 can be located/included at registry 350 or can be located/included elsewhere or can be an independent component located elsewhere.)

This second embodiment includes a sendings registry 350. Sendings registry 350 functions to inventory sendings. An exemplary sendings registry 350 is depicted in FIGS. 2a through 2j, shown as Registry 350. The exemplary sendings registry 350 can include circuitry and/or programming to inventory sendings. The exemplary registry 350 can include an inventory 324. Registry 350 can compile a registration number and assign the registration number to a sending. Registry 350 can list the registration number in inventory 324. Inventory 324 can comprise a plurality of assigned registration numbers. A sending having been assigned a registration number included in inventory 324 can be forwarded by registry 350 to be stored in a storage, for example, a storage 370 (storage 370 described below). Subsequently, registry 350 can search the registration numbers listed in inventory 324 for the existence of a sending or sendings. For a sending or sendings found in inventory 324, registry 350 can scan storage 370 to locate in storage 370 the sending or sendings. Registry 350 can then read, copy, or delete the located sending or sendings. Registry 350 can respond to instruction to be forwarded a sending by locating the sending in storage 370, reading the sending file and forwarding the read of the sending. Registry 350 can respond to instruction to be forwarded a copy of a sending file by locating the sending in storage 370, copying the sending file and forwarding the sending file copy. (Said request to forward a sending or to forward a copy of a sending file can come from a sendings provider 375, provider 375 described later).

(Presently practiced, a sending party addresses a sending to the user's telephone number and sends the sending. The sending is sent from the sending party's telephone (cell phone) and is delivered by a service provider. The service provider delivers the sending to the user's telephone (cell phone). The user's telephone stores the sending and provides a sending description in an inbox, the sending description representative of the sending. The user can then visit the inbox, view a list of sending descriptions and click on a description serving to open the associated sending file. Typically included with the delivered sending is sending origin identity information. The user's telephone provides the identity information in the sending description. As examples, the identity information can comprise the telephone number of a telephone from where the sending originated and/or can comprise a name registered to said telephone number and/or can comprise other sending identifying information. The identity information provided in the sending description enables the user to ascertain the sending's origin. In addition to the identity information, typically included with the delivered sending is sending type information. The user's telephone provides said sending type information in the sending description. Sending type can be: audio type, text message type, image type, video type, or some other type. Also presently practiced, a sending can be sent from an email account to an email account accessible to the user. Said sending description information is then typically provided at the inbox of said email account, said inbox accessible by the user.)

Registry 350 can include an automatic register 401. Automatic register 401 functions to automatically register sendings. An exemplary automatic register 401 is depicted in FIGS. 2a through 2j. The exemplary automatic register 401 can include circuitry and/or programming to automatically register sendings. For this exemplary register 401, register 401 can register a sending forwarded from receiver 340, and can register a sending forwarded from identifier 345 (identifier 345 described later). Register 401 can register a sending by registering a trait (or traits) of the sending to become a component (or components) of a registration number compiled by registry 350 and assigned to the sending (one component can comprise the entire registration number). In other words, a sending can comprise one or more of said traits and register 401 can register each trait to become a component of a registration number. Registry 350 can compile one or more of said components into a registration number. Registry 350 can then list said compiled registration number in inventory 324. Registry 350 can search inventory 324 for the registration number or for one or more of said components of the registration number. The above-described origin identity information can comprise one sending trait. Time of receipt can comprise another sending trait. The above-described sending type information can comprise another sending trait registered. Sending class can comprise another sending trait.

The registering of origin identity, time of receipt, sending type, and sending class by automatic register 401 will now be described:

Automatic register 401 can include an origin register 358. Origin register 358 functions to register a sending by origin. An exemplary origin register 358 is depicted in FIGS. 2a through 2j. The exemplary origin register 358 can include circuitry and/or programming to register a sending by origin. As one example of this exemplary origin register 358, register 358 can obtain the origin identity information included with a received sending (for example, the above-described identity information presently provided in the sending description) and can register said obtained origin identity to the sending. Register 358 can be configured to scan information received relative to a received sending, to recognize origin identity information in the scanned information and to register the origin identity information. Registry 350 can compile a registration number inclusive of the register 358 registered identity information as a component and assign the registration number to the sending. Registry 350 can list the registration number in an inventory, for example inventory 324, and can forward the inventoried sending to be stored in storage 370. (As stated above, said identity information can be the telephone number of a telephone from where the sending originated and/or a name registered to said telephone number or can be some other sending identifying information. Also, in one variation, said identity information can be an email address from where the sending was emailed.)

Origin register 358 can include a telephone number register 359 shown as TNR 359. Telephone number register 359 functions to register a sending by telephone number. As one example of telephone number register 359, register 359 can include circuitry and/or programming to obtain the telephone number of the telephone from where a sending originated. Register 359 can obtain said telephone number from identity information included along with the received sending (for example, presently provided in the above-described sending description). Register 359 can then register the obtained telephone number. Registry 350 can compile a registration number for the sending inclusive of the register 359 obtained telephone number as a component. Registry 350 can add the registration number to an inventory, for example inventory 324, and can forward the inventoried sending to be stored in storage 370.

As an example, the telephone number included along with a sending forwarded to registry 350 can be 5095346666. Telephone number register 359 can register the telephone number. Registry 350 can compile a registration number for the sending inclusive of the registered telephone number 5095346666 as a component. Registry 350 can list the registration number in inventory 324 and can forward the inventoried sending to be stored in storage 370. The stored sending can be found by searching inventory 324 identifiable by the 5095346666 component of the registration number. Subsequently, a sendings request to registry 350 can be made by, for example, sendings provider 375 (provider 375 described later, or by some other component). The request can be, for example, to provide all sendings registered to the telephone number 5095346666. Registry 350 can respond to said request by searching inventory 324 for registration numbers having the telephone number 5095346666 as a component. For each registration number found, registry 350 can then provide the sending from storage 370 to the requester. (The exemplary origin register 358 can register alternative obtained origin identity information. Said alternative obtained identity information can be, for example, a last name, a first name and/or some other identity information. For example, the above example sending registered by 5095346666 can instead be registered by a last name provided in said obtained identity information. If the identity information included a last name of Williams (for example), then the sending can be registered as, for example, WILLIAMS.)

Automatic register 401 can include a time register 371. Time register 371 functions to register a sending by time. An exemplary time register 371 is depicted in FIGS. 2a through 2j. The exemplary time register 371 can include circuitry and/or programming to register a sending by time. As one example of this exemplary time register 371, register 371 can register a sending by registering the time the sending was registered by registry 350. Time registered can include one or more of: year registered, date registered, time of day registered, date and time of day registered, year date and time of day registered, or other. As an example, time register 371 can register a date registered to a sending, for example the date can be 10/03/2011. Register 350 can compile a registration number inclusive of the registered date 10/03/2011 as a component and assign the registration number to the sending. Registry 350 can add the registration number to inventory 324 and can forward the inventoried sending to be stored in storage 370. For example, the sending can be the above example sending assigned the registration number 5095346666. Registry 350 can include the registered date component 10/03/2011 in the registration number. The registration number can then be, as an example for this example, 5095346666-10/03/2011. Registry 350 can list the registration number in inventory 324 and can forward the inventoried sending to be stored in storage 370. Registry 350 can find the sending in inventory 324 identifiable by the entire registration number, identifiable by the 5346666 component and identifiable by the 10/03/2011 component.

Subsequently, a sendings request to registry 350 can be made by, for example, a prioritizer 341 of sendings provider 375 (prioritizer 341 described below, or can be made by some other component). Prioritizer 341 can request registry 350 provide the registration numbers for all sendings iregistered to the telephone number 5095346666. Registry 350 can respond to said request by searching inventory 324 for all registration numbers having a 5095346666 component and by providing all found registration numbers having the 5095346666 component to prioritizer 341. (Said registration numbers provided would include the above example 5095346666-10/03/2011.) Prioritizer 341 can then, for example, determine from the date-received information included in the registration numbers the last sending registered and can then request from registry 350 said last sending registered by providing the registration number to registry 350. Registry 350 can then provide the sending from storage 370, for example to dispatcher 336. (As another example of time register 371, registry 350 can list sendings in inventory 324 in the order received. In other words, the first inventoried sending would then constitute the first on the list and the last inventoried sending would then constitute the last on the list. Registry 350 inventorying sendings in the order received acts as time register 371 by in effect registering sendings by time.)

Sendings registry 350 can include a sendings type register 372. Sendings type register 372 functions to register a sending by type. An exemplary sendings type register 372 is depicted in FIGS. 2a through 2j, shown as Type Register 372. The exemplary register 372 can include circuitry and/or programming to register a sending by type. As one example of this exemplary register 372, register 372 can obtain sending type information included with a received sending (for example, the above-described type information presently provided in the sending description) and can register the sending by said obtained sending type information. Register 372 can be configured to scan information received relative to each received sending, to recognize sending type information in the scanned information and to register the sending type information. Registry 350 can compile a registration number inclusive of the registered sending type information as a component and assign the registration number to the sending. Registry 350 can add the registration number to inventory 324 and forward the inventoried sending to be stored in storage 370. (Sending type can be audio type, can be text message type, can be image type, can be video type, or can be some other sending type. Audio can be two types, audio message and audio content.)

Sendings type register 372 can include an audio type register 388 shown as ATR 388. Audio type register 388 functions to register at least one sending by audio type (e.g. an audio type sending can comprise music, voice, sound effects, sounds of nature etc.) As one example of audio type register 388, register 388 can obtain sending type information included along with a received sending. For this example, type register 388 can recognize from sending type information that the sending constitutes an audio sending. Register 388 can then register audio type to the sending. Register 350 can compile a registration number inclusive of the registered audio type as a component by including AU in the registration number. Registry 350 can add the registration number to inventory 324 and forward the inventoried sending to be stored in storage 370. For example, the sending can be the above example sending assigned the registration number 5095346666-10/03/2011. Registry 350 can include AU in the registration number. The registration number can then be, as an example for this example, 5095346666-10/03/2011-AU. Registry 350 can add the registration number to inventory 324 and forward the inventoried sending to be stored in storage 370. Registry 350 can find the sending in inventory 324 identifiable by the entire registration number, identifiable by the 5346666 component, identifiable by the 10/03/2011 component and identifiable by the AU component. Subsequently, a sendings request to registry 350 can be made by, for example, sendings provider 375 or by some other hardware to provide, for example, all audio sendings inventoried. Registry 350 can respond to said request by searching inventory 324 for registration numbers inclusive of AU. For each registration number found, registry 350 can then provide from storage 370 to the requester the audio sending having the assigned registration number.

Sendings type register 372 can include a text message type register 382 shown as TMTR 382. Text message type register 382 functions to register at least one sending by text message type (e.g. a text message type sending can comprise a poem, a joke, a saying, a motto, a theme, a title etc.). As one example of text message type register 382, register 382 can obtain sending type information included along with a received sending. For this example, type register 382 can recognize from sending type information that the sending constitutes a text message sending. Register 382 can then register text message type to the sending. Register 350 can compile a registration number inclusive of the registered text message type as a component by including TM in the registration number. Registry 350 can add the registration number to inventory 324 and forward the inventoried sending to be stored in storage 370. For example, the sending can be the above example sending assigned the registration number 5095346666-10/03/2011. Registry 350 can include TM in the registration number. The registration number can then be, as an example for this example, 5095346666-10/03/2011-TM. Registry 350 can add the registration number to inventory 324 and forward the inventoried sending to be stored in storage 370. Registry 350 can find the sending in inventory 324 identifiable by the entire registration number, identifiable by the 5346666 component, identifiable by the 10/03/2011 component and identifiable by the TM component. Subsequently, a sendings request to registry 350 can be made by, for example, sendings provider 375 or by some other hardware to provide, for example, all text message sendings inventoried. Registry 350 can respond to said request by searching inventory 324 for registration numbers inclusive of TM. For each registration number found, registry 350 can then provide from storage 370 to the requester the text message sending having the assigned registration number.

Sendings type register 372 can include an image type register 383 shown as ITR 383. Image type register 383 functions to register at least one sending by image type (e.g. an image type sending can comprise a picture of an-other party who the user converses with via provider 121, a favorite picture of an-other party, an-other party's worst nightmare, a design, a map etc.). As one example of image type register 383, register 383 can obtain sending type information included along with a received sending. For this example, type register 383 can recognize from sending type information that the sending constitutes an image sending. Register 383 can then register image type to the sending. Register 350 can compile a registration number inclusive of the registered image type as a component by including IM in the registration number. Registry 350 can add the registration number to inventory 324 and forward the inventoried sending to be stored in storage 370. For example, the sending can be the above example sending assigned the registration number 5095346666-10/03/2011. Registry 350 can include IM in the registration number. The registration number can then be, as an example for this example, 5095346666-10/03/2011-IM. Registry 350 can add the registration number to inventory 324 and forward the inventoried sending to be stored in storage 370. Registry 350 can find the sending in inventory 324 identifiable by the entire registration number, identifiable by the 5346666 component, identifiable by the 10/03/2011 component and identifiable by the IM component. Subsequently, a sendings request to registry 350 can be made by, for example, sendings provider 375 or by some other hardware to provide, for example, all image sendings inventoried. Registry 350 can respond to said request by searching inventory 324 for registration numbers inclusive of IM. For each registration number found, registry 350 can then provide from storage 370 to the requester the image sending having the assigned registration number.

Sendings type register 372 can include a video type register 384 shown as VTR 384. Video type register 384 functions to register at least one sending by video type (e.g. a video type sending can comprise a video starring an-other party whom the user converses with, a favorite video of an-other party, a movie clip, a internet posted video clip, a commercial, an infomercial etc.). As one example of video type register 384, register 384 can obtain sending type information included along with a received sending. For this example, type register 384 can recognize from sending type information that the sending constitutes a video sending. Register 384 can then register video type to the sending. Register 350 can compile a registration number inclusive of the registered video type as a component by including VD in the registration number. Registry 350 can add the registration number to inventory 324 and forward the inventoried sending to be stored in storage 370. For example, the sending can be the above example sending assigned the registration number 5095346666-10/03/2011. Registry 350 can include VD in the registration number. The registration number can then be, as an example for this example, 5095346666-10/03/2011-VD. Registry 350 can add the registration number to inventory 324 and forward the inventoried sending to be stored in storage 370. Registry 350 can find the sending in inventory 324 identifiable by the entire registration number, identifiable by the 5346666 component, identifiable by the 10/03/2011 component and identifiable by the VD component. Subsequently, a sendings request to registry 350 can be made by, for example, sendings provider 375 or by some other hardware to provide, for example, all video sendings inventoried. Registry 350 can respond to said request by searching inventory 324 for registration numbers inclusive of VD. For each registration number found, registry 350 can then provide from storage 370 to the requester the video sending having the assigned registration number.

Sendings registry 350 can include a sending class register 326. Class register 326 functions to register a sending by sending class. An exemplary class register 326 is depicted in FIGS. 2a through 2j. The exemplary class register 326 can include circuitry and/or programming to register a sending by sending class. As one example of this exemplary register 326, register 326 can determine class information by determining from where the sending came to registry 350 and can register the sending by said class information. Registry 350 can compile a registration number for the sending inclusive of the registered sending class information as a component. Registry 350 can add the registration number to inventory 324 and forward the inventoried sending to be stored in storage 370.

Sendings class register 326 can include a received class register 328, depicted in FIGS. 2a through 2j, shown as Received 328. Received class register 328 functions to register a sending by received class. As one example of received class register 328, register 328 can recognize that a sending has been received from sendings receiver 340 and can register the sending as received class. Registry 350 can compile a registration number inclusive of the register 326 registered received class as a component by including RE in the registration number assigned to the sending. Registry 350 can list the registration number in inventory 324 and forward the inventoried sending to be stored in storage 370. For example, the sending can be the above example video type sending assigned the registration number 5095346666-10/03/2011-VD. The registered RE component can be included in the registration number. The registration number can then be 5095346666-10/03/2011-VD-RE. Registry 350 can list the registration number in inventory 324 and can forward the inventoried sending to be stored in storage 370. Registry 350 can find the sending in inventory 324 identifiable by the entire registration number, identifiable by the 5346666 component, by the 10/03/2011 component, identifiable by the VD component and identifiable by the RE component. Subsequently, a sendings request to registry 350 can be made by, for example, sendings provider 375 to provide, for example, all received sendings inventoried. Registry 350 can respond to said request by searching inventory 324 for sendings having RE in their registration number. For each sending found, registry 350 can then provide the received sending from storage 370 to the requester.

Sendings class register 326 can include an identified class register 322, depicted in FIGS. 2f, 2i and 2j, shown as Identified 322. Identified class register 322 functions to register a sending by identified class. As one example of identified class register 322, register 322 can recognize that a sending has been received from sendings identifier 345 (meaning identifier 345 has identified the sending) and can register the sending as identified class. Registry 350 can compile a registration number inclusive of the register 322 registered identified class as a component by including ID in the registration number assigned to the sending. Registry 350 can list the registration number in inventory 324 and forward the inventoried sending to be stored in storage 370. For example, the sending can be the above example video type sending assigned the registration number 5095346666-10/03/2011-VD. The registered ID component can be included in the registration number. The registration number can then be 5095346666-10/03/2011-VD-ID. Registry 350 can list the registration number in inventory 324 and can forward the inventoried sending to be stored in storage 370. Registry 350 can find the sending in inventory 324 identifiable by the entire registration number, identifiable by the 5346666 component, identifiable by the 10/03/2011 component, identifiable by the VD component and identifiable by the ID component. Subsequently, a sendings request to registry 350 can be made by, for example, sendings provider 375 to provide, for example, all identified sendings inventoried. Registry 350 can respond to said request by searching inventory 324 for sendings having ID in their registration number. For each sending found, registry 350 can then provide the identified sending from storage 370 to the requester.

Sendings class register 326 can include a non-identified class register 327, depicted in FIGS. 2f, 2I and 2j, shown as Non-identified 327. Non-identified class register 327 functions to register a sending by non-identified class. As one example of non-identified class register 327, register 327 can receive a sendings forwarded from identifier 345 with instruction from identifier 345 that the sending was not identified. Register 327 can register the sending as non-identified class. Registry 350 can compile a registration number inclusive of the register 327 registered non-identified class as a component by including NON in the registration number assigned to the sending. Registry 350 can list the registration number in inventory 324 and can forward the inventoried sending to be stored in storage 370. Registry 350 can identify the sending in the manner as suggested for the above identified call register 322. Sendings class register 326 can include a user-selected class register 387, depicted in FIGS. 2g, 2i and 2j shown as User-selected 387. User-selected class register 387 functions to register a sending by user-selected. As one example of user-selected class register 387, register 387 can recognize that a sending has forwarded from a user-selected sendings supplier 380 (or that supplier 380 has been employed), and can then register the sending as user-selected class. Registry 350 can compile a registration number inclusive of the register 326 registered identified class as a component by including US in the registration number assigned to the sending. For example, the sending can be the above example video type sending assigned the registration number 5095346666-10/03/2011-VD. The registered US component can be included in the registration number. The registration number can then be 5095346666-10/03/2011-VD-US. Registry 350 can list the registration number in inventory 324 and can forward the inventoried sending to be stored in storage 370. Registry 350 can find the sending in inventory 324 identifiable by the entire registration number, identifiable by the 5346666 component, identifiable by the 10/03/2011 component, identifiable by the VD component and identifiable by the US component. Subsequently, a sendings request to registry 350 can be made by, for example, sendings provider 375 to provide, for example, all user-selected sendings inventoried. Registry 350 can respond to said request by searching inventory 324 for sendings having US in their registration number. For each sending found, registry 350 can then provide the user-selected sending from storage 370 to the requester. (Register 387 can function to register user-selected sendings by sub-classes of user-selected, for example user favorites, contact list etc.)

This second embodiment includes a storage 370. Storage 370 functions to store sendings. The storage of sendings in storage 370, including the subsequent locating, reading, copying and deleting can be accomplished in any manner as presently practiced in the electronic storage of a data file. A stored sending can comprise a stored file containing the sending. An exemplary storage 370 is depicted in FIGS. 2a through 2j. The exemplary storage 370 can include circuitry and/or programming to store sendings. For this exemplary storage 370, a stored sending can be a sending inventoried by sendings registry 350, a stored sending can be a sending forwarded to storage 370 by registry 350 for storage in storage 370. Automatic register 401 can automatically register a sending and registry 350 can compile a registration number and list the registration number in inventory 324 and can forward the registered and inventoried sending to storage 370. The user can employ manual register 402 to register a sending and registry 350 can compile a registration number for the sending and can list the number in inventory 324 and can forward the registered and inventoried sending to storage 370. Registry 350 can locate a sending stored in storage 370 and can then read, copy and/or delete the sending.

Storage 370 can store any sending type sending: audio message type, audio content type, text message type, image type, video type. Storage 370 can be a storage component dedicated solely to storing received sendings and/or received identified sendings. Conversely, storage 370 can be a storage component that stores received sendings and/or received identified sendings and also stores, for example, user-selected sendings. Storage 370 can be a storage component that stores received sendings and/or received identified sendings and also stores, for example, non-related files. Storage 370 can be a storage that stores received sendings and/or received identified sendings across multiple storage components. (Storage 370 can comprise a conventional component or components and, therefore, has not been discussed in detail.)

This second embodiment includes a sendings provider 375. Sendings provider 375 functions to provide sendings. An exemplary sendings provider 375 is depicted in FIGS. 2a through 2j. The exemplary sendings provider 375 can include circuitry and/or programming to provide at least one sending. For this exemplary provider 375, said provide at least one sending can include obtaining at least one sending and can include dispatching at least one sending. Provider 375 can obtain inventory information from registry 350 and can obtain an inventoried sending from registry 350. Said obtain an inventoried sending can include requesting registry 350 read a sending file and forward the read to provider 375. Said obtain an inventoried sending can include requesting registry 350 make and forward a copy of a sending file to provider 375. Provider 375 can respond to instruction from a delivery trigger 390 by obtaining and dispatching a read of a sending file (trigger 390 described later). Provider 375 can respond to instruction from delivery trigger 390 by obtaining and dispatching a copy of a sending file. Provider 375 can dispatch a file to a deliverer 360 (deliverer 360 described later).

Sendings provider 375 can operate as an audio sendings provider 331. Audio sendings provider 331 functions to obtain and to dispatch at least one audio sending. Provider 331 can provide an audio sending by obtaining and dispatching the sending. The exemplary provider 375 can operate as a text message sendings provider 332. Text message sendings provider 332 functions to provide at least one text message sending. Provider 332 can provide a text message sending by obtaining and dispatching the sending. The exemplary provider 375 can operate as an image sendings provider 333. Image sendings provider 333 functions to provide at least one image sending. Provider 333 can provide an image sending by obtaining and dispatching the sending. The exemplary provider 375 can operate as a video sendings provider 334. Video sendings provider 334 functions to provide at least one video sending. Provider 334 can provide a video sending by obtaining and dispatching the sending. (Provider 375 can employ one circuitry to provide for the operation of one or more of providers 331, 332, 333 and 334. Conversely, provider 375 can employ a plurality of circuitry to provide for the operation of more than one of providers 331, 332, 333 and 334.)

Exemplary sendings provider 375 includes a sendings obtainer 335 and a sendings dispatcher 336. Sendings obtainer 335 functions to obtain a sending. An exemplary sendings obtainer 335 is depicted in FIGS. 2a through 2j, shown as Obtainer 335. The exemplary obtainer 335 can include circuitry and/or programming to obtain at least one sending. This example of obtainer 335 can respond to a delivery trigger 390 by obtaining at least one sending (trigger 390 described later). Obtainer 335 can obtain a sending by requesting registry 350 provide a sending located in an inventory. Said requesting a sending can include requesting registry 350 read a sending file and forward the read to dispatcher 336. Said request a sending can include requesting registry 350 copy a sending file and forward the copy to dispatcher 336. Obtainer 335 can be configured to request from registry 350 one or more type of sending. Examples of a sending type include: audio type, text message type, image type, video type or some other type sending. As one example, obtainer 335 can request registry 350 provide a sendings registered as a video type. Obtainer 335 can be configured to request from registry 350 one or more sendings of a given sending type. As one example, obtainer 335 can request registry 350 provide a copy of five sendings registered to a given sending type. Obtainer 335 can be configured to request from registry 350 one or more sendings registered to an address of the other party of a telephone call, for example a telephone number stored in other party address register 357 (register 357 described below). Obtainer 335 can be configured to request form registry 350 at least one sending registered during a time period, for example employing time register 371.

Obtainer 335 can include a sendings prioritizer 341. Sendings prioritizer 341 functions to prioritize one or more sendings. An exemplary prioritizer 341 is depicted in FIGS. 2a through 2j, shown as Prioritizer 341. The exemplary prioritizer 341 can include circuitry and/or programming to prioritize one or more sendings. This exemplary prioritizer 341 can be configured to prioritize one or more sendings from a plurality of available sendings. Prioritizer 341 can request sendings registry 350 provide sendings inventory information (for example, sendings registration numbers). Prioritizer 341 can employ said inventory information to prioritize one or more sendings. Obtainer 335 can subsequently request registry 350 provide said prioritized one or more sendings. Registry 350 can provide said prioritized one or more sendings by providing said to sendings dispatcher 336.

As one example of this exemplary prioritizer 341, obtainer 335 can request prioritizer 341 choose a last stored sending. As an example, a sending of a given type from a given telephone number is inventoried by registry 350 and stored in storage 370. At some later date, a next/last sending of the same type from the same telephone number is inventoried by registry 350 and stored in storage 370. Subsequently, for example, provider 375 is triggered by receipt of an incoming call to obtain and dispatch a sending. For this example, obtainer 335 (of provider 375) is configured to obtain the last audio sending received from the calling telephone (the given telephone number). In response to the triggering, obtainer 335 employs prioritizer 341 to determine the last audio sending received from the given/calling telephone number. Prioritizer 341 instructs registry 350 to provide the registration numbers of all image sendings inventoried to the given/calling telephone number. Registry 350 provides, as an example, five registration numbers to prioritizer 341. Included in each registration number is the time/date of registration (registered by time register 371). Prioritizer 341 determines from the time of registration for each of the five registration numbers the last audio sending received and requests registry 350 provide said last audio sending received to sendings dispatcher 336.

As another example of prioritizer 341, prioritizer 341 can in effect prioritize a sending by deleting a prior stored sending upon the arrival of a next sending. For example, from inventory information provided by registry 350, prioritizer 341 can respond to each sending received/registered by registry 350 by searching said inventory information to locate any sendings received prior of the same type and of the same identity information. Prioritizer 341 can employ time registered by time registry 371 to determine a sending received prior. Responsive to locating any of said sending received prior, prioritizer 341 can request registry 350 delete said sending received prior.

As another example of prioritizer 341, prioritizer 341 can be configured to prioritize a sending by requesting registry 350 periodically delete all sendings. For example, prioritizer 341 can request registry 350 delete all sendings at the conclusion to each telephone call or delete all sendings at the conclusion to each calendar day or delete all sendings at the conclusion to each calendar month or delete all sendings at some other event or for some reason. (Said all sendings can be all sendings stored of a given type or can be all sendings stored, can be all sendings inventoried to the same identity information, can be all sendings of a given sending type inventoried to the same identity information or can be other.

As another example of prioritizer 341, prioritizer 341 can be configured to prioritize a sending by randomly choosing a sending from a plurality of stored sendings (said randomly chosen sending subsequently provided by registry 350 for example to dispatcher 336). As one example, prioritizer 341 can employ inventory information from registry 350 to randomly choose a sending from a plurality of sendings inventoried to the same type and same identity information. As another example, prioritizer 341 can employ inventory information from registry 350 to randomly choose a sending from all sendings stored inventoried to the same identity information. As another example, prioritizer 341 can employ inventory information from registry 350 to randomly choose one sending from all sendings stored.

As another example of prioritizer 341, prioritizer 341 can in effect prioritize a sending by requesting registry 350 not inventory and store a sending if a sending has been stored prior inventoried to the same type and same identity information. As another example of prioritizer 341, prioritizer 341 can be configured to prioritize a sending by, for example, requesting registry 350 provide a user-selected sending as a default sending if no received sending is found inventoried to a given identity information. As another example of prioritizer 341, prioritizer 341 can in effect prioritize one or more sendings by requesting registry 350 provide the first sending or sendings found in an inventory, as an example, the first found in an inventory being of a given type and/or of a given identity. (Prioritizer 341 can be located at registry 350. In other words, registry 350 can include for example programming to provide the above-described functionality of prioritizer 341. As examples, registry 350 can be configured to store a sending and delete any prior stored sending, can be configured to periodically delete sendings, can be configured to randomly choose sendings, can be configured to provide the first sending or sendings found in an inventory or can do other.)

This second embodiment can include an-other party address register 357. Other party address register 357 functions to obtain an address of an-other party. An exemplary address register 357 is depicted in FIGS. 2a through 2j, shown located at provider 375 and shown as OPAR 357. For this example, address register 357 can be configured to obtain an address, for example the telephone number of the telephone of the party's of a telephone call. For this example, register 357 can be further configured to store the obtained address. As an example, for a call incoming to the user, register 357 can obtain and store the telephone number provided in caller I.D. information supplied, for example, by service provider 121. Other party address register 357 can include circuitry and/or programming for obtaining the caller I.D. information included with the ring signal of an incoming call. Register 357 can store the obtained caller I.D. information, for this example, at storage In Number 319, hereafter referred to and shown in FIGS. 2a through 2j as IN #319. Obtainer 335 can then employ the telephone number stored at IN #319 to request one or more sendings from registry 350 registered to the telephone number stored at IN #319. The telephone number stored at IN #319 can be employed to designate, to provider 121 for example, where a sending is to be delivered. Provider 121 can then deliver a sending to the telephone of the telephone number stored at IN #319. (As another example of an address that register 357 can be configured to obtain, a serial number associated with the calling telephone can be included with the incoming ring signal or can be provided by provider 121 to the user's telephone upon provider 121 detecting an outgoing call from the user's telephone. A sending can be sent to the serial number and provider 121 can deliver the sending to the telephone associated with that serial number.)

As another example, for a call outgoing from the user, register 357 can stored the telephone number dialed by the user. Register 357 can include circuitry and/or programming for obtaining the telephone number dialed by a user when placing a telephone call. Register 357 can store the obtained called (dialed) telephone number, for this example, at storage Out Number 318, hereafter referred to and shown in FIGS. 2a through 2j as OUT #318. Obtainer 335 can then employ the telephone number stored at OUT #318 to request one or more sendings from registry 350 registered to the telephone number stored at OUT #318. The telephone number stored in OUT #318 can be employed to designate, to provider 121 for example, where a sending is to be delivered. Provider 121 can then deliver the sending to said desired destination.

Upon receipt of an incoming call or upon the user dialing a telephone number, register 357 can store the number of the other party's telephone at IN #319 or at OUT #318, respectively. Upon receipt of an incoming call or upon the user dialing a telephone number, register 357 can delete any prior stored telephone number whether located at IN #319 or at OUT #318.

As a first example of provider 375 employing address register 357, during a telephone call, obtainer 335 (of sendings provider 375) can respond to a delivery trigger 390 (trigger 390 described later) by requesting registry 350 provide sendings inventoried registered to the other party's address stored by register 357 in whichever of IN #319 or OUT #318 that contains a newly registered telephone number. Registry 350 can forward sendings found to dispatcher 336.

As a second example of provider 375 employing address register 357, during a telephone call, sendings dispatcher 336 can dispatch a sending to a service provider delivery 369. As one example, said sending dispatched can be a sending file and a file dispatcher 347 of dispatcher 336 (both dispatchers described below) can dispatch the sending file to service provider delivery 369. Along with the sending file, dispatcher 347 can obtain from register 357 the address (for example the telephone number) stored by register 357 and dispatch said address to delivery 369. Delivery 369 can then deliver the sending to a service provider addressed to the address obtained from register 357. The service provider can then deliver the sending to the obtained address. (The above said “during a telephone call” can include the period from when a call is first placed until the call is answered, can include the period of the conversation, can include the period after hang-up of the telephone call, can include the period after hang-up until receipt of a next call and can include the period after hang-up until dialing by the user of a next call. Also, address register 357 can be located elsewhere, for example between provider 375 and deliverer 360. In that configuration, delivery 369 can be electrically connected directly to register 357 and, thus can obtain an address directly from register 357 instead of via dispatcher 347 as disclosed above.) Exemplary sendings provider 375 includes a sendings dispatcher 336. Dispatcher 336 functions to dispatch sendings. An exemplary sendings dispatcher 336 is depicted in FIGS. 2a through 2j, shown as Dispatcher 336. The exemplary dispatcher 336 can include circuitry and/or programming to dispatch at least one sending. For this example, dispatcher 336 can dispatch a read sendings file. For this example, dispatcher 336 can dispatch a copy of a sendings file. Sendings obtainer 335 can request a sending from registry 350. Registry 350 can provide the requested sending to dispatcher 336. Dispatcher 336 can dispatch the sending to deliverer 360. Dispatcher 336 can include one or more of: a sendings arranger 337, an audio player 338, a text message feed 339, an image feed 343, a video player 346 and a file dispatcher 347.

Sendings dispatcher 336 can include an arranger 337. Arranger 337 functions to arrange sendings. An exemplary sendings arranger 337 is depicted in FIGS. 2a through 2j, shown as Arranger 337. The exemplary arranger 337 can include circuitry and/or programming to arrange sendings. For this example, arranger 337 can arrange sendings provided by registry 350. Arranger 337 can forward arranged sendings for dispatch to, for example, deliverer 360. Arranger 337 can include one or more of: a gallery arranger 342, a sendings sequencer 378 and a sendings repeater 392.

Arranger 337 can include a gallery arranger 342. Gallery arranger 342 functions to arrange a gallery. An exemplary gallery arranger 342 is depicted in FIGS. 2a through 2j, shown as Gallery 342. As a first example of this exemplary gallery arranger 342, arranger 342 can arrange a plurality of images into a gallery. As an example, obtainer 335 can be configured to arrange all image sendings inventoried into said one gallery image. For example, arranger 342 can request registry 350 provide all image sendings found in an inventory of registry 350 to gallery arranger 342. Arranger 342 can then arrange said all image sendings onto one gallery image (arranged, for example, in rows of image sendings), said one gallery image for dispatch to deliverer 360 for delivery. Arranger 342 can size said one gallery image to fit on a display (for example a display 361 or an image display 367, both described later). (Arranger 342 can arrange all stored images, can arrange all stored images inventoried to the same identity information, can arrange all stored images inventoried during a given time period, can arrange all stored images inventoried to the same subject or action and registered to the same identity information or can arrange all stored images of any other group or other.)

As another example of this first example, gallery arranger 342 can be configured to arrange the last given number of images inventoried into said one gallery image. For example, arranger 342 can arrange the last six images received registered to the same identity information. Obtainer 335 can employ prioritizer 341 to request registry 350 provide the registration numbers of all image sendings inventoried to the same identity information. For this example, registry 350 provides the registration numbers for ten images to prioritizer 341. Included in each registration number is the time/date of receipt (time/date registered by time register 371). Prioritizer 341 determines from the time/date of receipt of each of the ten images the last six images received. Prioritizer 341 then supplies the registration numbers of said last six images to registry 350 and requests registry 350 provide said last six images to arranger 342. Arranger 342 then arranges the six images onto one gallery image for dispatch to a deliverer 360 (for example to an image display 367 described later). (As another example, gallery arranger 342 can be configured to arrange a given number of randomly selected images, for example employing prioritizer 341, into said one gallery image.)

As a second example of this exemplary gallery arranger 342, arranger 342 can arrange a plurality of text messages. As an example, gallery arranger 342 can be configured to arrange a plurality of text message sendings onto one gallery image (arranged, for example, in rows of text message sendings), said one gallery image for dispatch to a deliverer 360 for delivery. Arranger 342 can arrange any prioritization of text message sendings and in any arrangement as described above in the first example of arranger 342 (arranging image sendings) or can arrange text message sendings otherwise.

As a third example of this exemplary gallery arranger 342, arranger 342 can arrange a plurality of videos. As an example, arranger 342 can be configured to arrange a plurality of videos by taking a frame out of each video and arranging the frames/images into rows arranged to fit onto one gallery image, said one gallery image for dispatch to a deliverer 360 (for example video display 368 described later). As another example, arranger 342 can be configured to arrange a plurality of videos by arranging the frame size of each video to fit onto one gallery image, said one gallery image for dispatch to a deliverer 360 for delivery. (For example arranging the frame sizes into rows arranged to fit onto said gallery image.) The plurality of videos can then be played simultaneously and all arranged playing videos can thus be viewed simultaneously on one display (for example video display 368). (The video can be a video clip and can be played from the beginning of the clip and, when the playing clip reaches it's end, the clip can be replayed.) (Said plurality of videos can be all inventoried videos, can be all videos inventoried to the same identity information, can be all videos inventoried during a given time period, can be all videos inventoried to the same subject or action and registered to the same identity information, can be the last given number of videos received, can be the last given number of videos received inventoried to the same identity information, can be a random selection of a given number of videos or can be other.)

Arranger 337 can include a sendings sequencer 378. Sendings sequencer 378 functions to arrange sequential dispatch. An exemplary sendings sequencer 378 is depicted in FIGS. 2a through 2j. As a first example of this exemplary sendings sequencer 378, sequencer 378 can arrange audio sendings for sequential dispatch. As an example, sequencer 378 can be configured to sequentially forward for dispatch all audio sendings found in an inventory of registry 350. Sequencer 378 can instruct obtainer 335 to obtain from registry 350 the registration numbers of all audio sendings inventoried and to then provide registry 350 with a first of the registration numbers corresponding to a first audio sending and instruct registry 350 to read the corresponding sending file and to forward the read to sequencer 378. (Obtainer 335 can employ prioritizer 341 and prioritizer 341 can randomly determine said first sending or can determine the first sending inventoried to be said first sending or other.) Sequencer 378 forwards the read of said first audio sending to be dispatched (for example, forwarded to audio player 338 for dispatching, player 338 described below).

Sequencer 378 can include a timer and can time a duration, for example a five-second duration (or can detect the end of an audio clip, or other). When the five-second duration has expired, sequencer 378 can instruct obtainer 335 to provide registry 350 with a second of the registration numbers corresponding to a second audio sending and instruct registry 350 to read the corresponding file and to forward the read to sequencer 378. Sequencer 378 forwards the read of said second audio sending to be dispatched (for example, forwarded to audio player 338 for dispatching). Arranger 342 can again time a five-second duration. When the five-second duration has expired, sequencer 378 can instruct obtainer 335 to provide registry 350 with a third of the registration numbers corresponding to a third audio sending and can instruct registry 350 to read the file corresponding to said third sending and to forward the read to sequencer 378, and so on. (When the five-second duration for the last audio sending has expired, sequencer 378 can be configured to loop back to obtainment and dispatch of the first audio sending. Also, sequencer 378 can operate similarly to sequentially arrange all audio sendings registered to a given telephone number, for example the telephone number of the other party of a telephone call as stored by register 357. Also, sequencer 378 can operate similarly and additionally can employ prioritizer 341 to arrange a given number out of all audio sendings inventoried for sequential dispatch, i.e. arrange the last given number of audio sendings inventoried, the last given number of audio sendings inventoried registered to a given telephone number or other.)

As a second example of this exemplary sendings sequencer 378, sequencer 378 can arrange text message sendings for sequential dispatch. As an example, sequencer 378 can be configured to sequentially forward for dispatch all text message sendings found in an inventory of registry 350. Sequencer 378 can instruct obtainer 335 to obtain from registry 350 the registration numbers of all text message sendings inventoried and to then provide registry 350 with a first of the registration numbers corresponding to a first text message sending and to instruct registry 350 to read corresponding file and to forward the read to sequencer 378. (Obtainer 335 can employ prioritizer 341 and prioritizer 341 can randomly determine said first sending or can determine the first sending inventoried to be said first sending or other.) Sequencer 378 forwards the read of said first text message sending to be dispatched (for example forwarded to text message feed 339 for dispatching, feed 339 described below).

Sequencer 378 can include a timer and can time a duration, for example a six-second duration (time adequate for the message to be reviewed). When the six-second duration has expired, sequencer 378 can instruct obtainer 335 to provide registry 350 with a second of the registration numbers corresponding to a second text message sending and instruct registry 350 to read the corresponding file and to forward the read to sequencer 378. Sequencer 378 forwards the read of said second text message sending to be dispatched (for example, forwarded to text message feed 339 for dispatching). Arranger 342 can again time a six-second duration. When the six-second duration has expired, sequencer 378 can instruct obtainer 335 to provide registry 350 with a third of the registration numbers corresponding to a third text message sending and instruct registry 350 to read the corresponding file and to forward the read to sequencer 378, and so on. (When the six-second duration for the last text message sending has expired, sequencer 378 can be configured to loop back to obtainment and dispatch of the first text message sending. Also, sequencer 378 can operate similarly to sequentially arrange all text message sendings registered to a given telephone number, for example the telephone number of the other party of a telephone call in progress as stored by register 357. Also, sequencer 378 can operate similarly and additionally can employ prioritizer 341 to arrange a given number out of all text message sendings inventoried for sequential dispatch, i.e. arrange the last given number of text message sendings inventoried, the last given number of text message sendings inventoried registered to a given telephone number or other.)

As a third example of this exemplary sendings sequencer 378, sequencer 378 arrange image sendings for sequential dispatch. As an example, sequencer 378 can be configured to sequentially forward for dispatch all image sendings found in an inventory of registry 350. Sequencer 378 can sequentially forward image sendings in a manner similar to that described in the above given example of sequencer 378 sequentially forwarding text message sendings for dispatch with the exception that image sendings can be forwarded to and dispatched by an image feed (for example image feed 343, feed 343 described below). (Sequencer 378 can sequentially forward all image sendings otherwise.)

(As suggested in the above example for sequencer 378 when configured to sequentially dispatch text message sendings, sequencer 378 can be configured to, upon completion of forwarding a last image sending, loop back to obtainment and dispatch of a first image sending. Also, sequencer 378 can operate similarly as described above for text message sendings, to arrange all image sendings registered to a given telephone number for sequential dispatch, for example the telephone number of the other party of a telephone call in progress. Sequencer 378 can operate similarly as described above for text message sendings and additionally can employ prioritizer 341 to arrange a given number out of all image sendings stored for sequential dispatch, i.e. arrange the last given number of image sendings inventoried, the last given number of image sendings inventoried registered to a given telephone number or other.)

As a fourth example of this exemplary sendings sequencer 378, sequencer 378 can arrange video sendings for sequential dispatch. As an example, sequencer 378 can be configured to sequentially forward for dispatch all video sendings found in an inventory of registry 350. Sequencer 378 can sequentially forward video sendings in a manner similar to that described in the above given example of sequencer 378 sequentially forwarding audio sendings for dispatch with the exception that video sendings can be forwarded to and dispatched by a video player (for example video player 346, player 346 described below). (Sequencer 378 can sequentially forward all video sendings otherwise. Also, Iin an alternate version, a frame can be taken out of each video and the frames/images can be sequentially forwarded to a feed for dispatch, for example image feed 343.)

(As suggested in the above example for sequencer 378 when configured to sequentially dispatch audio messages, sequencer 378 can be configured to loop back to obtainment and dispatch of the first video sending. Also, sequencer 378 can operate, similarly as described above for audio sendings, to sequentially arrange all video sendings registered to a given telephone number, for example the telephone number of the other party of a telephone call in progress, for sequential dispatch. Sequencer 378 can operate similarly as described above for audio sendings and in addition can employ prioritizer 341 to sequentially arrange a given number out of all video sendings inventoried for sequential dispatch, i.e. arrange the last given number of video sendings inventoried, the last given number of video sendings inventoried registered to a given telephone number or other.)

Arranger 337 can include a sendings repeater 392. Sendings repeater 392 functions to arrange repeated dispatch. An exemplary sendings repeater 392 is depicted in FIGS. 2a through 2j. As a first example of this exemplary sendings repeater 392, repeater 392 can arrange audio sendings for repeated dispatch. As an example, repeater 392 can be configured to repeatedly forward for dispatch the last audio sending inventoried by registry 350. Repeater 392 can employ prioritizer 341 (of obtainer 335). Repeater 392 can instruct prioritizer 341 to determine from the registration numbers of all audio sendings inventoried by registry 350 the last audio sending inventoried and to then request registry 350 provide to dispatcher 336 said determined last audio sending received. Repeater 392 can include a timer and can time a duration, for example a ten-second duration. For this example, repeater 362 measures the duration dispatcher 336 dispatches the sending. When the ten-second duration has expired, repeater 392 instructs prioritzer 341 to again request registry 350 provide said last audio sending received to sendings dispatcher 336. Repeater 392 again measures the duration dispatcher 336 dispatches the sending. When the ten-second duration has expired, repeater 392 instructs prioritzer 341 to again request registry 350 provide said last audio sending received to sendings dispatcher 336, and so on. (Repeater 392 can operate in a similar manner to arrange text message sendings for repeated dispatch. Repeater 392 can operate in a similar manner to arrange image sendings for repeated dispatch. Repeater 392 can operate in a similar manner to arrange video sendings for repeated dispatch.)

Dispatcher 336 can include an audio player 338. Audio player 338 functions to provide an audio feed. An exemplary audio player 338 is depicted in FIGS. 2a through 2j. The exemplary audio player 338 can include circuitry and/or programming to provide an audio feed. For this example, audio player 338 can receive from registry 350 a read of an audio sending and can play the read. (Alternately, player 338 can receive an audio sending file from registry 350 and can read the file and play the read.) Audio player 338 can dispatch an audio feed of the playing audio sending to deliverer 360. (Deliverer 360 can comprise one or more speakers and the audio feed can drive the speakers, the speaker can be, for example, speaker 362 described below.)

Dispatcher 336 can include a text message feed 339. Text message feed 339 functions to provide a text message feed. An exemplary text message feed is depicted in FIGS. 2a through 2j, shown as Text Msg. Feed 339. The exemplary text message feed 339 can include circuitry and/or programming to provide a text message feed. For this example, text message feed 339 can receive from registry 350 a read of a text message sending and can dispatch a feed of the read. Feed 339 can dispatch the feed of the read text message sending to deliverer 360. (Deliverer 360 can comprise a display and the feed can drive the display to display the text message sending. The display can be, for example, display 361 or text message display 366, both described below. In one variation, said text message sending can comprise a book and feed 339 can operate to feed a text message player, the player to provide pages of the book, for example one page at a time.)

Dispatcher 336 can include an image feed 343. Image feed 343 functions to provide an image feed. An exemplary text message feed is depicted in FIGS. 2a through 2j. The exemplary image feed 343 can include circuitry and/or programming to provide an image feed. For this example, image feed 343 can receive from registry 350 a read of an image sending and can dispatch a feed of the read. Feed 343 can dispatch the feed of the read image sending to deliverer 360. (Deliverer 360 can comprise a display and the feed can drive the display to display the image sending. The display can be, for example, display 361 or image display 367, both described below. Also, one feed can be employed to operate as both text message feed 339 and image feed 343.)

Dispatcher 336 can include a video player 346. Video player 346 functions provide a video feed. An exemplary video player 346 is depicted in FIGS. 2a through 2j. The exemplary video player 346 can include circuitry and/or programming to provide a video feed. For this example, video player 346 can receive from registry 350 a read of a video sending and can play the read. (Alternately, player 346 can receive a video sending file from registry 350 and can read the file and play the read.) Video player 346 can dispatch a video feed of the playing video sending to deliverer 360. (Deliverer 360 can comprise a display and the video feed can be displayed on the display, the display can be, for example, display 361 or video display 368, both described below.)

Dispatcher 336 can include a file dispatcher 347. File dispatcher 347 functions to dispatch a sending file. An exemplary file dispatcher 347 is depicted in FIGS. 2a through 2j, shown as File Dsp. 347. The exemplary file dispatcher 347 can include circuitry and/or programming to dispatch a sending file. For this example, file dispatcher 347 can receive a sending file from registry 350 and can dispatch the sending file. (Said sending file copied by registry 350 and provided by registry 350 to dispatcher 347.) Dispatcher 347 can dispatch a sending file to deliverer 360. Dispatcher 347 can dispatch an audio sending file, can dispatch a text message sending file, can dispatch an image sending file and can dispatch a video sending file.

This second embodiment includes a deliverer 360. Deliverer 360 functions to deliver sendings. An exemplary deliverer 360 is depicted in FIGS. 2a through 2j. The exemplary deliverer 360 can include circuitry and/or programming to deliver sendings. For this exemplary deliverer 360, said at least one sending can be a sending dispatched to deliverer 360 from sendings dispatcher 336 (of sendings provider 375). For example, deliverer 360 can be dispatched a sending from one or more of: audio player 338, text message feed 339, image feed 343, video player 346 and file dispatcher 347. A sending dispatched to deliverer 360 can be delivered by deliverer 360. Deliverer 360 can include one or more of: a speaker 362, a display 361, a text message display 366, an image display 367, a video display 368, an email delivery 363, a web-site poster 374, a service provider delivery 369, a delivery port 364, a ring-back delivery 391 and can include some other delivery.

Deliverer 360 can include a speaker 362. Speaker 362 functions to deliver audio. An exemplary speaker 362 is depicted in FIGS. 2a through 2j. The exemplary speaker 362 can include circuitry and/or programming to deliver audio. For this exemplary speaker 362, an audio sending can be dispatched from an audio dispatcher, for example audio player 338, to speaker 362. The dispatched audio can drive speaker 362 to deliver the audio for a user to hear. Speaker 362 can comprise one or more of: a broadcasting type speaker, a telephone receiver type speaker, a telephone ringer, a telephone ring-tone deliverer type speaker and some other type speaker.

Deliverer 360 can include a display 361. Display 361 functions to display at least one sending. An exemplary display 361 is depicted in FIGS. 2a through 2j. The exemplary display 361 can include circuitry and/or programming to display at least one sending. This example of display 361 can function as one or more of: a text message display 366 (shown as Text Msg. Display 366), an image display 367 (shown as Image 367) and a video display 368 (shown as Video 368). (Alternately, display 366, display 367 and display 368 can be separate displays. In one embodiment, display 361 can be divided into dedicated sections with each section functional as one of displays 366, 367 and 368.) A text message sending can be dispatched to display 361 (or to display 366). Display 361 can function as text message display 366 to deliver/display the text message for a user to view/read. An image sending can be dispatched to display 361 (or to display 367). Display 361 can function as image display 367 to deliver/display the image for a user to view. A video sending can be dispatched to display 361 (or to display 368). Display 361 can function as video display 368 to deliver/display the video sending for a user to view. The prior-described graphic user interface (shown as GUI 210) can be employed to provide the functionality of display 361 and, thus, the functionality of display 366, display 367 and/or display 368. GUI 210, functioning as display 361, can be divided into dedicated sections, for example with each section functional as one of displays 366, 367 and 368.

Deliverer 360 can include a plurality of display 361. For example, present-day cell phones employ a two-display flip open type of cell phone. The phone when closed sports an outer display and flipping the phone open to converse yields an inner display. Display 361 can comprise said outer display. Display 361 can comprise said inner display. Also, display 361 can function as the prior described caller I.D. display 21. GUI 210 can function as the prior described caller I.D. display 21.

Deliverer 360 can include an email delivery 363. Email delivery 363 functions to deliver sendings for receipt at an email account. An exemplary email delivery 363 is depicted in FIGS. 2a through 2j, shown as ED 363. The exemplary delivery 363 can include circuitry and/or programming to deliver a sendings for receipt at an email account. This example of delivery 363 can deliver one or more type of sending, for example: audio type, text message type, image type and video type. A sending delivered by delivery 363 can be in the form of a sending file. Said sending file can be a file dispatched from a file dispatcher, for example file dispatcher 347 to email delivery 363. Delivery 363 can deliver a sending file inclusive of an email address for receipt at an email account, said receipt at an email account can be via an email account provider. Said provider can employ said email address to deliver the file to said email account. A sending file delivered to an email account via said email account provider can be delivered from delivery 363 to said email account provider via a wifi internet connection or via internet access provided by provider 121 or via service provider 121 or via some other pathway. Examples of said email account provider include: Yahoo.com, Netzero.net and gmail.com. Many entities comprise in-house email account providing thus constituting an email account provider, for example: government offices, law offices, corporations etc., as examples: Johnson@wa.usda.gov or Williams@Hydrolinear.com. (As one example of said email address, said address can be the user's email address. As another example, said address can be the email address of the other party of a telephone call. As another example, said email address can be another party's email address.)

Email delivery 363 includes an email delivery addresser 379. Email delivery addresser 379 functions provide an email address. An exemplary email delivery addresser 379 is depicted in FIGS. 2a through 2j, shown as EDA 379. The exemplary addresser 379 can employ GUI 210. To act as addresser 379, GUI 210 can include circuitry and/or programming to enable a user to provide an email address for email delivery of a sending. GUI 210 can provide the user with a keypad enabling the user to enter an email address. (Alternately, an email address can be pre-provided in telephone 27 by for example the telephone manufacturer or can be provided by provider 121 or other.) GUI 210 can forward the entered address to email delivery 363. Delivery 363 can deliver a sending inclusive of the email address for receipt at an email account.

Deliverer 360 can include a web-site poster 374. Web-site poster 374 functions to post sendings to an internet web-site. An exemplary web-site poster 374 is depicted in FIGS. 2a through 2j, shown as ID 374. The exemplary poster 374 can include circuitry and/or programming to post sending to an internet web-site. This example of poster 374 can post, for example: an audio sending, a text message sending, an image sending, a video sending, a combination video/audio sending or other. As an example, an inventory reviewer 447 can provide a review of an inventoried sending to a user. Upon seeing and/or hearing the sending from the provided review, a user can employ a post trigger 444 to trigger the posting of the sending. A triggered trigger 447 can instruct provider 375 to provide the sending to web-site poster 374. Provider 375 can provide the sending by employing file dispatcher 347 to dispatch the sending to web-site poster 374. Poster 374 can post the sending to an internet web-site by delivering the sending inclusive of an internet address for receipt at an Internet web-site, said receipt at an internet web-site can be via an internet service provider and can be via the internet. Said internet service provider can be accessed by poster 374 via service provider 121 or via a wifi internet connection or via internet access provided by provider 121 or via some other pathway or service provider 121 can be the internet service provider. Web-site poster 374 includes a web-site poster addresser 381 and can include one or more of a manual poster 453 and an auto poster 454.

Web-site poster 374 includes a web-site poster addresser 381. Web-site poster addresser 381 functions to provide an internet web-site address. An exemplary web-site poster addresser 381 is depicted in FIGS. 2a through 2h, shown as IDA 381. As one example of the exemplary addresser 381, addresser 381 can employ GUI 210. To act as addresser 381, GUI 210 is configured to be capable of being placed in electronic communication with circuitry and/or programming to enable a user to provide an internet address. GUI 210 can provide the user with a keypad enabling the user to enter an internet address. GUI 210 can forward the entered address to web-site poster 374. Poster 374 can deliver a sending inclusive of the user-entered address for receipt at an internet web-site.

As another example of the exemplary addresser 381, addresser 381 can be supplied an internet address by a telephone manufacturer said internet address can be an address programmed into telephone 27. As another example, addresser 381 can be supplied an internet address by service provider 121. For example, said address supplied can be that of a social media web-site.

Web-site poster 374 can include a manual poster 453. Manual poster 453 functions to enable a user to post a sending to a web-site. An exemplary manual poster 453 is depicted in FIGS. 2a through 2h, shown as MP 453. The exemplary manual poster 453 can include GUT 210. To act as poster 453, GUI 210 is configured to be capable of being placed in electronic communication with circuitry and/or programming to enable a user to post a sending to a web-site. GUI 210 can provide the user with a keypad enabling the user to enter information required for posting a sending. The information can be, for example, a user name, a user password or other. As an example, provider 375 can provide a sending to web-site poster 374. Poster 374 can employ addresser 381 to provide an internet web-site address. Poster 374 can store the addressed sending. A user can employ GUI 210 to access the internet web-site having the provided internet address (accessed via an internet service provider). The user can employ GUI 210 to provide the web-site with log-in information and can subsequently post the stored sending.

Web-site poster 374 can include an auto poster 454. Auto poster 454 functions to automatically post a sending to a web-site. An exemplary auto poster 454 is depicted in FIGS. 2a through 2h, shown as AP 454. The exemplary auto poster 454 can post an addressed sending. The exemplary auto poster 454 can enter information required for posting a sending. The information can be, for example, a user name, a user password or other. As an example, provider 375 can provide a sending to web-site poster 374. Poster 374 can employ addresser 381 to provide an internet web-site address. Auto poster 354 can access the internet web-site having the provided internet address (accessed via an internet service provider) and can automatically post the sending to the web-site provided that the web-site does not require any information to post a sending. If information is required, in one example, poster 454 can be configured to enable a user to supply required information to log into a web-site and, once logged into the web-site, poster 454 can maintain the logged-in status. Upon receipt of a sending to be posted, poster 454 can then post the sending to the already logged into web-site. If information is required, in another example, upon receipt of a sending to be posted, poster 454 can access the internet web-site of the provided internet address and enter information required for posting a sending, for example login information. The information can be, for example, a user name, a user password or other. Upon entering the information, poster 454 can post the sending.

Deliverer 360 can include a telephone service provider delivery 369. Service provider delivery 369 functions to deliver sendings to a telephone service provider. An exemplary service provider delivery 369 is depicted in FIGS. 2a through 2j, shown as SPD 369. The exemplary provider delivery 369 can include circuitry and/or programming to deliver at least one sending to a telephone service provider. For this example of provider delivery 369, a sending delivered can be an audio message and/or an audio content, can be a text message, can be an image, can be a video or can be other. A sending delivered by the service provider delivery 369 to a service provider can be in the form of a read sending. A sending delivered by the service provider delivery 369 to a service provider can be in the form of a sending file. Said sending file can be dispatched to service provider delivery 369 from a file dispatcher, for example from file dispatcher 347. Service provider delivery 369 can deliver the dispatched sending to a telephone service provider, for example, service provider 121. Delivery 369 can include an address with a sending delivered to the provider, for example a telephone number of the desired destination for said sending. Provider 121 can then deliver the sending, for example to the included telephone number. Delivery 369 can supply an address stored by other party address register 357 to a service provider and the service provider can deliver the sending to the supplied address from other party address register 357.

Service provider delivery 369 includes a service provider delivery addresser 386. Service provider delivery addresser 386 functions to provide an address. An exemplary service provider delivery addresser 386 is depicted in FIGS. 2a through 2j shown as PDA 386. The exemplary addresser 386 can employ GUI 210. To act as addresser 386, GUI 210 can include circuitry and/or programming to enable a user to provide an address for service provider delivery of a sending. GUI 210 can provide the user with a keypad enabling the user to enter an address, for example a telephone number. (Alternately, an address can be pre-provided in telephone 27 by for example the telephone manufacturer or can be provided by provider 121 or other.) GUI 210 can forward the entered address, for example telephone number, to service provider delivery 369. Delivery 369 can deliver a sending inclusive of the user-entered address for receipt at the entered address, for example via provider 121.

Deliverer 360 can include a delivery port 364. Delivery port 364 functions to enable delivery of sendings to an external device. An exemplary delivery port 364 is depicted in FIGS. 2a through 2j, shown as PORT 364. The exemplary delivery port 364 can include circuitry and/or programming to enable delivery of at least one sending to an external device. This example of delivery port 364 can enable delivery of an audio message and/or an audio content, can enable delivery of a text message, can enable delivery of an image or can enable delivery of a video. Said external device can comprise a device external to telephone 27. Deliver port 364 can deliver one or more sendings to one or more external devices. Said devices can be electrically connected to (or connectable to) delivery port 364. For example, one or more sendings can be delivered from port 364 to one or more of a personal computer, a fax machine, a printer, a music player, a television, or some other external device. The delivered sending can then be utilized on said external device.

Deliverer 360 can include a ring-back delivery 391. Ring-back delivery 391 functions to deliver a ring-back. An exemplary ring-back delivery 391 is depicted in FIGS. 2a through 2j, shown as RBD 391. The exemplary ring-back delivery 391 can include circuitry and/or programming to deliver a ring-back. For this example of ring-back delivery 391, delivery 391 can include answering circuitry to answer an incoming call and to send/deliver audio to the caller (the audio, for example, to entertain the caller and to inform the caller that the user is being alerted as to the presence of the incoming call). Said answering circuitry can detect said incoming call and can respond by answering the call (answering the call can include generating an off-hook condition). To send audio to the caller, ring-back delivery 391 can signal obtainer 335. Obtainer 335 can respond to the signal by providing the other party's address stored in register 357 to registry 350 and by requesting registry 350 search an inventory for an audio sending inventoried to the provided address (for example the latest audio sending). Registry 350 can then provide a found audio sending to audio player 338. Player 338 can respond by playing said audio sending and by dispatching an audio feed of the playing audio sending to ring-back delivery 391. Having answered the incoming call, delivery 391 can deliver the playing audio sending back to the caller (via provider 121). In other words, an audio sending received from the caller, at some date prior to the phone call, is subsequently being delivered as the ring-back when the caller calls the user (can be delivered as the ring-tone to the user as well). (If no audio sending is found registered to the other party's telephone number, a user-selected default audio sending can be provided by registry 350 in place of said no audio sending; user-selected sendings supplier 380 described later. In another example of ring-back delivery 391, a file of said audio sending inventoried to the address can be delivered to provider 121 and provider 121 can play/deliver the audio sending to the caller as the ring-back.)

Deliverer 360 can include a ring-back forward delivery 433. Ring-back forward delivery 433 functions to deliver a sending as a ring-back to the user. An exemplary ring-back forward delivery 433 is depicted in FIGS. 2a through 2j, shown as RFD 433. The exemplary delivery 433 can include circuitry and/or programming to deliver a ring-back to the user. As one example of delivery 433, dispatcher 336 can dispatch an audio sending to deliverer 433. Provider 121 can provide a ring-back to telephone 27 and delivery 433 can respond to the ring-back by delivering the audio sending as the ring-back to the user. In another example, service provider 121 can function as delivery 433. Dispatcher 336 dispatches an audio sending to provider 121 and provider 121 provides the audio sending as a ring-back to the user via telephone 27. The audio sending can be a sending received by receiver 340, can be a user-selected sending or other.

Deliverer 360 can include a ring-tone delivery 434. Ring-tone delivery 434 functions to deliver a received sending as a ring-tone. An exemplary ring-tone delivery 391 is depicted in FIGS. 2a through 2j, shown as RTD 434. The exemplary ring-tone delivery 434 can include circuitry and/or programming to deliver a received sending as a ring-tone to the user. As one example of delivery 434, dispatcher 336 can dispatch an audio sending, said sending for example received by receiver 340, to deliverer 434. Provider 121 can provide a ring signal to telephone 27 and delivery 434 can respond to the ring-signal by delivering the audio sending as the ring-tone to the user (alerting the user of the incoming call). In another example, service provider 121 can function as delivery 434. Dispatcher 336 can dispatch an audio sending, said sending for example received by receiver 340, to provider 121 and provider 121 can provide the audio sending as a ring-tone to the user via telephone 27.

(Also, the described-prior origin identity information can be delivered by deliverer 360 along with a sending. Said identity information can be obtained by obtainer 335 and forwarded from registry 350 to dispatcher 336 Dispatcher 336 can dispatch said identity information to, for example, display 361 an/or speaker 362. Speaker 362 can then announce said identity information and/or display 361 can then display said identity information.)

This second embodiment includes a delivery trigger 390. Delivery trigger 390 functions to initiate the providing of a sending. An exemplary delivery trigger 390 is depicted in FIGS. 2a through 2j, shown as Trigger 390. The exemplary delivery trigger 390 can include circuitry and/or programming to initiate the providing of a sending. For this example of delivery trigger 390, to initiate the providing of a sending, trigger 390 can instruct obtainer 335 request registry 350 to forward said at least one sending to dispatcher 336. Dispatcher 336 can then dispatch said at least one sending to deliverer 360. The exemplary delivery trigger 390 includes at least one of a linked trigger 393 and a user-deploy trigger 394.

Exemplary delivery trigger 390 can include a linked trigger 393. Linked trigger 393 functions to initiate the providing of a sending linked to an activity. An exemplary linked trigger 393 is depicted in FIG. 2a. The exemplary trigger 393 can include circuitry and/or programming to initiate the providing of a sending linked to an activity. This example trigger 393 can respond to signal input indicating an activity by sending a signal to obtainer 335. Obtainer 335 can respond to the signal by requesting registry 350 forward at least one sending to dispatcher 336. Registry 350 can forward from storage 370 said at least one sending to dispatcher 336. Dispatcher 336 can dispatch said at least one sending to deliverer 360.

For this exemplary linked trigger 393, said activity can be (for example): receipt of a sending from the other party; receipt of a sending from the other party during or after a telephone call; the user's deployment of an audio message; the user's deployment of an audio content; the user's deployment of an image (picture); the user's deployment of a video; or can be other.

For this exemplary linked trigger 393, said activity can be a telephone event (for example): a receipt/detection of an incoming call; an answering of an incoming call; a user hang-up; a caller hang-up; a receipt of an incoming call placed from a specific telephone; a timed duration subsequent to or prior to a telephone event; a completion of dialing a telephone number; and any other telephone event.

As an example of operation, linked trigger 393 can initiate the providing of a sending linked to detection of an incoming call. As an example, system 10 can include circuitry to detect an incoming call (activity). Said detection is signaled to trigger 393. Trigger 393 responds by signaling obtainer 335 of provider 375. Obtainer 335 responds to the signal from trigger 393 by requesting registry 350 forward to dispatcher 336 a sending (or sendings) inventoried to the calling party's telephone number stored in other party address register 357. Dispatcher 336 can then dispatch the sending to deliverer 360. Deliverer 360 can then deliver the sending to the calling party's telephone number stored in other party address register 357. (Trigger 393 is depicted in figures herein comprising a diagrammatic block. Trigger 393 can comprise circuitry and/or programming. Conversely, trigger 393 can merely be an electrical connection between, for example, two components. As an example, in the above example, said detection of an incoming call is described as being signaled to trigger 393 and trigger 393 then signals obtainer 335. Said detection of an incoming call can in actuality be signaled directly to obtainer 335. For this example, trigger 393 comprises the electrical connection between said circuitry to detect an incoming call and said obtainer 335.)

A first example of this second embodiment is illustrated as system 10ee in FIG. 2a. This exemplary system 10ee includes sendings receiver 340, sendings registry 350, storage 370, sendings provider 375, deliverer 360 and delivery trigger 390, and can include other party address register 357, all shown located at a telephone 27ee. For this first example, delivery trigger 390 includes linked trigger 393. This first example can be further configured to include one or more of: a deliverer picker 377; a sendings call-up 396; a sendings picker 385; a sendings identifier 345; a user-selected sendings supplier 380; a sendings poster supplier 440 and a configurator 395.

For this first example, sendings receiver 340 includes at least one of telephone receiver 344, email receiver 351 and internet receiver 409. Sendings registry 350 includes automatic register 401 and inventory 324. Sendings provider 375 includes sendings obtainer 335 and sendings dispatcher 336. Deliverer 360 includes one or more of: speaker 362; display 361; text message display 366; image display 367; video display 368; email delivery 363; internet delivery 374; service provider delivery 369; delivery port 364; ring-back delivery 391; ring-back forward delivery 433 and ring-tone delivery 434. Telephone 27ee comprises mobile phone 165.

(Registry 350 can include user-selected default 410. Obtainer 335 can include prioritizer 341. Sendings dispatcher 336 can include arranger 337. Arranger 337 can include one or more of: gallery 342; sequencer 348; and repeater 392. Delivery trigger 390 can include user-deploy trigger 394. Provider 375 can include sendings call-up 396. Sendings identifier 345 can include one or more of: universal identifier 349; special address identifier 437; manual identifier 403; requested sendings identifier 355; and auto-requester 365. Configurator 395 can include one or more of: a configuration selector 389; an enabler 373; and a data entry 407. System 10ee can include telephone 27ee and, thus, can include phone 165. System 10ee can include the prior-described caller I.D. circuitry 20. System 10ee can include GUI 210 and GUI 210 can operate as one or more of: addresser 386, addresser 379 and addresser 381.)

For this first example, sendings receiver 340 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. Linked trigger 393 can be electrically connected to (or connectable to) sendings provider 375.

For this first example, system 10ee can include other party address register 357. Other party address register 357 obtains the telephone number of an-other party. Register 357 can also store the obtained telephone number. Register 357 includes circuitry and/or programming to obtain from caller I.D. information the telephone number of the calling telephone. Register 357 can store the obtained telephone number at storage IN #319. Obtainer 335 can employ the telephone number stored at IN #319 to request one or more sendings from registry 350. Service provider delivery 369 can employ the telephone number stored at IN #319 to designate, to provider 121 for example, where a sending is to be delivered. Provider 121 can then deliver the sending to the telephone (other party's) of the telephone number stored at IN #319. Register 357 includes circuitry and/or programming for obtaining the telephone number dialed by a user when placing a telephone call. Register 357 can store the obtained called (dialed) telephone number at OUT #318. Obtainer 335 can then employ the telephone number stored at OUT #318 to request one or more sendings from registry 350. Service provider delivery 369 can employ the telephone number stored in OUT #318 to designate to provider 121 where a sending is to be delivered. Provider 121 can then deliver the sending to the telephone (other party's) of the telephone number stored at OUT #318. Upon receipt of an incoming call or upon the user dialing a telephone number, register 357 can store the number of the other party's telephone at IN #319 or at OUT #318, respectively. Upon receipt of an incoming call or upon the user dialing a telephone number, register 357 deletes any prior stored telephone number whether located at IN #319 or at OUT #318 (or at both of them).

For this first example, delivery trigger 390 comprises linked trigger 393. Trigger 393 initiates the providing of a sending linked to an activity. The occurrence of an activity sends a signal (triggers) linked trigger 393. Trigger 393 responds by sending a signal to obtainer 335 of provider 375. Obtainer 335 responds by requesting registry 350 forward a sending or sendings. The sending or sendings can be registered to a telephone number stored in other party address register 357. Registry 350 responds by forwarding said sending or sendings to dispatcher 336. Dispatcher 336 dispatches said sending or sendings to deliverer 360. Deliverer 360 delivers said sending or sendings.

ONE EXAMPLE OF OPERATION of receiving and inventorying sendings will now be given. Sendings received and inventoried as per this example can subsequently be provided by provider 375. For the following examples of operation for this first example of this second embodiment, sendings provider 375 provides sendings received and inventoried as per this example. For the first through eighth examples of this second embodiment, sendings provider 375 can provide sendings received and inventoried as per this example.

At some point in time, whether over the phone, or in person, or in an email, or via a text message, or via a prior user-selected and stored message deployed by the user during a telephone conversation with an-other party, or in some other manner, the user asks the other party whom the user anticipates conversing with over the telephone in the future to provide the user with sendings. For this ONE EXAMPLE OF OPERATION, the user requests two sendings from the other party: a favorite audio clip (of the other party); and a picture of or representative of himself (the other party). The other party has a favorite audio clip stored in his cell phone. He supplies the audio clip (sending) by telephone mailing the audio clip from his cell phone along with a telephone delivery address comprising the user's telephone 27. A telephone service provider (provider 121) delivers the audio clip to the user's telephone 27. Delivered by the service provider (provider 121) along with the audio clip (sending) is origin identity information and sending type information, for this example the telephone number of the dispatching telephone and audio type respectively. Telephone provider receiver 344 receives the audio clip (sending) and also receives said origin identity information and sending type information (telephone number of dispatching telephone, audio type). Receiver 344 forwards the received audio sending origin identity information and sending type information to sendings registry 350. Registry 350 employs origin register 358 to register the audio clip sending to the received identity information (for this example, said origin identity information comprises the telephone number of the other party's telephone and telephone number register 359 of origin register 358 registers said the audio sending under the telephone number). Registry 350 employs audio type register 388 of type register 372 to register the audio clip sending to the received sending type information. (For this example, said sending type information comprises a representation of audio type and audio type register 388 registers the sending under audio type). Registry 350 compiles the registered identity information and the registered sending type information into a registration number to represent the audio sending and includes the registration number in inventory 324. Registry 350 forwards the audio sending to storage 370. (For a received text message sending, text message type register 382 of type register 372 registers the sending under text message type. For a received image sending, image type register 383 of type register 372 registers the sending under image type. For a received video sending, video type register 384 of type register 372 registers the sending under video type. Said received video sending can comprise a video with audio sending or register 372 can include a video with audio register.)

To furnish the second requested sending, said other party has an image of himself stored on his PC. He supplies the image by including the image in an email and addressing the email for delivery to the user's email account. Email service delivers the email to said user's email account. Delivered along with the image (sending) is origin identity information, for this example the other party's cell phone telephone number included by the other party with the return address of the email. Also delivered along with the image (sending) is sending type information. Email receiver 351 receives the delivered email from said user's email account and also receives said identity information and said sending type information. Matcher 353 of receiver 351 obtains said telephone number included with the return address. Receiver 351 forwards the received image sending, obtained telephone number and received sending type information to sendings registry 350. Origin register 358 of registry 350 registers the image sending to the identity information (in this case telephone number register 359 of origin register 358 registers the sending under the obtained telephone number). Registry 350 also registers the image sending to the received sending type information (in this case image register 383 of type register 372 registers the sending under image type). Registry 350 compiles the registered identity information and the registered sending type information into a registration number to represent the image sending and includes the registration number in inventory 324. Registry 350 forwards the image sending to storage 370. (For a received audio sending, image type register 388 of type register 372 registers the sending under audio. For a received text message sending, text message type register 382 of type register 372 registers the sending under text message type. For a received video sending, video type register 384 of type register 372 registers the sending under video type.)

This first example (system 10ee) can be configured to respond to initiation by trigger 393 by one or more of: a) providing an audio sending dispatched by audio player 338 to speaker 362, b) providing an audio sending dispatched by audio player 338 to ring-back delivery 391, c) providing a text message sending dispatched by text message feed 339 to text message display 366, d) providing an image sending dispatched by image feed 343 to image display 367, e) providing a video sending dispatched by video player 346 to video display 368, providing one or more of: f) an audio sending, g) a text message sending, h) an image sending and i) video sending, said providing one or more of dispatched by file dispatcher 347 to one or more of deliverers: j) email delivery 363, k) internet delivery 374, 1) service provider delivery 369 and m) delivery port 364.

Responses “a” through “e” can be combined 24 different ways: a, b, c, d, e, ab, ac, ad, ae, bc, bd, be, cd, ce abc, abd, abe, bcd, bce, abcd, abce, acde, bcde, abcde.

Responses “f”, “g” “h”, and “i” can be combined with deliverers “j”, “k”, “l”, and “m” different ways: fj, fk, fl, fm, gj, gk, gl, gm, hj, hk, hl, hm, ij, ik, il, im, fgj, fgk, fgl, fgm, ghj, ghk, ghl, ghm, hij, hik, hil, him, fghj, fghk, fghl, fghm, ghij, ghik, ghil, ghim, fghij, fghik, fghil, fghim, fjk, fjl, fjm, gjk, gkl, gkm, hjk, hjl, hjm, ijk, iji, ijm, fkl, flm, gkl, gkm, hkl, hkm, flm, glm, hlm, ilm, fjkl, fklm, gjkl, gklm, hjkl, hklm, ijkl, iklm, fjklm, gjklm, hjklm, ijkln, fgjk, fgjl, fgjm, fgkl, fgkm, fglm, fhjk, fhjl, fhjm, fhkm, fhkm, fhlm, fijk, fijl, fijm, fikl, fikm, film, ghik, ghil, ghim, ghkl, ghkm, ghlm, ghjk, ghjl, ghjm, ghkl, ghkm,ghlm, gijk, gijl, gijm, gikl, gikm, gilm, hijk, hijl, hijm, hikl, hikm, hilm, fghjk, fghjl, fghjm, fghkl, fghkm, fghlm, ghijk, ghijl, ghijm, ghikl, ghikm, ghilm, fghijk, fghijl, fghijm, fghikl, fghikm, fghilm, fjkl, fjkm, fjlm, fklm, gjkl, gjkm, gjlm, gklm, hjkl, hjlm, hjlm, hklm, ijkl, ijkm, ijlm, iklm, fgjkl, fgjkm, fgjlm, fgklm, fhjkl, fhjkm, fhjlm, fhklm, fijkl, fijkm, fikjlm,fiklm, ghjkl, ghjkm, ghjlm, ghklm, gijkl, gijkm, gijlm, giklm, hijkl, hijkm, hijlm, hikim, fghjkl, fghjkm, fghjlm, fghklm, fhijkl, fhijkm, fhijlm, fhiklm, ghijkl, ghijkm, ghijlm, ghiklm, fghijkl, fghijkm, fghijlm, fghiklm, fgjklm, fhjklm, fijklm, ghjklm, gijklm, hijklm, fghjklm, fgijklm, fhijklm, ghijklm, fghijklm, and permutations thereof.

The 24 combinations of “a” through “e” responses can be combined with the 203 combinations of “f”, “g” “h”, “i” combined with deliverers “j”, “k”, “l”, “m” responses, in other words 203 totaling 4872 combinations.

The 24 combinations of “a” through “e” responses+the 204 combinations of “f”, “g”, “h”, “i” combined with deliverers T, “k”, “l”, “m” responses+the 4848 combinations=5098 total combinations. In other words, this first example (system 10ee) can be configured to provide at least 5098 different response combinations. (In addition to the above “a” through “e”, system 10ee can be further configured to respond to initiation by trigger 393 by providing an audio sending dispatched by audio player 338 to ring-back forward delivery 433 and by providing an audio sending dispatched by audio player 338 to ring-tone delivery 434.) In addition to said 5098 different response combinations, system 10ee can be configured to provide a given plurality of responses in a cadence rather than merely all responses simultaneously. As an example of a cadence, an audio sending is delivered as a ring-back by ring-back delivery 391, three seconds later an image sending is delivered by image display 367, five seconds later a video sending is delivered by video display 367 and four seconds later an image sending is delivered by provider delivery 369. Further, system 10ee can be configured to provide a plurality of cadences relative to a given plurality of responses, the cadence employed dependent for example on circumstances related to the telephone call. In summary, system 10ee can be configured to respond to linked trigger 393 in thousands of unique ways. (System 10ee can also be configured to respond to a plurality of initiations by trigger 393. As an example, a first response to an initiation triggered by receipt of an incoming call or completion of dialing an outgoing call, a second response to an initiation triggered by answering of the call by user or by other party and a third response to an initiation triggered by hang up of the call by user or by other party. For each of said plurality of initiations, the same sending or combination of sendings can be provided. For each of said plurality of initiations, a unique sending or unique combination of sendings can be provided.)

Operation of but two examples of the thousands of unique ways system 10ee can respond to linked trigger 393 will now be discussed in greater detail.

A first example of operation for this first example (system 10ee) of this second embodiment will now be given (1EX1:). For this example, provider 375 initiated by trigger 393 provides one or more sendings. For this example, said provided sendings are sendings registered to the telephone number (address) of an-other party's telephone, said telephone number obtained by other party address register 357. Provider 375 provides said sendings to deliverer 360 and deliverer 360 delivers said sendings. This example is a continuation from the above-given “ONE EXAMPLE OF OPERATION of receiving and inventorying sendings”:

Said audio sending and said image sending supplied by said other party have been received, inventoried and stored. (Also stored can be many other sendings from parties in addition to said other party, said many other sendings also received, inventoried and stored.) Some time later, the user places a call to said other party by dialing the telephone number of said other party's telephone. Other party address register 357 obtains and stores the dialed telephone number in storage OUT #318. A signal indicating the completion of dialing the telephone number (activity) triggers linked trigger 393. Trigger 393 responds by signaling obtainer 335 of provider 375. For this example, obtainer 335 is configured to respond to the signal by requesting registry 350 forward all sendings stored in storage 370 registered to the telephone number stored by other party address register 357 in storage OUT #318. Registry 350 responds by forwarding said sending or sendings to dispatcher 336 (for this example registry 350 responds by forwarding the audio sending and image sending supplied by said other party and received, inventoried and stored). Dispatcher 336 dispatches said sending or sendings to deliverer 360. Deliverer 360 delivers said sending or sendings.

For this first example of operation, dispatcher 336 employs audio player 338. Audio player 338 plays the audio sending and dispatches an audio feed of the playing audio sending to speaker 362 of deliverer 360. In one configuration, speaker 362 comprises a broadcasting type speaker and the audio is broadcast therefrom. The user listens to the ring-back tone from provider 121 indicating that the other party's telephone is being rung and, at the same time, listens to the playing audio sending out of the broadcasting type speaker. In another configuration, audio player 338 dispatches the audio feed to ring-back forward delivery 433. Ring-back forward delivery 433 plays the audio to the user via the telephone receiver of telephone 27ee as the ring-back tone indicating that the other party's telephone is being rung. (In another configuration, player 338 dispatches to both speaker 362 and delivery 433.)

For this first example of operation, dispatcher 336 employs image feed 343. Image feed 343 dispatches a feed of the read image sending (read by registry 350) to image display 367 of deliverer 360. While the other party's telephone is being rung, the image sending is displayed on display 367 for the user to view. When the other party answers, feed 343 can continue or discontinue display of the image.

For this first example of operation, dispatcher 336 also employs file dispatcher 347. Dispatcher 347 dispatches the file containing the image sending (copied and forwarded from registry 350) to service provider delivery 369 of deliverer 360. Delivery 369 delivers the image sending file to service provider 121 along with the other party's telephone number, said telephone number from storage OUT #318. Subsequently, provider 121 delivers the sending to the other party's telephone. The other party's telephone can display the image for the other party to view while their telephone is being rung and after they answer etc.

A second example of operation for this first example (system 10ee) of this second embodiment will now be given (1EX2:). For this example, provider 375 initiated by trigger 393 provides one or more sendings. For this example, said provided sendings are sendings registered to the telephone number (address) of an-other party's telephone, said telephone number obtained by other party address register 357. Provider 375 provides said sendings to deliverer 360 and deliverer 360 delivers said sendings. This example is a continuation from the above-given “ONE EXAMPLE OF OPERATION of receiving and inventorying sendings”:

Said audio sending and image sending supplied by said other party have been received, inventoried and stored. Some time later, a telephone call is received from said other party. Other party address register 357 obtains, from caller I.D. information, the other party's telephone's number and stores the telephone number in storage IN #319. The incoming call is detected (activity) and a signal representing said detection triggers linked trigger 393. Trigger 393 responds by signaling obtainer 335 of provider 375. For this example, obtainer 335 is configured to respond to the signal by requesting registry 350 forward all sendings stored in storage 370 registered to the telephone number stored by address register 357 in storage IN #319. Registry 350 responds by forwarding said sending or sendings to dispatcher 336 (for this example registry 350 responds by forwarding the audio sending and image sending supplied by said other party and received, inventoried and stored). Dispatcher 336 dispatches said sending or sendings to deliverer 360. Deliverer 360 delivers said sending or sendings.

For this second example of operation, dispatcher 336 employs audio player 338. Audio player 338 plays the audio sending and dispatches an audio feed of the playing audio sending to speaker 362 of deliverer 360. In one configuration, speaker 362 comprises a broadcasting type speaker and the audio is broadcast therefrom. The user listens to the ring-back from provider 121 indicating the unanswered incoming telephone and, at the same time, listens to the playing audio sending out of the broadcasting type speaker. In another configuration, dispatcher 338 dispatches the audio feed to ring-tone delivery 434. Ring-tone delivery 434 delivers the playing audio to the user via the receiver of telephone 27ee indicating that the other party's telephone is being rung. (In another configuration, player 338 dispatches to both speaker 362 and delivery 434.)

For this second example of operation, dispatcher 336 further employs audio player 338. Audio player 338 plays the audio sending and dispatches an audio feed of the playing audio sending to ring-back delivery 391. Delivery 391 includes answering circuitry to detect and answer the incoming call and to deliver the playing audio to the caller, the audio to entertain the caller and inform the caller that the user is being alerted.

For this second example of operation, dispatcher 336 employs image feed 343. Image feed 343 dispatches a feed of the read image sending (read by registry 350) to image display 367 of deliverer 360. For this example, image display 367 comprises the outer display of a two-display flip open type of cell phone 165. While the user's telephone is being rung indicating the unanswered incoming call, the image sending is displayed on said outer display. The user views the image and from the image can decide if he cares to converse with this caller. For this example, the image sending is also displayed on the inner display of the two-display flip open cell phone 165. If the user flips open the two-display flip open type of cell phone 165 to answer the call, the user can continue to admire the image sending. When the user answers the call, feed 343 can continue or to discontinue display of the image on one or both of outer and inner display or some combination of continued or discontinued thereof.

For this second example of operation, dispatcher 336 also employs file dispatcher 347. Dispatcher 347 dispatches the file containing the image sending (copied and forwarded from registry 350) to service provider delivery 369 of deliverer 360. Delivery 369 delivers the image sending file to service provider 121 along with the other party's telephone number, said telephone number from storage IN #319. Provider 121 delivers the sending to the other party's telephone. The other party's telephone can display the image for the other party to view while they wait for the user to answer and after the user answers etc.

A brief description of operation of additional examples of the thousands of unique ways to respond to linked trigger 393 will now be given. With respect to system 10ee of FIG. 2a:

Example 1EX3: Triggered by user or caller answering. Last stored audio sending delivered by broadcasting type of speaker 362. User hears sending and other party hears in background.

Example 1EX4: Triggered by user or caller hang up. Last stored video sending delivered by service provider delivery 369 to other party's telephone. Other party can watch video.

Example 1EX5: An audio sending and a text message sending furnished by an other party are repeatedly provided to the user when the user dials the other party

Example 1EX6: An audio sending and an image sending furnished by an-other party are provided to the user when the user dials the other party's phone.

Example 1EX7: Triggered by receipt of a sending to inventory, store the sending and send the sending back to the sender.

Example 1EX8: Triggered by user or other party answering. On Christmas, a text message greeting is provided to the user and to the other party.

In one variation, a sending received by receiver 340 can be immediately delivered by deliverer 360. (In one example, the identifying of a sending can comprise an activity that triggers trigger 393 to initiate provider 375 to provide the sending to deliverer 360.) As one example, a received sending can be forwarded to registry 350. Registry 350 can determine from sending type information included with the sending the appropriate dispatcher to dispatch the determined type. Registry 350 can then forward the sending to the dispatcher and the dispatcher can dispatch the sending to a deliverer (registry 350 can also inventory and store the sending). As an example, the sending type is determined by registry 350 to be text message type. Registry 350 forwards the text message sending to text message feed 339. Feed 343 is configured to dispatch the sending to text message display 366. Display 366 displays the dispatched text message sending. As another example, the sending type is determined by registry 350 to be video. Registry 350 forwards the video sending to file dispatcher 347. Dispatcher 347 dispatches the video sending to internet delivery 374. Delivery 374 posts the video on an internet social media website, for example, You Tube. (The prior described identity information can also be immediately delivered.)

Delivery trigger 390 can include a user-deploy trigger 394. User-deploy trigger 394 functions to enable a user to trigger the providing of at least one sending. An exemplary user-deploy trigger 394 is depicted in FIG. 2b. The exemplary trigger 394 can enable a user to initiate the providing of a sending. The exemplary trigger 394 can include GUI 210. To operate as trigger 394, GUI 210 is configured to be capable of being placed in electronic communication with circuitry and/or programming to enable a user to trigger the providing of at least one sending To operate as trigger 394, GUI 210 can be electrically connected to (or connectable to) sendings provider 375. GUI 210 can display a deploy trigger icon 398 shown as DT 398. A touched deploy trigger icon 398 can cause GUI 210 to send a signal to obtainer 335 (of provider 375). Obtainer 335 can respond to the signal by requesting registry 350 provide at least one sending to dispatcher 336. Registry 350 can forward from storage 370 said at least one sending to dispatcher 336. Dispatcher 336 can dispatch said at least one sending to deliverer 360.

As an example of operation, user-deploy trigger 394 can enable a user to trigger the providing of a sending during receipt of a telephone call. As an example, during receipt of an incoming call, after viewing caller I.D. information and prior to answering, the user decides to deploy sendings registered to the calling party's telephone. To do so, the user touches deploy trigger icon 398 provided by GUI 210. GUI 210 responds to the touched trigger icon 398 by signaling provider 375. Provider 375 responds by employing obtainer 335 to obtain all sendings registered to the calling party's telephone number. (For this example, obtainer 375 is configured to obtain all sendings registered to the telephone number obtained by other party address register 357.) Obtainer 335 responds by requesting registry 350 provide all sendings registered to the caller's telephone number stored by other party address register 357 to dispatcher 336. Registry 350 responds by providing the requested all sendings to dispatcher 336. Dispatcher 336 forwards the provided all sendings to deliverer 360. Deliverer 360 then delivers the sendings. (As one example, dispatcher 336 can be configured to dispatch all sendings via file dispatcher 347. Said all sendings dispatched by dispatcher 347 can then be delivered by service provider delivery 369 of deliverer 360 to the caller's telephone. Also, in one variation delivery trigger 390 can include an-other party deploy trigger. Said other party deploy trigger can function to enable an-other party, for example an-other party of a telephone call with the user, to trigger the providing of at least one sending. As an example, provider 375 can be configured to respond to a pressing of the pound key on the other party's telephone, for example when said other party phone and the user's phone are communicably connected, by obtaining and dispatching a sending to deliverer 360. Deliver 360 then delivers the sending.)

A second example of this second embodiment is illustrated as system 10ff in FIG. 2b. This exemplary system 10ff includes sendings receiver 340, sendings registry 350, storage 370, sendings provider 375, deliverer 360 and delivery trigger 390, and can include other party address register 357, all shown located at a telephone 27ff. For this second example, delivery trigger 390 includes user-deploy trigger 394. User-deploy trigger 394 enables a user to trigger the providing of a sending. This second example can be further configured to include one or more of: a deliverer picker 377; a sendings picker 385; a sendings call-up 396; a sendings identifier 345; a user-selected sendings supplier 380; a sendings poster supplier 440; and a configurator 395.

For this second example, sendings receiver 340 includes at least one of telephone receiver 344, email receiver 351 and internet receiver 409. Sendings registry 350 includes automatic register 401 and inventory 324. Sendings provider 375 includes sendings obtainer 335 and sendings dispatcher 336. Deliverer 360 includes one or more of: speaker 362; display 361; text message display 366; image display 367; video display 368; email delivery 363; internet delivery 374; service provider delivery 369; delivery port 364; ring-back delivery 391; ring-back forward delivery 433; and ring-tone delivery 434. Delivery trigger 390 includes user-deploy trigger 394. System 10ff can include the prior-described caller I.D. circuitry 20. Circuitry 20 employs GUI 210 to serve as display 21 to display caller I.D. information to the user. Telephone 27ff can comprise mobile phone 165.

(Registry 350 can include user-selected default 410. Obtainer 335 can include prioritizer 341. Dispatcher 336 can include arranger 337. Arranger 337 can include one or more of: gallery 342; sequencer 348; and repeater 392. Trigger 390 can include linked trigger 393. Sendings identifier 345 can include one or more of universal identifier 349; special address identifier 437; manual identifier 403; requested sendings identifier 355; and auto-requester 365. Configurator 395 can include one or more of: a configuration selector 389; an enabler 373; and a data entry 407. System 10ff can include telephone 27ff and, thus, can include phone 165.)

For this second example, sendings receiver 340 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. To operate as user-deploy trigger 394, GUI 210 can be electrically connected to (or connectable to) sendings provider 375.

For this second example, system 10ff can include other party address register 357. Other party address register 357 obtains the telephone number of an-other party. Register 357 can also store the obtained telephone number. Register 357 includes circuitry and/or programming to obtain from caller I.D. information the telephone number of the calling telephone. Register 357 can store the obtained telephone number at storage IN #319. Obtainer 335 can employ the telephone number stored at IN #319 to request one or more sendings from registry 350. Service provider delivery 369 can employ the telephone number stored at IN #319 to designate, to provider 121 for example, where a sending is to be delivered. Provider 121 can then deliver the sending to the telephone (other party's) of the telephone number stored at IN #319. Register 357 includes circuitry and/or programming for obtaining the telephone number dialed by a user when placing a telephone call. Register 357 can store the obtained called (dialed) telephone number at OUT #318. Obtainer 335 can then employ the telephone number stored at OUT #318 to request one or more sendings from registry 350. Service provider delivery 369 can employ the telephone number stored in OUT #318 to designate to provider 121 where a sending is to be delivered. Provider 121 can then deliver the sending to the telephone (other party's) of the telephone number stored at OUT #318. Upon receipt of an incoming call or upon the user dialing a telephone number, register 357 can store the number of the other party's telephone at IN #319 or at OUT #318, respectively. Upon receipt of an incoming call or upon the user dialing a telephone number, register 357 deletes any prior stored telephone number whether located at IN #319 or at OUT #318.

For this second example, delivery trigger 390 comprises user-deploy trigger 394. Trigger 394 initiates the providing of a sending. User-deploy trigger includes GUI 210. GUI 210 displays deploy trigger icon 398. A touched deploy trigger icon 398 causes GUI 210 to send a signal to obtainer 335 of provider 375. Obtainer 335 responds by requesting registry 350 forward a sending or sendings. The sending or sendings can be registered to a telephone number stored in other party address register 357. Registry 350 responds by forwarding said sending or sendings to dispatcher 336. Dispatcher 336 dispatches said sending or sendings to deliverer 360. Deliverer 360 delivers said sending or sendings.

This second example can be configured to respond to deployed trigger 394 in a like manner as disclosed for the first example responding to trigger 393. In other words, this second example can respond by one or more of: a) providing an audio sending dispatched by audio player 338 to speaker 362, b) providing an audio sending dispatched by audio player 338 to ring-back delivery 391, c) providing a text message sending dispatched by text message feed 339 to text message display 366, d) providing an image sending dispatched by image feed 343 to image display 367, e) providing a video sending dispatched by video player 346 to video display 368, providing one or more of: f) an audio sending, g) a text message sending, h) an image sending and i) video sending, said providing one or more of dispatched by file dispatcher 347 to one or more of deliverers: j) email delivery 363, k) internet delivery 374, l) service provider delivery 369 and m) delivery port 364.

As with the responses disclosed for the first example (system 10ee), for this second example (system 10ff) responses “a” through “e” can be combined 24 different ways. Responses “f”, “g” “h”, and “i” can be combined with deliverers “j”, “k”, “l”, and “m” 203 different ways: The 24 combinations of “a” through “e” responses can be combined with the 203 combinations of “f”, “g” “h”, “i” combined with deliverers “j”, “k”, “l”, “m” responses, in other words 24 multiplied by 203 totaling 4872 combinations. The 24 combinations of “a” through “e” responses +the 204 combinations of “f”, “g”, “h”, “i” combined with deliverers “j”, “k”, “l”, “m” responses+the 4848 combinations=5098 total combinations. In other words, this second example (system 10ff) can be configured at least 5098 different ways to respond to deploy trigger 394.

In addition, as discussed for system 10ee, system 10ff can also be configured to provide a given plurality of responses in a cadence rather than merely all responses simultaneously and can be configured to provide a plurality of cadences relative to a given plurality of responses (and can be configured to respond to a plurality of initiations by trigger 394). In summary, like system 10ee system 10ff can be configured to respond to deploy trigger 394 in thousands of unique ways.

Out of the thousands of ways to respond to deploy trigger 394, two detailed examples of operation of system 10ff will now be given.

A first example of operation for this second example (system 10ff) of this second embodiment will now be given (2EX1:). For this example, provider 375 initiated by trigger 394 provides one or more sendings. For this example, said provided sendings are sendings registered to the telephone number (address) of an-other party's telephone, said telephone number obtained by other party address register 357. Provider 375 provides said sendings to deliverer 360 and deliverer 360 delivers said sendings. This example is a continuation from the above-given “ONE EXAMPLE OF OPERATION of receiving and inventorying sendings”:

Said audio sending and said image sending supplied by said other party have been received, inventoried and stored. (Also stored can be many many other sendings from parties in addition to said other party, said sendings also received, inventoried and stored.) Some time later, the user places a call to said other party by dialing the telephone number of said other party's telephone. Other party address register 357 of system 10ff obtains and stores the dialed telephone number in storage OUT #318. At the completion of dialing the telephone number, the user touches deploy trigger icon 398 displayed on GUI 210. GUI 210 responds to touched icon 398 by signaling obtainer 335 of provider 375. For this example, obtainer 335 is configured to respond to the signal by requesting registry 350 forward all sendings stored in storage 370 registered to the telephone number stored by other party address register 357 in OUT #318. Registry 350 responds by forwarding said sending or sendings to dispatcher 336 (for this example the audio sending and image sending supplied by said other party and received, inventoried and stored). Dispatcher 336 dispatches said sending or sendings to deliverer 360. Deliverer 360 delivers said sending or sendings.

For this first example of operation, dispatcher 336 employs audio player 338. Audio player 338 plays the audio sending and dispatches an audio feed of the playing audio sending to speaker 362 of deliverer 360. In one configuration, speaker 362 comprises a broadcasting type speaker and the audio is broadcast therefrom. The user listens to the ring-back tone from provider 121 indicating that the other party's telephone is being rung and, at the same time, listens to the playing audio sending out of the broadcasting type speaker. In another configuration, audio player 338 dispatches the audio feed to ring-back forward 433. Ring-back forward 433 plays the audio to the user via the telephone receiver of telephone 27ff as the ring-back tone indicating that the other party's telephone is being rung. (In another configuration, player 338 dispatches to both speaker 362 and the telephone receiver of telephone 27ff.)

For this first example of operation, dispatcher 336 also employs image feed 343. Image feed 343 dispatches a feed of the read image sending (read by registry 350) to image display 367 of deliverer 360. For this example, image display 367 comprises the bottom one-third of the display of GUI 210, said bottom one-third of GUI 210 dedicated as display 367. While the other party's telephone is being rung, the image sending is displayed on said bottom one-third of the display of GUI 210 for the user to view. When the other party answers, feed 343 can continue or discontinue display of the image.

For this first example of operation, dispatcher 336 also employs file dispatcher 347. Dispatcher 347 dispatches the file containing the image sending (copied and forwarded from registry 350) to service provider delivery 369 of deliverer 360. Delivery 369 delivers the image sending file to service provider 121 along with the other party's (dialed) telephone number from address register 357 storage OUT #318. Provider 121 delivers the sending to the other party's telephone. The other party's telephone can display the image for the other party to view while their telephone is being rung and after they answer etc.

For this first example of operation, dispatcher 336 further employs file dispatcher 347. Dispatcher 347 dispatches the file containing the image sending (copied and forwarded from registry 350) to internet delivery 374 of deliverer 360. The sending file, inclusive of an internet address supplied prior by the user, is delivered by delivery 374 to an internet service provider, for example to Microsoft Internet Explorer. MS Explorer delivers the sending file to the included internet address, for this example the social media website Facebook. For this example, the image is posted on Facebook to the user's account under a heading “Recently Called”.

A second example of operation for this second example (system 10ff) of this second embodiment will now be given (Example 2EX2:). For this example, provider 375 initiated by trigger 394 provides one or more sendings. For this example, said provided sendings are sendings registered to the telephone number (address) of an-other party's telephone, said telephone number obtained by other party address register 357. Provider 375 provides said sendings to deliverer 360 and deliverer 360 delivers said sendings. For this example, system 10ff includes caller I.D. circuitry 20. This example is a continuation from the above-given “ONE EXAMPLE OF OPERATION of receiving and inventorying sendings”:

Said audio sending and image sending supplied by said other party have been received, inventoried and stored. Some time later, a telephone call is received from said other party. Other party address register 357 of system 10ff obtains, from caller I.D. information, the other party's telephone's number and stores the telephone number in storage IN #319. GUI 210 displays deploy trigger icon 398 of deploy trigger 394 and displays caller I.D. information (acting as caller I.D. display 21). The incoming call causes telephone 27 to be rung. The user responds to the ringing telephone by viewing the displayed caller I.D. information. The user recognizes the calling telephone number and based on the recognized number decides to deploy sendings registered to that number by touching deploy trigger icon 398. GUI 210 (acting as trigger 394) responds by signaling obtainer 335 of provider 375. For this example, obtainer 335 is configured to respond to the signal by requesting registry 350 forward all sendings stored in storage 370 registered to the telephone number stored in other party address register 357 storage IN #319. Registry 350 responds by forwarding said sending or sendings to dispatcher 336 (for this example the audio sending and image sending supplied by said other party and received, inventoried and stored). Dispatcher 336 dispatches said sending or sendings to deliverer 360. Deliverer 360 delivers said sending or sendings.

For this second example of operation, dispatcher 336 employs audio player 338. Audio player 338 plays the audio sending and dispatches an audio feed of the playing audio sending to speaker 362 of deliverer 360. In one configuration, speaker 362 comprises a broadcasting type speaker and the audio is broadcast therefrom. The user listens to the ring-tone from provider 121 indicating the unanswered incoming telephone and, at the same time, listens to the playing audio sending out of the broadcasting type speaker. In another configuration, dispatcher 338 dispatches the audio feed to ring-tone delivery 434. Ring-tone delivery 434 delivers the playing audio to the user via the receiver of telephone 27ff indicating that the other party's telephone is being rung. (In another configuration, player 338 dispatches to both speaker 362 and delivery 434.)

For this second example of operation, dispatcher 336 further employs audio player 338. Audio player 338 plays the audio sending and dispatches an audio feed of the playing audio sending to ring-back delivery 391. Delivery 391 includes answering circuitry. The answering circuitry responds to the signal from GUI 210 (touched icon 398) by answering the incoming call and delivering the playing audio to the caller. In other words, provider 121 provides a ring-back to the caller until the user touches icon 398. Subsequently provider 121 discontinues the ring-back when delivery 391 answers the call and delivery 391 then provides the audio sending as the ring-back.

For this second example of operation, dispatcher 336 also employs image feed 343. Image feed 343 dispatches a feed of the read image sending (read by registry 350) to image display 367 of deliverer 360. For this example, the display of GUI 210 acts as image display 367. While the user's telephone is being rung indicating the unanswered incoming call, the image sending is displayed on image display 367. The user views the image, the image helping the user decide if he really cares to converse with this caller. Upon the user answering the call, feed 343 can continue or discontinue display of the image.

For this second example of operation, dispatcher 336 also employs file dispatcher 347. Dispatcher 347 dispatches the file containing the image sending (copied and forwarded from registry 350) to service provider delivery 369 of deliverer 360. Delivery 369 delivers the image sending file to service provider 121 along with the other party's telephone number from storage IN #319. Provider 121 delivers the sending to the other party's telephone. The other party's telephone can display the image for the other party to view while they wait for the user to answer and after the user answers etc.

A brief description of operation of additional examples of said many many thousands of unique ways to respond to deploy trigger 394 will now be given. System 10ff additional Inventor Favorites:

Example 2EX3: Upon an-other party answering a call, the user deploys audio, text message, image and video sendings to the other party's telephone.

Example 2EX4: Upon an-other party not answering a call, the user deploys a text message to the other party's telephone.

Example 2EX5: Upon an-other party saying something kind to the user, the user deploys a text message valentine and an image of a heart.

This second embodiment can include a sendings picker 385. Sendings picker 385 functions to enable a user to pick a sending from a plurality of sendings to pick from. An exemplary sendings picker 385 is depicted in FIG. 2c, shown as S. Picker 385, shown located at GUI 210. The exemplary picker 385 can include GUI 210. To operate as picker 385, GUI 210 can include circuitry and/or programming to enable a user to pick a sending from a plurality of sendings to pick from. To operate as picker 385, GUI 210 can be electrically connected to (or connectable to) registry 350, can be electrically connected to (or connectable to) delivery trigger 390 and can be electrically connected to (or connectable to) sendings provider 375. To operate as picker 385, GUI 210 can provide a sendings icon array 352, shown as Array 352. Array 352 can include a plurality of icons, each icon representing a sending. In one configuration, upon the user completing the dialing of a telephone number, address register 357 can obtain the dialed telephone number. Upon receipt of an incoming telephone call, address register 357 can obtain the telephone number of the calling telephone from caller I.D. information. Upon obtaining a telephone number, register 357 can provide the number to registry 350 and registry 350 can respond by forwarding to GUI 210 the registration number of each sending registered to that number found in inventory 324. GUI 210 can then display in array 352 one icon representing each sending and can store the registration number forwarded from registry 350. The exemplary picker 385 can enable a user to pick a sending whether telephone 27 is communicably connected to another telephone or not.

In another configuration, registry 350 can forward to GUI 210 other than registration numbers of sendings registered to the obtained telephone number, for example registration numbers of all sendings found or of all sendings of a particular type or of all sending of a particular class or, for example, a particular group of user-selected sendings or of other. GUI 210 can display an icon representing each sending and can store the forwarded registration numbers.

An icon representing a sending can comprise the time and/or date and/or year received (registered to a sending by time register 371); the sending type (registered to a sending by type register 372); the sending class (registered to a sending by class register 326); or other. (As examples, an icon representing an audio message sending can be a music note with the date the sending was received included below the note, an icon representing a text message sending can be the date the sending was received written in an antique font, an icon representing an image sending can be a miniature of the actual image stored with the date the sending was received included below the image and an icon representing a video can be a miniature of a frame taken from the actual video with the date the sending was received included below the frame.)

GUI 210 can be configured to respond to a touched one of the plurality of icons in array 352 by signaling linked trigger 393 and by forwarding to trigger 393 the registration number of the sending represented by the touched icon. Trigger 393 can then wait for a signal indicating an activity and upon receipt of said signal can forward to provider 375 the registration number and instruct provider 375 to obtain and dispatch the sending. Provider 375 can respond by obtaining and dispatching the sending to deliverer 360.

GUI 210 can be configured to respond to a touched one of the plurality of icons in array 352 by triggering the providing of a sending (thus functioning as deploy trigger 394). GUI 210 can respond to a touched icon by forwarding the registration number of the sending represented by the touched icon to provider 375 and by instructing provider 375 to obtain and dispatch the sending. Provider 375 can respond by obtaining and dispatching the sending to deliverer 360.

(GUI 210 can be configured to respond to a touched icon by signaling linked trigger 393 only, can be configured to respond to a touched icon by functioning as deployed trigger 394 only or can be configured to respond to a touched icon by both signaling trigger 393 and functioning as trigger 394. When said configured to respond by both, GUI 210 can be configured to respond by both during a telephone call or to respond to one or the other during a telephone call depending, for example, on user instruction. GUI 210 can be programmed to enable a user to implement said instruction.)

As can be appreciated from the above disclosure, GUI 210 (acting as picker 385) can display numerous pluralities of sendings for the user to pick from. As examples of said pluralities of sendings, GUI 210 can be configured to display: one received class sending of each sending type to pick from (sending types, for example, audio message, audio content, text message, image/picture, video (with audio) or other; said one of each type, for example, chosen randomly from all received class sendings registered to that sending type); a plurality of random received class sendings to pick from (said random sendings selected randomly from all received class sendings stored; a plurality of received class sendings to pick from, said plurality selected prior by the user comprising, for example, user favorites; a plurality of user-selected class sendings to pick from, said plurality selected prior by the user comprising, for example, user favorites; all sendings registered to a telephone number stored by other party address register 357; one sending of each sending type registered to a telephone number stored by address register 357; a plurality of randomly selected sendings registered to a telephone number stored by address register 357; all of a given type of sendings registered to a telephone number stored by address register 357; all sendings registered to a telephone number provided by a sendings call-up 396 described later; one sending of each sending type registered to a telephone number provided by call-up 396; a plurality of randomly selected sendings registered to a telephone number provided by call-up 396; all of a given type of sendings registered to a telephone number provided by call-up 396; three pluralities of sendings, one plurality received class sendings, one plurality identified class sendings and one plurality user-selected class sendings; all sendings registered during a specified period of time. (For any of the examples given herein this application comprising a video sending, said video sending can include audio.)

Sendings picker 385 can include a sendings type picker 354. Sendings type picker 354 functions to enable a user to pick a sending type from a plurality of sending types to pick from. An exemplary sendings type picker 354 is depicted in FIG. 2c, shown as STP 354 located at GUI 210. The exemplary picker 354 can employ GUI 210. To operate as picker 354, GUI 210 GUI 210 is configured to be capable of being placed in electronic communication with circuitry and/or programming to enable a user to pick a sending type from a plurality of sending types to pick from. GUI 210 can be configured to display one icon for each sending type represented. Sending types represented can be, for example: audio message type, audio content type, text message type, image type, video type, or other. (As examples, an icon representing said audio message type can be a music note, an icon representing said text message type can be the word TEXT written in an antique font, an icon representing said image type can be a miniature of the actual image stored with and an icon representing said video type can be a depiction of a video camera. Also, audio sendings described prior registered as audio type by audio type register 338; text message sendings described prior registered as text message type by text message type register 382; image sendings described prior registered as image type by image type register 383; video sendings described prior registered as video type by video type register 384.) Upon the user picking a sending type, GUI 210 can then provide the user with a choice of sendings found in inventory 324 registered to that type to pick from. (Alternately, upon the user picking a sending type, GUI 210 can then provide the user with a choice of sending classes to pick from, said sending classes registered to said picked type. Upon picking a sending class, GUI 210 can then provide the user with a choice of sendings registered to that type and class to pick.)

As an example of operation, to operate as picker 354, GUI 210 can display one icon for each of a plurality of sending types. Upon the user touching one of the representative icons, GUI 210 can instruct registry 350 forward inventory information regarding the sending type to GUI 210. As an example, the user touches an icon representing image type sendings. GUI 210 responds by requesting registry 350 forward the registration numbers of all image type sendings found in inventory 324. Registry 350 responds by forwarding said registration numbers to GUI 210. GUI 210 displays an icon to represent each image type sending found (the icon can comprise the date received). The user can then pick one of the image sendings by touching the representative icon. GUI 210 responds by providing the registration number of the picked sending to obtainer 335 and by instructing obtainer 335 to obtain the sending. Obtainer 335 responds by requesting registry 350 forward the sending associated with the provided registration number to dispatcher 336. Dispatcher 336 can then dispatch the sending to deliverer 360. Deliverer 360 can then deliver the sending.

Sendings picker 385 can include a sendings class picker 406. Sendings class picker 406 functions to enable a user to pick a sendings class from a plurality of sendings classes to pick from. An exemplary sendings class picker 406 is depicted in FIG. 2c, shown as SCP 406 located at GUI 210. The exemplary picker 406 can employ GUI 210. To operate as picker 406, GUI 210 can include circuitry and/or programming to enable a user to pick a sending class from a plurality of sending classes to pick from. GUI 210 can be configured to display one icon for each sending class represented. Sending classes represented can be, for example: received class, identified class, non-identified class, user-selected class or some other class. (Received sendings described prior registered as received class by received class register 328; identified sendings described prior registered as identified class by identified class register 322; non-identified sendings described prior registered as non-identified class by non-identified class register 327; user-selected sendings described prior registered as user-selected class by user-selected class register 387.) Upon the user picking a sending class, GUI 210 can then provide the user with a choice of sendings found in inventory 324 registered to that class to pick from. (Alternately, upon the user picking a sending class, GUI 210 can then provide the user with a choice of sending types to pick from, said sending types registered to said picked class. Upon picking a sending type, GUI 210 can then provide the user with a choice of sendings found in inventory 324 registered to the picked class and picked type. Also, class picker 406 can operate in a similar manner as described above for type picker 354. Also, pickers 385, 354 and 406 can comprise GUI 210 displaying one icon representing one sending or one type or one class, respectively.)

A third example of this second embodiment is illustrated as system 10gg in FIG. 2c. This exemplary system 10gg includes sendings receiver 340, sendings registry 350, storage 370, sendings provider 375, deliverer 360, delivery trigger 390 and sendings picker 385, and can include other party address register 357, all shown located at a telephone 27gg. This third example can comprise the first or second example (and can comprise a combining of the first and second examples) and further configured to include sendings picker 385. Picker 385 can include one or more of sendings type picker 354 and sendings class picker 406. This third example can be further configured to include one or more of: a deliverer picker 377; a sendings call-up 396; a sendings identifier 345; a user-selected sendings supplier 380; a sendings poster supplier 440; and a configurator 395.

For this third example, sendings receiver 340 includes at least one of telephone receiver 344, email receiver 351 and internet receiver 409. Sendings registry 350 includes automatic register 401. Sendings provider 375 includes sendings obtainer 335 and sendings dispatcher 336. Sendings picker 385 employs GUI 210. Deliverer 360 includes one or more of: speaker 362; display 361; text message display 366; image display 367; video display 368; email delivery 363; internet delivery 374; service provider delivery 369; delivery port 364; ring-back delivery 391; ring-back forward delivery 433; and ring-tone delivery 434. Delivery trigger 390 includes at least one of linked trigger 393 and user-deploy trigger 394. Telephone 27gg comprises mobile phone 165.

(Registry 350 can include user-selected default 410. Obtainer 335 can include prioritizer 341. Dispatcher 336 can include arranger 337. Arranger 337 can include one or more of: gallery 342; sequencer 348; and repeater 392. Sendings identifier 345 can include one or more of: universal identifier 349; special address identifier 437; manual identifier 403; requested sendings identifier 355; and auto-requester 365. Configurator 395 can include one or more of: a configuration selector 389; an enabler 373; and a data entry 407. System 10gg can include telephone 27gg and, thus, can include phone 165. System 10gg can include caller I.D. circuitry 20. Circuitry 20 can include GUI 210 to serve as display 21 to display caller I.D. information to the user.)

For this third example, sendings receiver 340 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. Linked trigger 393 can be electrically connected to (or connectable to) provider 375. GUI 210, operating as user-deploy trigger 394, can be electrically connected to (or connectable to) provider 375. To operate as picker 385, GUI 210 can be electrically connected to (or connectable to) registry 350, can be electrically connected to (or connectable to) delivery trigger 390 (linked trigger 393) and can be electrically connected to (or connectable to) sendings provider 375. For this third example, sendings obtained by provider 375 can be sendings received and inventoried as described prior in “ONE EXAMPLE OF OPERATION of receiving and inventorying sendings”.

For this third example, sendings picker 385 employs GUI 210. To operate as picker 385, GUI 210 GUI 210 is configured to be capable of being placed in electronic communication with circuitry and/or programming to enable a user to pick a sending from a plurality of sendings to pick from. GUI 210 provides sendings icon array 352. Upon the user completing the dialing of a telephone number, address register 357 can obtain the dialed telephone number. Upon receipt of an incoming telephone call, address register 357 can obtain the telephone number of the calling telephone from caller I.D. information. Upon obtaining a telephone number, register 357 provides the number to registry 350 and registry 350 responds by forwarding to GUI 210 the registration number of each sending registered to that number found in inventory 324. GUI 210 displays an icon representing each sending and stores the registration number forwarded from registry 350. For this example, the icon comprises the date received (from time register 371) and comprises the sending type (from type register 372).

For this example, GUI 210 can respond to the user touching one of the plurality of icons by signaling (triggering) linked trigger 393 and by forwarding to trigger 393 the registration number of the picked sending. Trigger 393 then waits for a signal indicating an activity and upon receipt of said signal forwards to provider 375 the registration number and instructs provider 375 to obtain and dispatch the sending. Provider 375 responds by obtaining and dispatching the sending to deliverer 360.

For this example, GUI 210 can respond to the user touching one of the plurality of icons by initiating the providing of a sending (thus functioning as deploy trigger 394). GUI 210 can respond to the user touching one of the plurality of icons by forwarding the registration number of the picked sending to provider 375 and by instructing provider 375 to obtain and dispatch the sending. Provider 375 responds by obtaining and dispatching the sending to deliverer 360.

For this example, sendings picker 385 can include type picker 354. Picker 354 employs GUI 210. To operate as picker 354, GUI 210 is configured to be capable of being placed in electronic communication with circuitry and/or programming to enable a user to pick a sending type from a plurality of sending types to pick from. GUI 210 is configured to display an icon to represent each of the following sending types: audio message type, audio content type, text message type, image type, video type. Upon the user picking a sending type, GUI 210 then acts as picker 385 by providing the user with a choice of sendings registered to that type to pick from.

A first example of operation of this third example of the second embodiment (system 10gg) will now be given (3EX1). This first example comprises system 10ee and further configured to include sendings picker 385. (In other words, this first example comprises linked trigger 393.) For this example, to operate as sendings picker 385 GUI 210 is configured to display all received class sendings found in inventory 324 registered to a telephone number obtained by other party address register 357.

Upon the user completing the dialing of a telephone number or upon receipt of an incoming telephone call, other party address register 357 obtains the dialed telephone number or the calling telephone's number from caller I.D. information, respectively. Register 357 provides the obtained number to registry 350 and registry 350 responds by forwarding the registration number to GUI 210 of each sending found in inventory 324 registered to that telephone number. GUI 210 then displays icon array 352, array 352 comprising one icon representing each forwarded registration number. Each icon comprises the sending's date received and a representation of the sending's type. For this example, the call is answered (either by called party or by user). While conversing, the user decides to touch one of the displayed icons, as an example, an icon comprising the date Nov. 20, 2011 and a miniature of a picture (the miniature being a reduction of the actual image stored). GUI 210 responds to the user touching the date and image icon by forwarding to trigger 393 the registration number of the picked sending. Trigger 393 waits for a signal indicating an activity, as an example for this example, a hang up by the user or by the caller. Upon receiving said signal, trigger 393 forwards to provider 375 the forwarded registration number and instructs provider 375 obtain and dispatch the associated sending. Provider 375 responds by obtaining and dispatching the image sending to deliverer 360. (As an example for this example, provider 375 dispatches the image to delivery 369 and to image display 367. Delivery 369 delivers the image to the other party's telephone via provider 121, display 367 delivers the image to the user.)

A second example of operation of this third example of the second embodiment (system 10gg) will now be given (3EX2). This second example comprises system 10ff and further configured to include sendings picker 385. (In other words, this second example comprises user-deploy trigger 394.) For this example, to operate as sendings picker 385 GUI 210 is configured to display all received class sendings found in inventory 324 registered to a telephone number obtained by other party address register 357. For this example, system 10gg includes caller I.D. circuitry 20.

Upon the user completing the dialing of a telephone number or upon receipt of an incoming telephone call, other party address register 357 obtains the dialed telephone number or the calling telephone's number from caller I.D. information, respectively. Register 357 provides the obtained number to registry 350 and registry 350 responds by forwarding the registration number to GUI 210 of each sending found in inventory 324 registered to that telephone number. GUI 210 then displays icon array 352, array 352 comprising one icon representing each forwarded registration number. Each icon comprises the date received and a representation of the sending type. For this example, the telephone call is unanswered and incoming to the user. The user views caller I.D. information displayed on GUI 210 and from the information touches two icons displayed on GUI 210, an audio icon and a text message icon. GUI 210 responds to the user touching the two icons by initiating the providing of the associated two sendings (thus GUI 210 functions as deploy trigger 394). GUI 210 initiates the providing by forwarding the registration number of each of the two picked sendings to provider 375 and by instructing provider 375 to obtain and dispatch each of the sendings. Provider 375 responds by obtaining and dispatching the sendings represented by the touched icons. (As an example for this example, provider 375 dispatches the audio sending to ring-back delivery 391 and the text message sending to provider delivery 369. Delivery 391 delivers the audio sending to the other party as the ring-back. Delivery 369 delivers the image sending to the other party's telephone via provider 121.)

A third example of operation of this third example of the second embodiment (system 10gg) will now be given (3EX3). This third example comprises a combining of system 10ee and system 10ff and further configured to include sendings picker 385. Picker 385 is further configured to include sendings type picker 354. Picker 385 is further configured to include sendings class picker 406. The user touching an icon in icon array 352 functions as deploy trigger 394 to initiate provider 375. The user touching and holding for two seconds or more an icon in icon array 352 functions to signal linked trigger 393. Trigger 393 waits for a signal indicating an activity and responds by initiating provider 375. For this example, system 10gg includes caller I.D. circuitry 20.

Upon the user completing the dialing of a telephone number or upon receipt of an incoming telephone call, other party address register 357 obtains the dialed telephone number or the calling telephone's number from caller I.D. information, respectively. Register 357 provides the obtained number to registry 350 and registry 350 responds by forwarding the registration number of each sending found in inventory 324 registered to that number to GUI 210. GUI 210 determines from the forwarded registration numbers what types of sendings have been registered. For this example, GUI 210 acting as sendings type picker 354, determines that four types have been registered and, so, GUI 210 displays four icons, one icon represent each of the types found registered to the number obtained by register 357. GUI 210 displays a music note representing audio type, displays the word TEXT written in an antique font representing text message type, displays a miniature picture representing image type and displays a drawing depicting a video camera representing video type.

For this example, the telephone call is unanswered and incoming to the user. The user views caller I.D. information displayed on GUI 210 and from the information touches the TEXT icon. GUI 210 responds to the touched TEXT icon by determining from the registration numbers all text message sendings found in inventory 324 registered to the number obtained by register 357. For this example for example, GUI 210 determines that three text message sendings have been registered to the number. GUI 210 provides icon array 352 and displays three icons, one icon representing each of the three text message sendings (each icon comprising the date that sending was received written in an antique font). For this example, the user touches one of the icons. GUI 210 responds to the touched icon by functioning as deploy trigger 394 and, thus, by initiating provider 375. Provider 375 obtains and dispatches the text message sending (for example dispatches to text message display 366).

GUI 210, again acting as sendings type picker 354, displays the four type icons, one icon representing each of the determined four types of sendings registered to the other party's telephone number. For this example, the user then answers the incoming call. While conversing, the user touches the music note representing audio type. GUI 210 responds to the touched audio type icon by determining from the registration numbers all audio sendings found in inventory 324 registered to the number obtained by register 357. For this example for example, GUI 210 determines that five audio sendings have been registered to the number. GUI 210 provides icon array 352 and displays five icons, one icon representing each of the five audio sendings (each icon comprising a song title with the date that sending was received included below the song title). For this example, the user touches one of the audio icons for more than two seconds. GUI 210 responds to the touched for duration icon by forwarding to trigger 393 the registration number of the picked audio sending. Trigger 393 waits for a signal indicating an activity, for this example, the next received incoming call from the number obtained by register 357. Responsive to said next call from the other party's telephone, a signal indicating this activity is sent to trigger 393. Trigger 393 responds to the signal by forwarding to provider 375 the registration number of the picked audio sending and by instructing provider 375 obtain and dispatch the sending. Provider 375 responds by obtaining and dispatching the audio sending to deliverer 360. (As an example for this example, provider 375 employs audio player 338 to play the sending and to dispatch the playing audio to ring-back delivery 391. Delivery 391 delivers the playing audio sending to the other party as the ring-back.

A fourth example of operation of this third example of the second embodiment (system 10gg) will now be given (3EX4). This fourth example comprises system 10kk and further configured to include sendings picker 385. (In other words, this first example comprises user-selected sendings supplier 380.) For this example, to operate as sendings picker 385 GUI 210 is configured to display an array of icons representing the last ten received class image sendings registered and an array of icons representing the last ten user-selected class image sendings registered. System 10kk is configured to respond to a touched icon in either of the two arrays by displaying the represented image on the display of GUI 210.

Any time day or night whether on the phone or not, GUI 210 provides an icon representing sendings on an opening display. Any time day or night whether on the phone or not the user can touch the icon and GUI 210 responds to the touched icon by displaying the array of icons representing the last ten received class image sendings registered along with the array of icons representing the last ten user-selected class sendings registered. Upon the user touching the icon, GUI 210 responds by displaying the represented image on the display of GUI 210. (Deliverer picker 377, described below, can be employed. Subsequent to picking a sending, the user picks a deliverer, for example email delivery 363. Delivery addresser 379 can also be employed. The user supplies an address. The picked image is dispatched to delivery 363. Delivery 363 delivers the image sending to the internet for delivery to the supplied address. Also, it will be appreciated in the above examples, and in following examples, that statements along the lines of “GUI 210 responds”, “GUI 210 provides”, or other action verbs associated with the GUI 210, that this is intended to mean that the GUI 210 interacts with circuitry and/or programming in order for the indicated action (or actions) to be performed, and which may include: (i) displaying results via the GUI; (ii) receiving user inputs via the GUI; and (iii) prompting user inputs via the GUI.)

This second embodiment can include a deliverer picker 377. Deliverer picker 377 functions to enable a user to pick a deliverer. An exemplary deliverer picker 377 is depicted in FIG. 2d, shown as D. Picker 377, shown located at GUI 210. The exemplary picker 377 can include GUI 210. To operate as picker 377, GUI 210 is configured to be capable of being placed in electronic communication with circuitry and/or programming to enable a user to pick a deliverer. To operate as deliverer picker 377, GUI 210 can be electrically connected to (or connectable to) sendings provider 375 and can be electrically connected to (or connectable to) registry 350. To operate as deliverer picker 377, GUI 210 can be configured to display a deliverer icon array 376, shown as D. Array 376. Array 376 can include a plurality of icons, each icon representative of a deliverer. As one example, array 376 can comprise ten icons: one icon representing speaker 362, one icon representing display 361, one icon representing text message display 366, one icon representing image display 367, one icon representing video display 367, one icon representing email delivery 363, one icon representing internet delivery 374, one icon representing provider delivery 369, one icon representing port 364 and one icon representing ring-back delivery 391.

To operate as deliverer picker 377, GUI 210 can include programming to receive and to respond to instruction from the user via the user touching an icon, said touched icon, for example, one of the plurality of icons in deliverer icon array 376. GUI 210 can respond to a user touched icon in array 376 by signaling provider 375. Provider 375 can respond by instructing dispatcher 336 dispatch a sending to the deliverer picked by the user. If the user touches a deliverer icon that is not available for the sending type being provided, as an example GUI 210 can blink the icon indicating to the user to pick a different deliverer. Said plurality of deliverers to pick from can include two or more of: speaker 362, display 361, GUI 210 providing the functionality of display 361, text message display 366, image display 367, video display 368, email delivery 363, internet delivery 374, service provider delivery 369, delivery port 364 and ring-back delivery 391. (As examples of icon representation: speaker 362 can be a depiction of a speaker, display 361 can be a depiction of a display, text message display 366 can be a depiction of text on a display, image display 367 can be a depiction of an image on a display, video display 367 can be a depiction of a video camera on a display, email delivery 363 can be the word EMAIL, internet delivery 374 can be then word NET, service provider delivery 369 can be a depiction of a telephone, delivery port 364 can be the word PORT, ring-back delivery 391 can be a depiction of bells.)

A fourth example of this second embodiment is illustrated as system 10hh in FIG. 2d. This exemplary system 10hh includes sendings receiver 340, sendings registry 350, storage 370, sendings provider 375, deliverer 360, delivery trigger 390 and deliverer picker 377, and can include other party address register 357, all shown located at a telephone 27hh. This fourth example can comprise the first, second or third example (and can comprise a combining of the first, second and/or third examples) and further configured to include deliverer picker 377. This fourth example can be further configured to include one or more of: sendings picker 385; a sendings call-up 396; a sendings identifier 345; a user-selected sendings supplier 380; a sendings poster supplier 440; and a configurator 395.

For this fourth example, sendings receiver 340 includes at least one of telephone receiver 344, email receiver 351 and internet receiver 409. Sendings registry 350 includes automatic register 401. Sendings provider 375 includes sendings obtainer 335 and sendings dispatcher 336. Deliverer 360 includes one or more of: speaker 362; display 361; text message display 366; image display 367; video display 368; email delivery 363; internet delivery 374; service provider delivery 369; delivery port 364; ring-back delivery 391; ring-back forward delivery 433; and ring-tone delivery 434. Delivery trigger 390 includes at least one of linked trigger 393 and user-deploy trigger 394. Telephone 27hh comprises mobile phone 165.

(Registry 350 can include user-selected default 410. Obtainer 335 can include prioritizer 341. Dispatcher 336 can include arranger 337. Arranger 337 can include one or more of: gallery 342; sequencer 348; and repeater 392. Sendings identifier 345 can include one or more of: universal identifier 349; special address identifier 437; manual identifier 403; requested sendings identifier 355; and auto-requester 365. Configurator 395 can include one or more of: a configuration selector 389; an enabler 373; and a data entry 407. System 10hh can include telephone 27hh and, thus, can phone 165. System 10hh can include caller I.D. circuitry 20. Circuitry 20 can include GUI 210 to serve as display 21.)

For this fourth example, sendings receiver 340 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. Linked trigger 393 can be electrically connected to (or connectable to) provider 375. GUI 210, operating as user-deploy trigger 394, can be electrically connected to (or connectable to) provider 375. To operate as deliverer picker 377, GUI 210 can be electrically connected to (or connectable to) sendings provider 375, can be electrically connected to (or connectable to) registry 350 and can be electrically connected to (or connectable to) trigger 390.

For this fourth example, deliverer picker 377 includes GUI 210. To operate as picker 377, GUI 210 GUI 210 is configured to be capable of being placed in electronic communication with circuitry and/or programming to enable a user to pick a deliverer. GUI 210 is configured to display a deliverer icon array 376. Array 376 includes a plurality of icons, each icon representative of a deliverer. To operate as deliverer picker 377, GUI 210 includes programming to receive and to respond to instruction from the user via the user touching an icon, said touched icon, for example, one of the plurality of icons in deliverer icon array 376. GUI 210 responds to said user touching an icon in array 376 by signaling provider 375. Provider 375 responds by instructing dispatcher 336 dispatch a sending to the deliverer picked by the user and represented by the touched icon.

A first example of operation of this fourth example of the second embodiment (system 10hh) will now be given (4EX1). This first example comprises system 10ee and further configured to include deliverer picker 377. (In other words, this first example comprises linked trigger 393.) For this example, to operate as deliverer picker 377, GUI 210 is configured to display icon array 376 with array 376 comprising the following icons: a depiction of a speaker representing speaker 362, a depiction of text on a display represents text message display 366, a depiction of an image on a display represents image display 367, a depiction of a video camera represents video display 367, the word EDEL represents email delivery 363, the word NET represents internet delivery 374, a depiction of a telephone represents service provider delivery 369, the word PORT represents external port 364 and a depiction of bells represents ring-back delivery 391. For this example, provider 375 is configured to obtain and dispatch the last registered text message sending found in inventory 324 registered to a telephone number obtained by address registry 357 and the last registered image sending found in inventory 324 and registered to the telephone number obtained by address registry 357. (Said last registered text message and image sendings obtained by obtainer 335 employing prioritizer 341. Also, provider 375 can be configured to obtain and dispatch a default user-selected text message or a default user-selected image if a text message sending or an image sending, respectively, is not found in inventory 324 registered to said telephone number. User-selected default 410, described later, can be employed to supply said user-selected default text message and/or said user-selected image message.)

A text message sending and an image sending supplied by an-other party have been received, registered, inventoried and stored (and any other sendings said other party may have supplied). Some time later, the user places a call to said other party by dialing the telephone number of said other party's telephone. Other party address register 357 obtains and stores the dialed telephone number. The completion of the dialing is detected. Said detection instructs GUI 210 to display icon array 376.

The other party answers the call and while the two parties converse the user touches the icon depicting text on a display representing text display 366. GUI 210 responds to the touched icon by determining to instruct that the last registered text message sending (registered to the number obtained by register 357) be dispatched to text message display 366. GUI 210 forwards said instruction to linked trigger 393. Later in the conversation, the user touches the icon depicting a telephone representing service provider delivery 369. GUI 210 responds to the touched icon by determining that either of the last registered text message sending or the last registered image sending (registered to the number obtained by register 357) can be delivered by service provider delivery 369. Consequently, GUI 210 displays an icon representing text message sending and an icon representing image sending. The user understands to touch one or the other to instruct GUI 210 that the sending represented by that touched icon is to be dispatched to delivery 369. For this example, the user touches the icon representing image sending. GUI 210 responds to the touched icon by forwarding to linked trigger 393 instruction that the last registered image sending is to be dispatched to delivery 369. Subsequently, user or other party hang up. The hang up (activity) is detected and signaled to linked trigger 393. Trigger 393 responds by instructing provider 375 to obtain and dispatch to display 366 the last registered text message sending registered to the number obtained by register 357. Trigger 393 further responds by instructing provider 375 to obtain and dispatch to delivery 369 the last registered image sending registered to the number obtained by register 357. Provider 375 obtains the text message sending and employs text message feed 339 to dispatch the sending to text message display 366 for the user to view. Provider 375 obtains the image sending and employs file dispatcher 347 to dispatch the sending to service provider delivery 369 for receipt at the other party's telephone via provider 121.

A second example of operation of this fourth example of the second embodiment (system 10hh) will now be given (4EX2). This second example comprises system 10ff and further configured to include deliverer picker 377. (In other words, this second example comprises deploy trigger 394.) For this example, to operate as deliverer picker 377, GUI 210 is configured to display icon array 376. For this example, provider 375 is configured to obtain and dispatch a gallery comprising all text message sendings registered to a telephone number obtained by address register 357 and the last registered (received) video sending registered to the telephone number obtained by address register 357 (said gallery arranged by gallery arranger 342 and said last registered obtained employing prioritizer 341). (Provider 375 can be configured to obtain and dispatch a default user-selected text message sending or default user-selected image sending if a text message sending or an image sending, respectively, is not found in inventory 324 registered to said telephone number obtained by register 357. User-selected default 410, described later, can be employed to supply said default text message and/or said image message.)

Audio sendings, text message sendings, image sendings and video sendings supplied by an-other party have been received, registered, inventoried and stored. Some time later, the user places a call to said other party by dialing the telephone number of said other party's telephone. Other party address register 357 obtains and stores the dialed telephone number. The completion of the dialing is detected. Said detection instructs GUI 210 to display icon array 376. For this example, array 376 includes an icon depicting a speaker representing speaker 362, an icon depicting text on a display representing text display 366, an icon depicting an image on a display representing image display 367, an icon depicting a video camera representing video display 368, an icon comprising the word EDEL representing email delivery 363, an icon comprising the word NET representing internet delivery 374, an icon depicting a telephone representing service provider delivery 369, an icon comprising the word PORT representing external port 364 and an icon depicting bells representing ring-back delivery 391.

The other party answers the call and while the two parties converse the user touches the icon depicting a telephone representing service provider delivery 369. GUI 210 responds to the touched icon by determining that either of the text message gallery of sendings or the video sending can be delivered by service provider delivery 369. Consequently, GUI 210 displays an icon representing text message and an icon representing video sending. The user understands to touch one or the other to instruct GUI 210 that the sending represented by that touched icon is to be dispatched to delivery 369. For this example, the user touches the icon representing image sending. GUI 210 responds by operating as deploy trigger 394 and instructing provider 375 to dispatch to delivery 369 a gallery of text message sendings comprising all text message sendings found in inventory 324 registered to the number obtained by registry 357. Obtainer 335 requests the text message sendings from registry 350. Registry 350 forwards the sendings to gallery arranger 342. Arranger 342 arranges the text message sendings into a gallery image and forwards the image to file dispatcher 347. Dispatcher 347 dispatches the gallery image to service provider delivery 369 for receipt at the other party's telephone via provider 121.

Later in the conversation, the user touches the icon comprising the word PORT representing external port 364. GUI 210 responds to the touched icon by determining that either of the text message gallery of sendings or the video sending can be delivered by external port 364. Consequently, GUI 210 displays an icon representing text message and an icon representing video sending. The user understands to touch one or the other to instruct GUI 210 that the sending represented by that touched icon is to be dispatched to external port 364. For this example, the user touches the icon representing video sending. GUI 210 responds by operating as deploy trigger 394 and instructing provider 375 to dispatch to port 364 the last registered video sending found in inventory 324 registered to the number obtained by register 357. Obtainer 335 (of provider 375) employs prioritizer 341 to obtain said last registered video sending from registry 350. Registry 350 forwards a read of the video sending to video player 346. Player 346 plays the forwarded read and dispatches a video feed of the playing video sending to port 364. The user has previously connected a TV to port 364. The playing video is displayed on the TV for the user to view. Subsequently, user or the other party hang up. Responsive to the hang up, system 10hh can be configured to continue or discontinue the video feed of the playing video sending dispatched to port 364.

A third example of operation of this fourth example of the second embodiment (system 10hh) will now be given (4EX3). This fourth example comprises system 10gg and further configured to include deliverer picker 376. (In other words, this third example comprises sendings picker 385.) The user touching an icon in icon array 352 (of sendings picker 385) functions as deploy trigger 394 to initiate provider 375. The user touching and holding for two seconds or more an icon in icon array 352 functions to signal linked trigger 393. For this example, picker 385 is further configured to include sendings type picker 354. For this example, to operate as deliverer picker 377, GUI 210 is configured to display icon array 376. For this example, system 10hh includes caller I.D. circuitry 20.

Sendings supplied by an-other party have been received, registered, inventoried and stored. Some time later, upon the user completing the dialing of a telephone number or upon receipt of an incoming telephone call, other party address register 357 obtains the dialed telephone number or the calling telephone's number from caller I.D. information, respectively. Upon obtaining the telephone number, register 357 provides the number to registry 350 and registry 350 responds by forwarding the registration number of each sending found in inventory 324 registered to that number to GUI 210. GUI 210, acting as type picker 354, determines from the forwarded registration numbers the types of sendings that have been registered to said telephone number. For this example, GUI 210 determines that four types have been registered and, so, GUI 210 displays four icons. One icon represents each type found in inventory 324 registered to the number obtained by register 357. GUI 210 displays a music note representing audio type, displays the word TEXT written in an antique font representing text message type, displays a miniature picture representing image type and displays a drawing depicting a video camera representing video type.

For this example, the telephone call is unanswered and incoming to the user. The user views caller I.D. information displayed on GUI 210 and from the information touches the TEXT icon. GUI 210 responds to the touched TEXT icon by determining from the registration numbers all text message sendings registered to the number obtained by register 357. For this example for example, GUI 210 determines that three text message sendings have been registered. GUI 210 provides icon array 352 and displays three icons, one icon representing each of the three text message sendings (each icon comprising the date that sending was received written in an antique font). GUI 210 also provides icon array 376. For this example, array 376 displays icons representing deliverers that can be employed for delivering a text message. Array 376 displays an icon depicting text on a display representing text display 366, an icon comprising the word EDEL representing email delivery 363, an icon comprising the word NET representing internet delivery 374, an icon depicting a telephone representing service provider delivery 369 and an icon comprising the word PORT representing external port delivery 364.

The user touches one of the icons from array 352 followed by one of the icons from array 376 (or can touch an icon from array 376 followed by an icon from array 352). GUI 210 responds to the touched icons by functioning as deploy trigger 394 to initiate provider 375 and by instructing provider 375 to dispatch the sending to the deliverer represented by the touched icon. Provider 375 obtains and dispatches the text message sending to the represented deliverer. As an example for this example, the user touches the word EDEL and subsequently touches one of the three icons representing the text messages. GUI 210 responds by initiating provider 375 obtain and dispatch the text message sending represented by the touched icon and by instructing provider 375 to employ file dispatcher 347 to dispatch the text message sending to email delivery 363. (In one configuration, email delivery 363 can deliver the sending inclusive of a pre-supplied email address for receipt at an email account. In another configuration, the prior-described email delivery addresser 379 can be employed. As an example, upon the user touching the EDEL icon, GUI 210 can provide a keypad and enable the user to supply an email address. GUI 210 can forward the entered address to email delivery 363. Delivery 363 can deliver the sending inclusive of the user-entered email address for receipt at an email account.)

GUI 210 again acting as type picker 354 displays the four type icons (one icon representing each of the determined four types of sendings registered). For this example, the user then answers the incoming call. While conversing, the user touches the miniature picture representing image type. GUI 210 responds to the touched image type icon by determining from the registration numbers all image sendings registered to the number obtained by register 357. For this example, GUI 210 determines that four image sendings have been registered. GUI 210 provides icon array 352 and displays four icons, one icon representing each of the four image sendings (each icon comprising a miniature of the picture stored with the date that sending was received included below the miniature). GUI 210 also provides icon array 376. For this example, array 376 displays icons representing deliverers that can be employed for delivering an image sending. Array 376 displays an icon depicting an image on a display representing image display 367, an icon comprising the word EDEL representing email delivery 363, an icon comprising the word NET representing internet delivery 374, an icon depicting a telephone representing service provider delivery 369 and an icon comprising the word PORT representing external port 364.

The user touches the icon depicting an image on a display (image display 367), the icon comprising the word NET (internet delivery 374), the icon depicting a telephone (service provider delivery 369) and one of the four image representing icons. GUI 210 responds to the touched one of the four image representing icons by functioning as deploy trigger 394 to initiate provider 375. GUI 210 responds to the touched image on a display icon, the touched word NET icon and the icon depicting a telephone by instructing provider 375 to dispatch the sending to image display 367, internet delivery 374 and service provider delivery 369, respectively. Obtainer 335 of provider 375 requests registry 350 forward the sending to dispatcher 336. Dispatcher 336 employs image feed 343 to dispatch the image sending to image display 367 and employs file dispatcher 347 to dispatch the image sending to internet deliver 374 and to service provider delivery 369. (In one configuration, internet delivery 374 can deliver the sending inclusive of a pre-supplied internet address for receipt at an Internet website. In another configuration, the prior-described internet delivery addresser 381 can be employed. As one example, upon the user touching the NET icon, GUI 210 can provide the user with a keypad enabling the user to enter an internet address. GUI 210 can forward the entered address to internet delivery 374. Delivery 374 can deliver the sending inclusive of the user-entered address for receipt at an internet website. In one configuration, service provider delivery 369 can employ the telephone number obtained by address register 357 and can deliver the image sending along with the telephone number to telephone service provider 121. Provider 121 can deliver the sending to the telephone having that telephone number. In another configuration, the prior-described provider delivery addresser 386 can be employed. As an example, upon the user touching the icon depicting a telephone, GUI 210 can provide a keypad and enable the user to supply a telephone number. GUI 210 can forward the entered telephone number to service provider delivery 369. Delivery 369 can deliver the sending inclusive of the user-entered address for receipt at the entered address.)

GUI 210 once again acting as type picker 354 displays the four type icons, one icon representing each of the determined four types of sendings registered. While further conversing, the user touches the music note representing audio type. GUI 210 responds to the touched audio type icon by determining from the registration numbers all audio sendings registered to the number obtained by register 357. For this example for example, GUI 210 determines that five audio sendings have been registered. GUI 210 provides icon array 352 and displays five icons, one icon representing each of the five audio sendings (each icon comprising a song title with the date that sending was received included below the song title). GUI 210 also provides icon array 376. For this example, array 376 displays icons representing deliverers that can be employed for delivering an audio sending. Array 376 displays an icon depicting a speaker representing speaker 362, an icon comprising the word EDEL representing email delivery 363, an icon comprising the word NET representing internet delivery 374, an icon depicting a telephone representing service provider delivery 369, an icon comprising the word PORT representing external port delivery 364 and an icon depicting bells representing ring-back delivery 391.

For this example, the user touches one of the audio icons for more than two seconds and touches the icon depicting bells representing ring-back delivery 391. GUI 210 responds to the user touching the icon for duration by signaling linked trigger 393 and by forwarding to trigger 393 the registration number of the picked audio sending and the instruction to dispatch the audio sending to ring-back delivery 391. Trigger 393 then waits for a signal indicating an activity, for this example, a user or other party hang up. For this example, the user hangs up. A signal indicating detection of the user hang up is sent to trigger 393. Trigger 393 responds to the signal by forwarding to provider 375 the registration number of the picked audio sending and by instructing provider 375 obtain and dispatch the sending to ring-back delivery 391. Provider 375 responds by obtaining the sending and by employing audio player 338 to dispatch the audio sending to delivery 391. Delivery 391 maintains an off-hook condition and delivers the playing audio sending to the other party until the other party hangs up. (They get to hear their favorite song clip! Also, as another example of operation of system 10hh, an opening menu on GUI 210 displays icons representing deliverers that can be employed with sendings. Upon the user touching one of said deliverer icon, GUI 210 displays, for example all sendings found in inventory 324 that can be delivered via the represented deliverer. Also, as another example of operation of system 10hh, picker 377 can comprise GUI 210 displaying only one icon, said one icon representing one deliverer and GUI 210 can respond to the user touching said one icon by signaling provider 375. Provider 375 can respond by signaling dispatcher 336 to dispatch a sending to that deliverer.)

This second embodiment can include a sendings call-up 396. Sendings call-up 396 functions to enable a user to call up a (one or more) sending. An exemplary sendings call-up 396 is depicted in FIG. 2e, shown as Call-up 396, shown located at GUI 210. The exemplary call-up 396 can include GUI 210. To operate as call-up 396, GUI 210 GUI 210 is configured to be capable of being placed in electronic communication with circuitry and/or programming to enable a user to call-up a (one or more) sending. Said sending can be a sending registered to an address, for example, registered to a telephone number, can be a sending registered to an identity, can be a sending registered to a type, can be a sending registered to a sending class or can be other. To operate as call-up 396, GUI 210 can be electrically connected to (or connectable to) sendings provider 375, can be electrically connected to (or connectable to) registry 350 and can be electrically connected to (or connectable to) trigger 390. GUI 210 can provide the user with a keypad and enable the user to enter information, for example, an address, a telephone number, an identity, a type, a class or some other information. The exemplary call-up 396 can enable a user to call up sending whether telephone 27 is communicably connected to another telephone or not.

In a first example, operating as call-up 396, GUI 210 can be configured to respond to an entered telephone number by requesting obtainer 335 request registry 350 forward, for example, one or more sendings of one or more types (audio, register 388; text message, register 382; image, register 383; video, register 384 or other) of one or more classes (received, register 328; identified, register 322; non-identified, register 327; user-selected, register 387), said requested sendings registered to the entered telephone number. (As examples, GUI 210 can be configured to request: one sending, five sendings, one image sending, three video sendings, one received class audio sending, four identified class text message sendings, etc., said requested sendings registered to the entered telephone number.) Registry 350 can respond to the request by forwarding the requested sending or sendings to dispatcher 336. Dispatcher 336 can dispatch the sending or sendings to deliverer 360. Deliverer 360 can deliver the sending or sendings.

In a second example, operating as call-up 396 GUI 210 can be configured to respond to an entered telephone number by requesting registry 350 forward, for example, the registration number for each of one or more sendings of one or more types (audio, register 388; text message, register 382; image, register 383; video, register 384 or other) of one or more classes (received, register 328; identified, register 322; non-identified, register 327; user-selected, register 387), said requested sendings registered to the entered telephone number. (As examples, GUI 210 can be configured to request: one sending, ten sendings, one video sending, three audio sendings, one non-identified class audio sending, six user-selected class text message sendings, etc., said requested sendings registered to the entered telephone number.) Registry 350 can respond to the request by forwarding the requested registration numbers to, for example, GUI 210. GUI 210 can display an icon representing each registration number found enabling the user to pick one (or more) of the sendings (for example, operating as sendings picker 385). (GUI 210 can also operate as deliverer picker 377 enabling the user to pick a deliverer.) The user touching one (or more) of the icons can serve to pick the represented sending. GUI 210 can then forward the registration number of the picked sending to obtainer 335. Obtainer 335 can request registry 350 forward the sending to dispatcher 336. Registry 350 can forward the sending to dispatcher 336. Dispatcher 336 can then dispatch the sending to deliverer 360. Deliverer 360 can then deliver the sending.

Said one or more sendings (first example above) or said one or more sending registration numbers (second example above) can comprise, for example: the last sending registered to the entered number, all sendings registered to the entered number; a given number of sendings registered to the entered number; the last sending of a given type registered to the entered number, all of a given type of sendings registered to the entered number; a given number of a given type of sendings registered to the entered number or can be other.

A fifth example of this second embodiment is illustrated as system 10ii in FIG. 2e. This exemplary system 10ii includes sendings receiver 340, sendings registry 350, storage 370, sendings provider 375, deliverer 360, delivery trigger 390 and sendings call-up 396, all shown located at a telephone 27ii. This fifth example can comprise the first, second, third or fourth example (and can comprise a combining of the first, second, third and/or fourth examples) and further configured to include sendings call-up 396. This fifth example can be further configured to include one or more of: sendings picker 385; deliverer picker 377; a sendings identifier 345; a user-selected sendings supplier 380; a sendings poster supplier 440; and a configurator 395.

For this fifth example, sendings receiver 340 includes at least one of telephone receiver 344, email receiver 351 and internet receiver 409. Sendings registry 350 includes automatic register 401. Sendings provider 375 includes sendings obtainer 335 and sendings dispatcher 336 and can include other party address register 357. Deliverer 360 includes one or more of: speaker 362; display 361; text message display 366; image display 367; video display 368; email delivery 363; internet delivery 374; service provider delivery 369; delivery port 364; ring-back delivery 391; ring-back forward delivery 433; and ring-tone delivery 434. Delivery trigger 390 includes at least one of linked trigger 393 and user-deploy trigger 394. Telephone 27ii comprises mobile phone 165.

(System 10ii can include address register 357. Registry 350 can include user-selected default 410. Obtainer 335 can include prioritizer 341. Dispatcher 336 can include arranger 337. Arranger 337 can include one or more of: gallery 342; sequencer 348; and repeater 392. Identifier 345 can include one or more of: universal identifier 349; special address identifier 437; manual identifier 403; requested sendings identifier 355; and auto-requester 365. Configurator 395 can include one or more of: a configuration selector 389; an enabler 373; and a data entry 407. System 10ii can include telephone 27ii and, thus, can include phone 165. System 10ii can include the caller I.D. circuitry 20. Circuitry 20 can include GUI 210 to serve as display 21.)

For this fifth example, sendings receiver 340 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. Linked trigger 393 can be electrically connected to (or connectable to) provider 375. GUI 210, operating as user-deploy trigger 394, can be electrically connected to (or connectable to) provider 375. To operate as call-up 396, GUI 210 can be electrically connected to (or connectable to) registry 350 and can be electrically connected to (or connectable to) sendings provider 375. For this fifth example, sendings obtained by provider 375 can be sendings received and inventoried as described prior in “ONE EXAMPLE OF OPERATION of receiving and inventorying sendings”.

For this fifth example, sendings call-up 396 includes GUI 210. To operate as call-up 396, GUI 210 GUI 210 is configured to be capable of being placed in electronic communication with circuitry and/or programming to enable a user to call-up one or more sendings registered to a telephone number. GUI 210 provides the user with a keypad to enable the user to enter a telephone number. The user employs the provided keypad to enter a telephone number.

In a first example, GUI 210 is configured to respond to an entered telephone number by requesting obtainer 335 request registry 350 forward one or more sendings of one or more types of one or more classes, said requested sendings registered to the entered telephone number. Registry 350 responds to the request by forwarding the requested sending or sendings to dispatcher 336. Dispatcher 336 dispatches the sending or sendings to deliverer 360. Deliverer 360 delivers the sending or sendings.

In a second example, GUI 210 is configured to respond to an entered telephone number by requesting registry 350 forward the registration number for each of one or more sendings of one or more types of one or more classes, said requested sendings registered to the entered telephone number. Registry 350 forwards said registration numbers found to GUI 210. GUI 210 displays an icon for each of said registration numbers found enabling the user to pick one (or more) of the sendings. The user touching one (or more) of the icons serves to pick the represented sending. GUI 210 forwards the registration number of the picked sending to obtainer 335 (of provider 336). Obtainer 335 requests registry 350 forward the sending to dispatcher 336. Registry 350 forwards the sending to dispatcher 336. Dispatcher 336 dispatches the sending to deliverer 360. Deliverer 360 delivers the sending.

A first example of operation of this fifth example of the second embodiment (system 10ii) will now be given (5EX1). This first example comprises system 10ee and further configured to include sendings call-up 396. (In other words, this first example comprises linked trigger 393.) For this first example, system 10ii includes address register 357. GUI 210 is configured to respond to an entered telephone number by requesting obtainer 335 request registry 350 forward all sendings found registered to the entered telephone number.

Sendings supplied by other parties have been received, registered, inventoried and stored. Some time later, the user places a call to an-other party or an-other party calls the user. Upon the placing of the call or receipt of the call, address register 357 obtains the telephone number of the other party's telephone and, operating as call-up 396, GUI 210 provides the user with a keypad enabling the user to enter a telephone number. The call is answered and while the user and other party converse the user employs the provided keypad and enters a telephone number. GUI 210 forwards the entered telephone number to linked trigger 393 along with the request that obtainer 335 request registry 350 forward all sendings found registered to the entered telephone number. Subsequently, user or other party hang up. A signal representing the detected hang up is sent to 350 forward all sendings found registered to the entered telephone number to obtainer 335. Obtainer 335 requests registry 350 forward said all sendings found registered to the entered telephone number. Registry 350 responds by forwarding the requested all sending found to dispatcher 336. Dispatcher 336 dispatches the sending or sendings to deliverer 360. Deliverer 360 delivers the sending or sendings. For this example for example, dispatcher 336 employs dispatcher 347 to dispatch said all sendings found to service provider delivery 369. Delivery 369 delivers said all sendings found to the number obtained by address register 357. In other words, said all sendings found registered to the entered telephone number are delivered to the other party's telephone via provider 121. (If system 10 does not include address register 357, GUI 210 can supply addresser 386 enabling the user to enter an-other party's telephone number.)

A second example of operation of this fifth example of the second embodiment (system 10ii) will now be given (5EX2). This second example comprises system 10ff and further configured to include sendings call-up 396. (In other words, this second example comprises deploy trigger 394. Trigger 394 employs GUI 210 to provide deploy trigger icon 398.) For this example, system 10ii can include address register 357. GUI 210 is configured to respond to an entered telephone number by requesting obtainer 335 request registry 350 forward all image sendings found registered to the entered telephone number.

Sendings supplied by other parties have been received, registered, inventoried and stored. Some time later, the user places a call to an-other party or an-other party calls the user. Upon the placing of the call or receipt of the call, operating as call-up 396, GUI 210 provides the user with a keypad enabling the user to enter a telephone number. The call is answered and while the user and other party converse the user employs the provided keypad and enters a telephone number. The user then touches deploy trigger icon 398. GUI 210 responds to the touched icon 398 by forwarding the entered telephone number to obtainer 335 and requests obtainer 335 request registry 350 forward all image sendings found registered to the entered telephone number. Obtainer 335 requests registry 350 forward said all image sendings found. Registry 350 responds to the request by forwarding the requested all image sending found to dispatcher 336. Dispatcher 336 dispatches the sending or sendings to deliverer 360. Deliverer 360 delivers the sending or sendings. For this example for example, dispatcher 336 employs gallery arranger 342 to arrange the images into a gallery and employs image feed 343 to dispatch the gallery of image sendings to image display 367. Dispatcher 336 also employs file dispatcher 347 to dispatch said all image sendings found to service provider delivery 369. Delivery 369 delivers said all sendings found (via provider 121). (If address register 357 is employed, delivery 369 addresses the sendings to the number obtained by register 357. If address register 357 is not employed, GUI 210 can supply delivery addresser 386 to enable the user to enter an-other party's telephone number.)

A third example of operation of this fifth example of the second embodiment (system 10ii) will now be given (5EX3). This third example comprises system 10gg and further configured to include sendings call-up 396. (In other words, this third example comprises sendings picker 385.) For this example, system 10ii can include address register 357. GUI 210 is configured to respond to an entered telephone number by requesting obtainer 335 request registry 350 forward the registration number for each audio, text message and image sending found registered to the entered telephone number.

Sendings supplied by other parties have been received, registered, inventoried and stored. Some time later, the user places a call to an-other party or an-other party calls the user. The call is answered and the user and other party converse. Upon the call being answered, operating as call-up 396 GUI 210 provides the user with a keypad to enable the user to enter a telephone number. During the conversation, the user employs the provided keypad and enters a telephone number. GUI 210 forwards the entered telephone number to registry 350 and requests registry 350 forward the registration number for each audio, text message and image sending found registered to the entered telephone number. Registry 350 responds by forwarding the registration number of each sending found in inventory 324 registered to the entered telephone number to GUI 210. GUI 210, acting as sendings picker 385, displays an icon for each of said registration number of each sending found enabling the user to pick one (or more) of the sendings. The user touching one (or more) of the icons serves to pick the represented sending (or sendings). GUI 210 forwards the registration number of the picked sending to obtainer 335. Obtainer 335 requests registry 350 forward the sending to dispatcher 336. Registry 350 forwards the sending to dispatcher 336. Dispatcher 336 dispatches the sending to deliverer 360. Deliverer 360 delivers the sending. For this example for example, the picked sending comprises an audio sending. Dispatcher 336 employs audio player 338 to play the audio sending and to dispatch the playing sending to speaker 362. For this example, speaker 362 comprises a broadcasting type speaker enabling the user to hear the playing audio sending and the other party to hear the sending in the background as they converse.

A fourth example of operation of this fifth example of the second embodiment (system 10ii) will now be given (5EX4). This fourth example comprises system 10gg and further configured to include sendings call-up 396. (In other words, this fourth example comprises sendings picker 385.) For this example, system 10ii includes caller I.D. circuitry 20 and includes address register 357. GUI 210 is configured to respond to an entered telephone number by requesting obtainer 335 request registry 350 forward the registration number for each of all sendings found registered to the entered telephone number.

Sendings supplied by other parties have been received, registered, inventoried and stored. Some time later, the user places a call to an-other party or an-other party calls the user. Upon the user completing the dialing of a telephone number or upon receipt of an incoming telephone call, other party address register 357 obtains the dialed telephone number or the calling telephone's number from caller I.D. information, respectively. Register 357 provides the number to registry 350 and, for this example, registry 350 responds by forwarding the registration number of each sending registered to that telephone number to GUI 210. GUI 210 then displays icon array 352, array 352 comprising one icon representing each forwarded registered sending. For this example, the telephone call is unanswered and incoming to the user and the user views caller I.D. information displayed on GUI 210. Based on the information the user decides to touch a text message icon displayed in array 352. GUI 210, functioning as deploy trigger 394, responds to the touched icon by initiating the providing of the text message sending. GUI 210 forwards the registration number of the text message sending to provider 375 and instructs provider 375 obtain and dispatch the sending. Provider 375 responds by obtaining and dispatching the sending to deliverer 360. (As an example for this example, provider 375 employs file dispatcher 347 and dispatches the text message sending file to provider delivery 369. Delivery 369 employs the telephone number obtained by register 357 and delivers the text message sending to the other party's telephone via provider 121. Provider 375 also employs text message feed 338 and employs text message feed 339 to dispatch the sending to message display 366.)

Subsequently, the call is answered. Operating as call-up 396, GUI 210 responds to said answered call by providing the user with a keypad enabling the user to enter a telephone number (in addition to continuing to display icon array 352). During the ensuing conversation the user employs the provided keypad and enters a telephone number. GUI 210 forwards the entered telephone number to registry 350 and requests registry 350 forward the registration number for each of all sendings found registered to the entered telephone number. Registry 350 responds by forwarding the registration numbers of each sending found inventory 324 registered to the entered telephone number to GUI 210. GUI 210, operating as sendings picker 385, displays an icon for each of said registration numbers found enabling the user to pick one (or more) of the sendings. The user touching one (or more) of the icons serves to pick the represented sending (or sendings). GUI 210 forwards the registration number of the picked sending to obtainer 335. Obtainer 335 forwards the registration number to registry 350 and requests registry 350 forward the sending. Registry 350 forwards the sending to dispatcher 336. Dispatcher 336 dispatches the sending to deliverer 360. Deliverer 360 delivers the sending.

A fifth example of operation of this fifth example of the second embodiment (system 10ii) will now be given (5EX5). This fifth example comprises system 10hh and further configured to include sendings call-up 396. (In other words, this third example comprises deliverer picker 377.) For this example, system 10ii can include address register 357. GUI 210 is configured to respond to an entered telephone number by requesting obtainer 335 request registry 350 forward the registration number for each of all sendings found registered to the entered telephone number.

Sendings supplied by other parties have been received, registered, inventoried and stored. Some time later, the user places a call to an-other party or an-other party calls the user. The call is answered and the user and other party converse. Upon the call being answered, operating as call-up 396, GUI 210 provides the user with a keypad enabling the user to enter a telephone number. During the conversation, the user employs the provided keypad and enters a telephone number. GUI 210 provides the entered telephone number to registry 350 and requests registry 350 forward the registration number for each of all sendings found registered to the entered telephone number. Registry 350 forwards a registration number for each of all sendings found in inventory 324 registered to the entered telephone number to GUI 210. Operating as sendings picker 385, GUI 210 displays an icon for each of said all registration numbers found enabling the user to pick one (or more) of the sendings. The user touching one (or more) of the icons serves to pick the represented sending (or sendings). For this example, the user touches an icon representing a text message sending. Operating as deliverer picker 377, GUI 210 provides icon array 376. For this example, array 376 displays icons representing deliverers that can be employed for delivering a text message. Array 376 displays an icon depicting text on a display representing text display 366, an icon comprising the word EDEL representing email delivery 363, an icon comprising the word NET representing internet delivery 374, an icon depicting a telephone representing service provider delivery 369 and an icon comprising the word PORT representing external port delivery 364. The user touches one of the icons of array 376. Operating as deploy trigger 394, GUI 210 responds to the touched icon by initiating provider 375 and by instructing provider 375 to dispatch the sending to the deliverer represented by the touched icon. Provider 375 obtains and dispatches the text message sending to the represented deliverer. If the deliverer is provider delivery 369 and system 10ii includes address register 357, the text message sending, for this example, is delivered to the other party's telephone. Conversely, if system 10ii does not include register 357, system 10ii can supply the prior-described provider delivery addresser 386 enabling the user to furnish a telephone number of a desired telephone destination.

For the above five examples of operation for system 10ii, operating as call-up 396, GUI 210 has been configured to respond to the user entering a telephone number by calling-up sendings registered to the entered telephone number. However, operating as call-up 396, GUI 210 can be configured many many different ways to call-up a sending or sendings. For example, operating as call-up 396, GUI 210 can be configured to call-up sendings in response to the user entering one or more of: an address, a telephone number, an identity, a sending type, a sending class, a time period of receipt or some other information.

This second embodiment can include a sendings identifier 345. Sendings identifier 345 functions to identify a sending. An exemplary sendings identifier 345 is depicted in FIGS. 2f, 2i and 2j, shown as Identifier 345. The exemplary identifier 345 can include circuitry and/or programming to identify a sending. For this exemplary sendings identifier 345, identifier 345 can detect for a distinguishing feature identifying a sending. For this example, a sending received by sendings receiver 340 can be forwarded to identifier 345. If identifier 345 detects said distinguishing feature, identifier 345 can forward the identified sending to registry 350. Registry 350 can employ identified class register 322 to register the sending under identified class. Registry 350 can then compile a registration number for the sending and include the registration number in inventory 324. If identifier 345 cannot detect said distinguishing feature, identifier 345 can be configured to forward the sending to registry 350 or can be configured to ignore the sending. If the sending is forwarded to registry 350, registry 350 can employ non-identified class register 327 to register the sending under non-identified class. Registry 350 can then compile a registration number for the sending and include the number in inventory 324. Said sendings registered under identified class and included in inventory 324 can subsequently be provided by sendings provider 375. For example, obtainer 335 can respond to delivery trigger 390 by requesting registry 350 provide a sending (or sendings) registered under identified class to dispatcher 336. Dispatcher 336 can dispatch said sending registered under identified class to deliverer 360, Deliverer 360 can deliver said sending registered under identified class. (Sendings registered under non-identified class can be provided by provider 375.)

In one variation, a sending detected to include said distinguishing feature can be identified by identifier 345 and immediately delivered by deliverer 360. (In one example, the identifying of a sending can comprise an activity that triggers trigger 393 to initiate provider 375 to provide the sending to deliverer 360.) As an example, an identified sending can be forwarded to registry 350. Registry 350 can determine from sending type information included with the sending the appropriate dispatcher to dispatch the determined type. Registry 350 can then forward the sending to the appropriate dispatcher and the dispatcher can dispatch the sending to a deliverer. As an example, the sending type is determined by registry 350 to be image. Registry 350 forwards the image sending to image feed 343. Feed 343 is configured to dispatch the sending to GUI 210, GUI 210 having a portion of it's display dedicated to displaying a feed 343 dispatched image. As another example, the sending type is determined by registry 350 to be video. Registry 350 forwards the video sending to file dispatcher 347. Dispatcher 347 dispatches the video sending to internet delivery 374. Delivery 374 posts the video on an internet social media website, for example, My Space. (Non-identified sendings can be immediately delivered. Also, the prior described identity information can be immediately delivered.)

Sendings identifier 345 can include a universal identifier 349. Universal identifier 349 functions to identify a universal distinguishing feature. An exemplary universal identifier 349 is depicted in FIGS. 2f, 2i and 2j, shown as Universal 349. The exemplary universal identifier 349 can include circuitry and/or programming to identify a universal distinguishing feature. For this exemplary identifier 349, said universal distinguishing feature comprises a feature that can be employed absent any specialized hardware and/or programming at the sending device (for example, a feature that can be sent by a present-day telephone) and that can be provided absent any special addressing by the sending party. Identifier 349 can identify a sending upon detecting said universal distinguishing feature. Identifier 349 can then forwarded the identified sending, for example, to registry 350.

A distinguishing feature can be a signal marker sent along with a sending. However, a sending telephone requires specialized hardware and/or programming to implement the signal marker and, thus, the signal marker is not a universal distinguishing feature. Three examples of a universal distinguishing feature are described below: a telephone call time window 422, a matching addresses 397 and a time of day time window 399.

Universal identifier 349 can include a telephone call time window identifier 422 (shown as TCTW 422 in FIGS. 2f, 2i and 2j). As one example of telephone call time window identifier 422, identifier 422 can detect for a sending received during a specified period of time during a telephone call. As one example of said specified period of time, the time between when an incoming call is detected and three seconds after the detection. As another example, the time between the hang up of a call and the receipt of a next call or the placing of a next call. The time window can be specified by, for example, a telephone manufacturer, a service provider, a user or by other. Upon identifier 422 detecting a sending received during said specified period of time (time window) identifier 422 can then forward the identified sending. As another example of said specified time, any time during a telephone call. Identifier 422 can detect for receipt of a sending at any time during a telephone call (including from when the call is first received or first place until after hang-up and, for example, before receipt or placing of a next telephone call). (Identifier 422 can be configured to inform an-other party as to the time during a call that the window is open by sending a message to said other party. More than one time window can be employed, i.e. different time windows, for example, for receipt of different type sendings. Also, identifier 422 can include a clock and can employ the clock to measure elapsed time.)

Universal identifier 349 can include a matching addresses identifier 397 (shown as MAI 397 in FIGS. 2f, 2i and 2j). As one example of matching addresses identifier 397, identifier 397 can detect for a sending received sent from an address that matches the address of the telephone of the other party of a telephone call (said telephone call can include from when the call is first received or first place until after hang-up and, for example, before receipt or placing of a next telephone call). For example, during a telephone call, identifier 397 can store the telephone number of the other party's telephone in an-other party number storage 356 shown as OP #356. For a call incoming to the user, identifier 397 can store in storage 356 the telephone number provided in caller I.D. information supplied by service provider 121 and, for a call outgoing from the user, identifier 397 can store is storage 356 the telephone number dialed by the user. Identifier 397 can obtain the telephone number of the sending telephone and can store the number in a sending number storage 408 shown as SD #408. Identifier 397 can compare the telephone number of the other party's telephone stored in storage 356 with the number from where the sending was sent stored in storage 408. If the two numbers match, identifier 397 can then identify the sending. As an example of operation, during a telephone call the user requests a sending from the other party and the other party dispatches the sending to the user's telephone. Identifier 397 detects that the address of the sending telephone matches the address of the other party's telephone and, thus, identifies the sending. Identifier 397 can then forward the identified sending. (The prior described other party address register 357 can be configured to function as other party number storage 356.)

Universal identifier 349 can include a time of day time window identifier 399 (shown as TDTW 399 in FIGS. 2f, 2i and 2j). As one example of time of day time window identifier 399, identifier 399 can detect for a sending received during a specified period of time during the day, or during a specified period of time during a particular day or can detect for a sending received during the entirety of a specified day. Between 8 and 8:30 a.m. is one example of said specified period of time. The time window can be specified by, for example, a telephone manufacturer, a service provider, the user or by other. A sending received during said specified period of time (time window) can be identified by identifier 399 and then forwarded. (Identifier 399 can be configured to inform an-other party as to the time of day the window is open by sending a message to said other party. More than one time window can be employed, i.e. different time windows, for example, for receipt of different type sendings. Also, identifier 399 can include a clock and can employ the clock to measure time of day.)

Alternately, sendings identifier 345 can be an identifier other than universal identifier 349 (above-given examples of identifier 349: identifiers 422, 397 and 399). For example, identifier 345 can be an identifier that detects for some other distinguishing feature (or features), for example: a signal marker sent with the sending, a mark on the sending, a sending density range, a sending file size range, a frequency range or any feature that distinguishes the sending relative to other sendings. However, these distinguishing features require that the other party's telephone comprise specialized hardware.

Sendings identifier 345 can include a special address identifier 437. Special address identifier 437 functions to identify a special address. An exemplary special address identifier 437 is depicted in FIGS. 2f, 2i and 2j, shown as Special 437. The exemplary identifier 437 can include circuitry and/or programming to identify a special address. As an example of this exemplary identifier 437, identifier 437 can be configured to identify an address distinguished from the delivery address typically employed for sendings or can be configured to identify an address distinguished from the return/senders address typically provided with delivered sendings. As an example of operation, an-other party can send content to, for example the user's telephone. When addressing the sending, said other party can include special addressing. Said special addressing can comprise, for example, addressing in addition to the typical delivery address for sending content, for example, to one telephone from another. The sending can be received and forwarded to identifier 345. Identifier 437 can then identify said special addressing and can then forward the special addressed sending or sendings to, for example, registry 350. Registry 350 can employ, for example, identified class register 322 to register the sending under identified class. (Alternately, registry 350 can comprise a special class register and can employ said special class register. Also, a plurality of special addresses can be employed, each special address serving to be identified by identifier 437 to special route the sending, for example, to a register of registry 350 unique for each special address or to a destination unique to each special address. Said destination can be: a printer, speaker 362, display 361, delivery 391, port 364, delivery 369, delivery 374, delivery 379 or can be other. Also, in one variation, the special address can comprise, for example, a special signal sent by the other party from, for example, a non-specialized i.e. present-day phone. The special signal can be, for example, a signal from a pound key pressed on the other party's telephone. Special address identifier 437 can be configured to identify the key signal and can respond, as one example, by identifying any sendings sent immediately prior to or immediately after receipt of said key signal and can instruct registry 350 to inventory the sending or sendings accordingly.)

Sendings identifier 345 can include a manual identifier 403. Manual identifier 403 functions to enable a user to identify a sending. An exemplary manual identifier 403 is depicted in FIGS. 2f, 2i and 2j, shown as Manual 403. The exemplary identifier 403 can include circuitry and/or programming to enable a user to identify a sending. For this exemplary identifier 403, a sending can be received and can be available to identifier 403. Manual identifier 403 can enable the user to access the sending to distinguish the sending from other sendings received. As one example of operation, identifier 403 can enable the user to access an inbox containing sendings received, can enable the user to listen to and/or view each sending in the inbox and can enable the user to choose/identify one or more of the sendings. In another example, identifier 403 can enable the user to access an inbox containing sendings received and can enable the user to choose/identify one or more of the sendings from sending description information provided at the inbox. For either example, identifier 345 can then forward the manually identified sending or sendings to, for example, registry 350. Registry 350 can employ, for example, identified class register 322 to register the sending under identified class (or registry 350 can comprise a manual class register and can employ said manual class register). Subsequently, delivery trigger 390 can trigger provider 375 to provide the sending to deliverer 360. (In one variation, a sending identified by the user can be immediately provided by provider 375 and delivered. The sending can be registered by registry 350 (and can be stored in storage 370) and forwarded to provider 375. Provider 375 can provide the sending to deliverer 360. The identifying of the sending can comprise the activity to trigger the providing.)

Sendings identifier 345 can include a requested sendings identifier 355. Requested sending identifier 355 functions to identify a requested sending. An exemplary sendings requester 355 is depicted in FIGS. 2f, 2i and 2j, shown as Req. 355. The exemplary sendings requester 355 can include circuitry and/or programming to identify a requested sending. The exemplary requester 355 can include GUI 210. GUI 210 can be electrically connected to (or connectable to) sendings identifier 345 (direct connection not shown out of illustrative convenience). GUI 210 can display a request sendings icon 404, shown as RS 404. A user touching request sendings icon 404 can cause GUI 210 to send a signal to identifier 355. (Electrical connection not shown in FIG. 2i for illustrative convenience.) Identifier 355 can respond to the signal by storing the other party's address, for example the other party's telephone number (can store in the manner described for address identifier 397). Subsequently, the other party can send content and the content comprising a sending or sendings can be received and forwarded to identifier 355 (of identifier 345). Identifier 355 can obtain the telephone number from where the sending was sent, said number delivered with the sending and can compare that telephone number with the stored other party telephone number. If the numbers match, identifier 355 can identify the sending or sendings as comprising a requested sending and can forward the sending or sendings to registry 350. Registry 350 can employ, for example, identified class register 322 to register the sending under identified class (or registry 350 can comprise a requested class register and can employ said requested class register).

As one example of operation of identifier 355, the user can be engaged in a telephone call with an-other party. The user can convey to the other party, for example. “Send me some content, I'll make you a star in my universe”. Upon making the request, the user touches request sendings icon 404. Identifier 355 responds to the touched icon by storing the other party's telephone number. Subsequently, any sendings received from said other party's telephone number are identified as comprising requested sendings and are registered accordingly. As another example of operation of identifier 355, during a telephone call (including from when the call is first received or first place until after hang-up and, for example, before receipt or placing of a next telephone call) the user can touch icon 404. Touched icon 404 instructs GUI 210 to deploy a stored user-selected text message to the other party's telephone, the message requesting the other party provide content. (The touched icon instructs GUI 210 to send a signal to sendings provider 375. Provider 375 responds by dispatching said user-selected text message to delivery 369. Subsequently, delivery 369 sends the text message to the other party's telephone. Alternately, provider 375 can respond by providing a video message or an audio message or an image message or other.) Touched icon 404 also sends a signal to identifier 355. Identifier 355 responds to the signal by storing the other party's telephone number. Subsequently, any sendings received from said other party's telephone number are identified as comprising requested sendings and are registered accordingly. As another example of operation of identifier 355, identifier 355 can be configured to enable the user to request sendings at any time, on the phone or not. Identifier 355 can enable the user to address a sendings request message. The user touched icon 404 can instruct GUI 210 to deploy said sendings request message (message can be text, audio, image video or other). The user-touched icon 404 can instruct identifier 355 to store the user-supplied address (telephone number) to subsequently match the number with that of sendings received. (The prior-described matcher 353 can be employed by identifier 355 to match sendings identity information. Also, as can be seen from the above examples of operation of requested sendings identifier 355, identifier 355 can function absent any specialized other party telephone hardware or other party special addressing. Thus universal identifier 349 can include identifier 355.)

Requested sendings identifier 355 can include a request picker 411. Picker 411 functions to enable a user to pick a request message from a plurality of request messages. An exemplary picker 411 is depicted in FIGS. 2f, 2i and 2j, shown as M. Picker 411. The exemplary picker 411 can include GUI 210. GUI 210 can provide picker 411 as an array comprising a plurality of icons with each icon representing a unique stored message. (Picker 411 shown comprising icon 404.) A user touching one of the icons in array 411 can instruct GUI 210 to send a signal to sendings provider 375. Provider 375 can respond by dispatching the message representing the touched icon to delivery 369. Delivery 369 can send the message represented by the icon for receipt at the other party's telephone. The user touching an icon also can send a signal to identifier 355. Identifier 355 can store the other party's telephone number to subsequently match the number with that of the telephone number from where sendings have been sent.

Requested sendings identifier 355 can include a deliverer picker 412. Picker 412 functions to enable a user to pick a deliverer to route a (one or more) requested sending to the picked deliverer. An exemplary picker 412 is depicted in FIGS. 2f, 2i and 2j, shown as D. Picker 412. The exemplary picker 412 employs GUI 210. GUI 210 can provide picker 412 as an array comprising a plurality of icons with each icon representing a deliverer. GUI 210 is shown providing picker 412 as an array comprising: speaker 362 represented as icon S 413; display 361 represented as icon D 414; ring-back delivery 391 represented as icon RB 416; port 364 represented as icon P 417; service provider delivery 369 represented as icon SP 418; internet delivery 374 represented as icon I 419; and email delivery 379 represented as icon E 421. A user touching one of the icons in array 412 can instruct GUI 210 to send a signal to sendings provider 375. Provider 375 can respond by dispatching a user-selected message to delivery 369. (The message can be a text message, a video message, an audio message, an image message or can be other.) Delivery 369 can send the message represented by the touched icon to the other party's telephone. The user touching the icon can also send a signal to identifier 355. Identifier 355 can store the other party's telephone number to subsequently match the number with that of sendings received. Identifier 355 can also store the deliverer type represented by the touched icon.

In one configuration, upon a received sending or sendings being forwarded to identifier 345, identifier 355 can then obtain the sending origin telephone number delivered with the sending and can compare the telephone number with the stored other party telephone number. If the numbers match, identifier 355 can identify the sending or sendings as comprising a deliverer picker requested sending and can forward the sending or sendings to registry 350. Registry 350 can employ, for example, a deliverer identified class register to register the sending according to the deliverer represented by the touched icon. Subsequently, for example, when obtainer 335 requests a sending from registry 350 registered to the subject other party's telephone number, registry 350 can provide the sending and can instruct dispatcher 336 to employ the appropriate dispatcher to dispatch the sending to the deliverer registry 350 has registered the sending to. In other words, as an example of operation, if the user employs picker 412 and touches an icon representing display 361, sendings received from the other party are registered by registry 350 in a class register representing display 361. Subsequently, when registry 350 forwards a sending registered to the class register representing display 361, registry 350 instructs dispatcher 336 to dispatch the sending to display 361.

In another configuration, upon a sending or sendings being forwarded to identifier 345, identifier 355 can then obtain the origin telephone number delivered with the sending and can compare the origin telephone number with the stored other party telephone number. If the numbers match, identifier 355 can identify the sending or sendings as comprising a deliverer picker requested sending and can forward the sending or sendings to the deliverer represented by the touched icon. (Picker 312 can be configured to operate in conjunction with request picker 411.)

Sendings identifier 345 can include an auto-requester 365. Auto-requester 365 functions to automatically request sendings. An exemplary auto-requester is depicted in FIGS. 2f, 2i and 2j, shown as Auto 365. The exemplary auto-requester 365 can include circuitry and/or programming to automatically request sendings. For this exemplary auto-requester 365, identifier 345 can be electrically connected to registry 350. As one example, responsive to an incoming or placed, for example telephone call, auto-requester 365 can employ registry 350 to determine that inventory 324 includes, for example, no sendings whatsoever registered to the other party's telephone (or, for example no sendings whatsoever of a given type or types). In other words, no sendings have been received from the other party's telephone (or, for example, from the other party's email). Identifier 365 can respond, for example, by sending to the other party's telephone (email) a message requesting a sending or sendings (said message can be user-selected). The other party may respond by sending content. As another example, registry 350 can be configured to catalog incoming call telephone numbers and/or dialed telephone numbers. Auto-requester 365 can be configured to periodically search said catalog to locate each telephone number (address) having no sendings (or no sendings of a type or types) registered thereto. Auto-requester 365 can respond, for example, by sending to the other party's telephone (email) a message requesting a sending or sendings (said message can be user-selected).

Auto-requester 365 can operate in conjunction with requested sending identifier 355. As an example, the address to where auto-requester 365 sends a message requesting content can be stored by identifier 355. Subsequently, identifier 355 can match the stored number with the telephone number from where a received sending has been sent. When the stored number matches the telephone number, identifier 355 identifies the sending and registry 350 can then register the sending, for example under identified class or under a auto-requested class or under other.

A sixth example of this second embodiment is illustrated as system 10jj in FIG. 2f. This exemplary system 10jj includes sendings receiver 340, sendings registry 350, storage 370, sendings provider 375, deliverer 360, delivery trigger 390 and sendings identifier 345, and can include other party address register 357, all shown located at a telephone 27jj. This sixth example can comprise the first, second, third, fourth or fifth example (and can comprise a combining of the first, second, third, fourth and/or fifth examples) and further configured to include sendings identifier 345. Sendings identifier 345 can include one or more of: universal identifier 349; special address identifier 437; manual identifier 403; requested sendings identifier 355; and auto-requester 365. Universal identifier 349 can include one or more of: telephone call time window identifier 422; time of day time window identifier 399; and matching addresses identifier 397. Requested sendings identifier 355 can include one or both of request picker 411 and deliverer picker 412. This sixth example can be further configured to include one or more of: sendings picker 385; deliverer picker 377; sendings call-up 396; a user-selected sendings supplier 380; a sendings poster supplier 440; and a configurator 395.

For this sixth example, sendings receiver 340 includes at least one of telephone receiver 344, email receiver 351 and internet receiver 409. Sendings registry 350 includes automatic register 401 and inventory 324. Sendings provider 375 includes sendings obtainer 335 and sendings dispatcher. Deliverer 360 includes one or more of: speaker 362; display 361; text message display 366; image display 367; video display 368; email delivery 363; internet delivery 374; service provider delivery 369; delivery port 364; ring-back delivery 391; ring-back forward delivery 433; and ring-tone delivery 434. Delivery trigger 390 includes at least one of linked trigger 393 and user-deploy trigger 394. Telephone 27jj comprises mobile phone 165.

(Registry 350 can include user-selected default 410. Obtainer 335 can include prioritizer 341. Dispatcher 336 can include arranger 337. Arranger 337 can include one or more of: gallery 342; sequencer 348; and repeater 392. System 10jj can include telephone 27jj and, thus, can include phone 165. System 10jj can include caller I.D. circuitry 20. Circuitry 20 can include GUI 210 to serve as display 21. Configurator 395 can include one or more of: a configuration selector 389; an enabler 373; and a data entry 407.

For this sixth example, sendings receiver 340 can be electrically connected to (or connectable to) sendings identifier 345. Sendings identifier 345 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. Linked trigger 393 can be electrically connected to (or connectable to) provider 375. GUI 210, operating as user-deploy trigger 394, can be electrically connected to (or connectable to) provider 375. GUI 210 can be electrically connected to (or connectable to) identifier 345.

For this sixth example, sendings identifier 345 includes circuitry and/or programming to identify a sending. Identifier 345 detects for a distinguishing feature identifying a sending. For this example, a sending received by sendings receiver 340 is forwarded to identifier 345. If identifier 345 can identify said distinguishing feature, identifier 345 forwards the identified sending to registry 350. Registry 350 employs identified class register 322 to register the sending under identified class. Registry 350 then compiles a registration number for the sending and includes the registration number in inventory 324. If identifier 345 cannot detect said distinguishing feature, identifier 345 can be configured to forward the sending to registry 350 or can be configured to ignore the sending. If the sending is forwarded to registry 350, for this example registry 350 employs non-identified class register 327 to register the sending under non-identified class. Registry 350 then compiles a registration number for the sending and includes the number in inventory 324. Said sendings registered under identified class and included in inventory 324 can subsequently be provided by sendings provider 375. For example, obtainer 335 can request registry 350 provide a sending (or sendings) registered under identified class to dispatcher 336. Dispatcher 336 can dispatch said sending registered under identified class to deliverer 360, Deliverer 360 can deliver said sending registered under identified class.

In a first example, sendings forwarded from receiver 340 can be identified by identifier 345 and register 322 (of registry 350) registers the identified sendings under identified class. For sendings forwarded from receiver 340 that identifier 345 fails to identify, identifier 345 can be configured to ignore or delete them. Provider 375 can then obtain and dispatch the identified class sendings.

In a second example, sendings forwarded from receiver 340 can be identified by identifier 345 and identified class register 322 (of registry 350) registers the identified sendings under identified class. For sendings forwarded from receiver 340 that identifier 345 fails to identify, identifier 345 can forward the sendings and non-identified class register 327 (of registry 350) can register these non-identified sendings under non-identified class. Provider 375 can then obtain and dispatch the identified class sendings under certain circumstances and can obtain and dispatch the non-identified class sendings under other circumstances. (System 10 can be configured having receiver 340 electrically connected to (or connectable to) identifier 340 and is also electrically connected to (or connectable to) registry 350. For this configuration, receiver 340 can forward certain sendings to identifier 345 and can forward other sendings to registry 350, thus bypassing identifier 345. In other words, registry 350 can employ identified class register 322, non-identified class register 327 and received class register 328.)

In the prior-given examples of operation for the first, second, third, fourth and fifth examples of this second embodiment, sendings received by sendings receiver 340 were forwarded to registry 350, registered by received class register 328, included in inventory 324 and, subsequently, provided by provider 375 and delivered by deliverer 360.

In prior-given examples of the first, second, third, fourth and fifth examples of this second embodiment, a sending received by receiver 340 was forwarded to received class register 328, registered, included in inventory 324 and, subsequently, provided by provider 375 to deliverer 360. Sendings identifier 345 can be employed in any or all of said prior-given examples. As shown, identifier 345 can be located between sendings receiver 340 and registry 350. A sendings previously forwarded to registry 350 (register 328) in said prior-given examples can instead be forwarded to identifier 345. Identifier 345 can identify the sending (or not) and can then forward the identified sending to registry 350. Identified class sendings can be employed anywhere received class sendings can be employed. (Also, non-identified class sendings can be employed anywhere received class sendings can be employed and, the to-be-described user-selected class sendings can be employed anywhere received class sendings can be employed). Identified class sendings can be linked trigger deployed for example employing linked trigger 393. Identified class sendings can be user-deploy trigger deployed for example employing deploy trigger 394. Identified sendings can be picked, for example employing sendings picker 385. Identified sendings can be called up, for example employing sendings call-up 396. This second embodiment can employ one or more of: received class sendings, identified class sendings, non-identified class sendings and user-selected class sendings.

This second embodiment can include a user-selected sendings supplier 380. User-selected sendings supplier 380 functions to enable employment of user-selected sendings. An exemplary user-selected sendings supplier 380 is depicted in FIGS. 2g, 2i and 2j, shown as U.S. Sendings Supplier 380. The exemplary supplier 380 can include circuitry and/or programming to enable employment of user-selected sendings. The exemplary sendings supplier 380 includes a sendings selector 425 and a user-selected registry 405 and can include a user-selected default 410.

The exemplary user-selected sendings supplier 380 includes sendings selector 425. Sendings selector 425 functions to enable a user to select a sending. An exemplary sendings selector 425 is depicted in FIG. 2g, shown as Selector 425. The exemplary selector 425 can include circuitry and/or programming to enable a user to select a sending. For this exemplary sendings selector 425, selector 425 can enable a user to select a sending comprising content configured to be sent electronically or a sending comprising a file containing content. (Selector 425 can place content selected by the user in a file, the user can place selected content in a file, or content selected by the user can already be in a file.) For this exemplary sending selector 425, selector 425 can enable the user to select one or more of: audio sendings, text message sendings, image/picture sendings, video sendings or combined audio and video sendings. Sending selector 425 can include one or more of: a port 423, an internet access, 424; an audio recorder 426; a data entry 427; a still camera 428, a video camera 429, a memory access 431, a service provider access 432, and/or some other source for sendings.

Sending selector 425 can include a port 423. Port 423 functions to enable sendings to be selected from an external source. An exemplary port 423 is depicted in FIG. 2g, shown as Port 423. The exemplary port 423 can enable the user to select sendings from a device external to system 10. As an example, port 423 can comprise a port adapted for connection to a cable. An external device can be electrically connected to system 10 via a cable connecting the device to port 423. Examples of a device external to system 10 electrically connectable to port 423 include: an audio recorder, a music player, a text message entry device, a personal computer, a still camera, a video camera, a DVD recorder or other. Selector 425 can forward a sending selected employing port 423 to registry 405.

Sending selector 425 can include internet access 424. Internet access 424 functions to enable sendings to be selected from the internet. An exemplary internet access 424 is depicted in FIG. 2g, shown as Net 424. The exemplary access 424 can enable the user to select sendings from the internet. As examples: access 424 can enable the user to access the internet via service provider 121; access 424 can enable the user to access the internet via wifi; access 424 can include telephone 27 being internet enabled or wifi enabled enabling the user to access sendings/content delivered to an email account. Selector 425 can forward a sending selected employing access 424 to registry 405.

Sending selector 425 can include an audio recorder 426. Audio recorder 426 functions to enable the recording of audio sendings. An exemplary recorder 426 is depicted in FIG. 2g, shown as Rec 426. The exemplary recorder 426 can enable the user to record audio for employment in a sending. As an example, recorder 426 can comprise an audio recording device and the user can be enabled to employ the device to record audio to be employed in an audio sending. Selector 425 can forward a sending selected employing recorder 426 to registry 405.

Sending selector 425 can include a text entry 427. Text entry 427 functions to enable the entry of a text message sending. An exemplary entry 427 is depicted in FIG. 2g, shown as Keys 427. The exemplary entry 427 can enable the user to enter text for employment in a sending. As an example, entry 427 can employ GUI 210 and GUI 210 can provide the user with a keypad to enable the user to enter text. As another example, entry 427 can employ voice recognition hardware and/or software to enable the user to enter text for employment in a sending (the sending can be a text message sending, a combined text message and image sending or other). Selector 425 can forward a sending selected employing entry 427 to registry 405.

Sending selector 425 can include a still camera 428. Still camera 428 functions to enable the making of an image sending. An exemplary camera 428 is depicted in FIG. 2g, shown as S. Cam 428. The exemplary camera 428 can enable the user to record an image for employment in a sending. As an example, camera 428 can comprise a still camera and the user can be enabled to employ the still camera to take a picture/image and employ the picture in an image sending. Selector 425 can forward a sending selected employing camera 428 to registry 405.

Sending selector 425 can include a video camera 429. Video camera 429 functions to enable the making of a video sending. An exemplary camera 429 is depicted in FIG. 2g, shown as V. Cam 429. The exemplary camera 429 can enable the user to record a video for employment in a sending. As an example, camera 429 can comprise a video camera and the user can be enabled to employ the video camera to take video and employ the video in a video sending. Selector 425 can forward a sending selected employing camera 429 to registry 405.

Sending selector 425 can include a memory access 431. Memory access 431 functions to enable access to memory to select sendings. An exemplary access 431 is depicted in FIG. 2g, shown as Mem 431. The exemplary access 431 can enable the user to access memory to select sendings. As an example, access 431 can enable the user to access sendings stored in memory available to access 421 to select a sending therefrom. (Said memory can be memory located at telephone 27.) As one example, access 431 can enable a user to access storage 370 to select one or more sendings stored there. Access 431 can enable the user to access storage 370 to select one or more of: received class sendings, identified class sendings, non-identified class sendings or any other sendings. Selector 425 can forward a sending selected employing access 431 to registry 405.

Sending selector 425 can include a service provider access 432. Provider access 432 functions to enable access to a service provider to select sendings. An exemplary access 432 is depicted in FIG. 2g, shown as S P 432. The exemplary access 432 can enable the user to access content/sendings stored at or available to a service provider, for example service provider 121, to select sendings. As an example, access 432 can enable user access to sendings stored by service provider 121 and/or sendings available at a website associated with provider 121. As another example, access 432 can include telephone 27 configured to be service provider enabled enabling the user to access sendings delivered to a telephone mail account. Selector 425 can forward a sending selected employing access 432 to registry 405.

The exemplary user-selected sendings supplier 380 includes a user-selected registry 405. User-selected registry 405 functions to register user-selected sendings. An exemplary user-selected registry 405 is depicted in FIGS. 2g, 2i and 2j. The exemplary user-selected registry 405 can include circuitry and/or programming to register user-selected sendings. For this exemplary registry 405, registry 405 can register a trait (or traits) of a sending to be a component (or components) of a registration number. Registry 405 can forward the registered user-selected sending to registry 350. Registry 350 can compile said component or components into said registration number and can then list said compiled registration number in inventory 324. Subsequently, the sending can be located by registry 350 searching inventory 324 for the registration number or for one or more of said components of the registration number.

The user can employ sendings selector 425 to select a sending. Selector 425 can forward the selected sending to registry 405. As a first example, registry 405 can detect the forwarded sending and can supply the sending to registry 350 and instruct registry 350 to employ user-selected class register 387 (of registry 350) to register the sending under user-selected class. (Alternately, selector 425 can forward the sending directly to registry 350. Registry 350 can be configured to respond to receipt of a sending from selector 425 by employing user-selected class register 387 to register the sending under user-selected class. In other words, for this example, registry 350 can provide the functionality of registry 405.)

As a second example, registry 405 can detect the forwarded sending and can supply the sending to registry 350 and can instruct registry 350 to employ one or more of: time register 371, type register 372 and user-selected class register 387. Registry 350 can employ time register 371 to register the time the registering of the sending takes place. Registry 350 can employ type register 372 to register the type the sending comprises. Registry 350 can employ user-selected class register 387 to register the sending under user-selected class. (Alternately, selector 425 can forward the sending directly to registry 350. Registry 350 can be configured to respond to receipt of a sending from selector 425 by employing one or more of: time register 371, type register 372 and user-selected class register 387. In other words, for this example, registry 350 can provide the functionality of registry 405. Also, register 372 can obtain type information included with the supplied sending to register the sending under type. For example, the sending can comprise type information included with file addressing.)

As a third example, registry 405 can detect the forwarded sending and can enable the user to provide one or more of: address information, time registered, sending type, sending class or some other trait or relevant information (as an example the name of an-other party). Registry 405 can include GUI 210, US Registry 405 shown located at GUI 210 in FIGS. 2g, 2i and 2j. GUI 210 can provide a keypad to enable the user to enter the address information (for example a telephone number) and/or the time registered and/or the sending type and/or the sending class, and/or other. GUI 210 can forward the user's entry (telephone number, time, type, class) to registry 405. Registry 405 can register the user's entry to the sending as a registration number component or components and can forward the sending and component(s) to registry 350. (Said address information can be information identifying a telephone, for example the telephone number of a telephone used by an-other party whom the user converses with.)

As a fourth example, registry 405 can detect the forwarded sending and can enable the user to provide the above-described address information. Registry 405 can employ GUI 210. GUI 210 can provide a keypad to enable the user to enter the address information (for example a telephone number). GUI 210 can forward the user's entry (for example an entered telephone number) to registry 405. Registry 405 can register the user's entry to the sending as a registration number component and can forward the sending and component to registry 350. Registry 350 can employ one or more of: time register 371, type register 372 and user-selected class register 387. Registry 350 can employ time register 371 to register the time registering the sending takes place. Registry 350 can employ type register 372 to register the type the sending comprises. (Register 372 can obtain type information included with the supplied sending to register the sending under type.) Registry 350 can employ user-selected class register 387 to register the sending under user-selected.)

For each selected sending forwarded from selector 425, register 350 can compile a registration number inclusive of each component or components registered by user-selected registry 405 and/or time register 371 and/or type register 372 and/or user-selected class register 387. Registry 350 can list the registration number in inventory 324 and can forward the inventoried sending to be stored in storage 370.

(Registry 405 can be configured to enable the user to delete, for example, to remove a sending from inventory 324 and/or from storage 370. Registry 405 can enable the user to delete a sending of any registered origin, registered type, registered time or registered class. Registry 405 can enable the user to re-register a sending.)

The exemplary user-selected sendings supplier 380 can include a user-selected default 410. User-selected default 410 functions to provide default sendings. An exemplary user-selected default 410 is depicted in FIG. 2g, shown as U.S. Default 410 and shown located at registry 350. The exemplary default 410 can include circuitry and/or programming to provide default sendings. For this exemplary default 410, default 410 can provide one or more user-selected sendings when other sendings are not available. As an example, obtainer 335 can request registry 350 forward a sending registered to a telephone number obtained by other party address register 357. Registry 350 can search inventory 324 for the requested sending. Upon registry 350 failing to locate the requested sending (for example, no sending has been supplied by the other party), registry 350 can signal default 410. Default 410 can respond by supplying a user-selected sending found in inventory 324 to act as the requested sending. Registry 350 can forward the supplied default sending, for example to dispatcher 336. Obtainer 335 can request a plurality of sendings, for example, ten sendings found in inventory 324 registered to the number obtained by register 357. Upon registry 350 locating, for example only five of the requested ten, default 410 can supply the remaining five sendings requested. Default 410 can be configured to enable the user to choose a sending or sendings to be supplied by default 410. If sendings requested comprise a given type of sending, default 410 can supply user-selected sendings of the given type. Default 410 can randomly choose sendings to supply.

A seventh example of this second embodiment is illustrated as system 10kk in FIG. 2g. This exemplary system 10kk includes sendings receiver 340, sendings registry 350, storage 370, sendings provider 375, deliverer 360, delivery trigger 390 and user-selected sendings supplier 380, and can include other party address register 357, all shown located at a telephone 27kk. Sendings supplier 380 includes sendings selector 425 and user-selected registry 405 and can include user-selected default 410. Sendings selector 425 can include one or more of: port 423, internet access 424; audio recorder 426; data entry 427; still camera 428, video camera 429, memory access 431 or service provider access 432. This seventh example can comprise the first, second, third, fourth, fifth or sixth example (and can comprise a combining of the first, second, third, fourth, fifth and/or sixth examples) and further configured to include user-selected sendings supplier 380. This seventh example can be further configured to include one or more of: deliverer picker 377; sendings picker 385; sendings call-up 396; sendings identifier 345; a sendings poster supplier 440; and a configurator 395.

For this seventh example, sendings receiver 340 includes at least one of telephone receiver 344, email receiver 351 and internet receiver 409. Sendings registry 350 can include inventory 324 and can include automatic register 401. Sendings provider 375 includes sendings obtainer 335 and sendings dispatcher 336. Deliverer 360 includes one or more of: speaker 362; display 361; text message display 366; image display 367; video display 368; email delivery 363; internet delivery 374; service provider delivery 369; delivery port 364; ring-back delivery 391; ring-back forward delivery 433; and ring-tone delivery 434. Delivery trigger 390 includes at least one of linked trigger 393 and user-deploy trigger 394. Telephone 27kk comprises mobile phone 165.

(Registry 350 can include user-selected default 410. Obtainer 335 can include prioritizer 341. Dispatcher 336 can include arranger 337. Arranger 337 can include one or more of: gallery 342; sequencer 348; and repeater 392. Identifier 345 can include one or more of: universal identifier 349; special address identifier 437; manual identifier 403; requested sendings identifier 355; and auto-requester 365. Configurator 395 can include one or more of: a configuration selector 389; an enabler 373; and a data entry 407. System 10kk can include telephone 27kk and, thus, can include phone 165. System 10kk can include caller I.D. circuitry 20. Circuitry 20 can include GUI 210 to serve as display 21 to display caller I.D. information to the user.)

For this seventh example, sendings receiver 340 can be electrically connected to (or connectable to) sendings registry 350. Registry 350 can be electrically connected to (or connectable to) storage 370. Sendings provider 375 can be electrically connected to (or connectable to) sendings registry 350 and can be electrically connected to (or connectable to) deliverer 360. Delivery trigger 390 can be electrically connected to (or connectable to) sendings provider 375. User-selected sendings supplier 380 can be electrically connected to (or connectable to) sendings registry 350.

For this seventh example, user-selected sendings supplier 380 includes circuitry and/or programming to enable employment of user-selected sendings. Supplier 380 includes sendings selector 425 and user-selected registry 405 and can include user-selected default 410. Selector 425 includes circuitry and/or programming to enable the user to select a sending. Selector 425 enables the user to select one or more of: audio sendings, text message sendings, image/picture sendings, video sendings or combined audio and video sendings. Selector 425 includes one or more of: a port 423, an internet access, 424; an audio recorder 426; a data entry 427; a still camera 428, a video camera 429, a memory access 431, a service provider access 432, and/or some other source for sendings.

For this seventh example, user-selected registry 405 includes circuitry and/or programming to register user-selected sendings. Registry 405 registers a trait (or traits) of a sending to be a component (or components) of a registration number. Registry 405 forwards the registered user-selected sending to registry 350. Registry 350 compiles said component or components into said registration number and lists said compiled registration number in inventory 324. Subsequently, the sending can be located by registry 350 searching inventory 324 for the registration number or for one or more of said components of the registration number.

For this seventh example, user-selected default 410 includes circuitry and/or programming to provide default sendings. Default 410 provides one or more user-selected sendings when other sendings are not available. As an example, registry 350 can search inventory 324 for a requested sending. Upon failing to locate the requested sending, default 410 can respond by supplying a user-selected sending found in inventory 324 to act as the requested sending. Registry 350 can forward the supplied default sending to dispatcher 336.

In prior-given examples of the first, second, third, fourth and fifth examples of this second embodiment, a sending received by receiver 340 was forwarded to received class register 328, registered, included in inventory 324 and, subsequently, provided by provider 375 to deliverer 360. In prior-given examples of the sixth example of this second embodiment, a sending received by receiver 340 was forwarded to identifier 345, identified and forwarded to identified class register 322 (or non-identified class register 327), registered, included in inventory 324 and, subsequently, provided by provider 375 to deliverer 360 and delivered by deliver 360. In the employment of user-selected sendings supplier 380, a sending selected by the user employing selector 425 can be forwarded from selector 425 to user-selected class registry 387, registered, included in inventory 324 and, subsequently, provided by provider 375 to deliverer 360 and delivered by deliverer 360. Accordingly, user-selected sendings as supplied by sendings supplier 380 can be provided and delivered wherever sendings received by receiver 340 can be provided and delivered.

User-selected class sendings can be linked trigger deployed for example employing linked trigger 393 (system 10ee, a mix of user-selected and receiver 340 received sendings can be link trigger deployed). User-selected class sendings can be user-deploy trigger deployed for example employing deploy trigger 394 (system 10ff, a mix of user-selected and receiver 340 and received sendings can be user deployed). User-selected class sendings can be picked, for example employing sendings picker 385 (a mix of sendings supplier 380 supplied sendings and receiver 340 received sendings can be provided to pick from). User-selected class sendings can be called up, for example employing sendings call-up 396 (a mix of user-selected and receiver 340 received sendings can be called up). (Sendings received by receiver 340 that provider 375 can provide include: received class sendings, identified class sendings, non-identified class sendings.)

(In one variation, system 10 can be configured to provide and deliver user-selected sendings stand-alone, i.e. not configured to also provide and deliver receiver 340 received sendings. As one example, system 10 can be configured to include registry 350, storage 370, provider 375, deliverer 360, delivery trigger 390 and user-selected sendings supplier 380. Supplier 380 supplies sendings to registry 350. Registry 350 inventories each sending supplied, includes the sending in inventory 324 and forwards the sending to storage 370. Subsequently, provider 375 can provide one or more of the user-selected sendings and deliver 360 can deliver each of the provided sendings. Trigger 390 can comprise any of the herein examples given in the triggering of provider 375. This example of the variation can include one or more of: deliverer picker 377, sendings picker 385, sendings call-up 396, sendings poster supplier 440 and configurator 395.)

This second embodiment can include an inventory review poster 440. Inventory review poster 440 functions to enable review and selection of inventoried sendings and to post selections. An exemplary inventory review poster 440 is depicted in FIG. 2h. The exemplary review poster 440 can include circuitry and/or programming to enable review and selection of inventoried sendings and to post selections. For this exemplary poster 440, poster 440 can enable the user to review inventoried sendings, for example sendings found in inventory 324, can enable the user to select a reviewed sending and can post the selected sending to a web-site. The exemplary poster 440 includes a post trigger 444, an inventoried sending reviewer 447 and a web-site poster 374 (described prior). (In one variation, poster 440 includes trigger 444, reviewer 447 and email delivery 363 and can enable review and delivery of inventoried sendings to an email account. In another variation, poster 440 can auto-post a sending. As one example, poster 440 can track each time an inventoried sending is provided and delivered. Periodically, the most employed sending can be posted, for example under a heading This Weeks Favorite. As another example, each sending provided by provider 375 can be automatically posted.)

The exemplary inventory review poster 440 includes a post trigger 444. Post trigger 444 functions to enable a user to trigger the posting of a sending. An exemplary post trigger 444 is depicted in FIG. 2h. The exemplary post trigger 444 can include GUI 210. GUI 210 is configured to be capable of being placed in electronic communication with circuitry and/or programming to enable a user to trigger the posting of a sending. In one example, GUI 210 can display a post trigger icon 442 shown as PT 442. A touched post trigger icon 442 can cause GUI 210 to respond by displaying icons representing sendings that are presently being provided for the user's review. For example, GUI 210 can display one or more of: an audio icon representing an audio sending, a text message icon representing a text message sending, an image icon representing an image sending and a video icon representing a video sending. As an example of operation, inventory reviewer 447 (described below) can simultaneously provide review of an audio sending, a text message sending and a video sending. The user decides he'd like to post the image sending. The user touches icon PT 442. For each sending under review, GUI 210 can display a representative icon. For this example, GUI 210 displays the audio icon, the image icon and the video icon. Wanting to post the image, the user touches the image icon. GUI 210 responds by forwarding the selected image sending to web-site poster 374. Poster 374 posts the sending to an internet web-site. In another example, a sending under review by a user can be a text message sending, an image sending or a video sending displayed on GUI 210. The user decides he desires to post the sending he's reviewing. For this example, the user touches the desired sending for duration to select the sending (e.g. a duration of two seconds). GUI 210 can be configured to respond to a user touching a displayed sending for a duration by forwarding the sending to web-site poster 374 to subsequently be posted to a website. GUI 210 can respond to the touched-for-duration sending by instructing provider 375 to provide the sending to poster 374. (Poster 440 can be configured to delete a reviewed sending. As an example, the user touching icon 442 three times followed by a representative icon can signal poster 440 to delete the sending represented by the icon from inventory 324.)

The exemplary inventory review poster 440 includes an inventoried sending reviewer 447. Inventoried sending reviewer 447 functions to provide a review of an inventoried sending. An exemplary sending review 441 is depicted in FIG. 2h. The exemplary inventoried sending reviewer 447 can include circuitry and/or programming to provide a review of an inventoried sending. For this exemplary reviewer 447, reviewer 447 can provide a review of an inventoried sending to a user. A sending provided for review can be, for example, a sending found in inventory 324. Said review can comprise a first experience as the user may not have seen and/or heard the sending prior. Upon seeing and/or hearing the sending from the provided review, a user can employ post trigger 444 to trigger the posting of the sending. If the user triggers the sending, reviewer 447 can instruct provider 375 to provide the sending to web-site poster 374. Poster 374 can post the sending to an internet web-site. Inventoried sending reviewer 447 can include one or more of: a delivery provided review 448, a picker provided review 449 and a call-up provided review 451.

Inventoried sending reviewer 447 can include a delivery trigger provided review 448. Delivery trigger provided review 448 functions to operate in conjunction with a delivery trigger to provide a review of a sending. An exemplary delivery trigger provided review 448 is depicted in FIG. 2h, shown as Pr 448 located at delivery trigger 390. The exemplary review 448 can employ a delivery trigger, for example delivery trigger 390, to provide a review of a sending to a user.

As a first example of reviewer 448, reviewer 448 can operate in conjunction with delivery trigger 390 with delivery trigger 390 comprising linked trigger 393. As one example of operation, a telephone call is received from an-other party (or the other party is dialed). Other party address register 357 obtains the other party's telephone's number. A signal representing detection of the incoming call (or of the dialed number) triggers linked trigger 393. Trigger 393 signals obtainer 335. Obtainer 335 requests registry 350 forward all sendings registered to the obtained telephone number. Registry 350 forwards said sendings to dispatcher 336. For this example, registry 350 forwards an audio sending and image sending. Dispatcher 336 employs audio player 338 to dispatch the audio sending to speaker 362 of deliverer 360. Speaker 362 broadcasts the audio sending enabling the user to review the sending and decide whether to select the sending for posting to a web-site. Dispatcher 336 also employs image feed 343 to dispatch the image sending to image display 367 of deliverer 360. Display 367 displays the image sending enabling the user to review the sending and decide whether to select the sending for posting. To select a sending, the user triggers post trigger 444 by touching post trigger icon 442. Acting as trigger 444, GUI 210 responds to the touched icon by displaying icons representing the sendings delivered for review, for this example an audio icon and an image icon. The user desires to post the audio sending and, so, touches the audio icon. GUI 210 responds by instructing provider 375 to provide the audio sending. Provider 375 responds by dispatching the selected audio sending to web-site poster 374.

As a second example of reviewer 448, reviewer 448 can operate in conjunction with delivery trigger 390 with delivery trigger 390 comprising deploy trigger 394. As one example of operation, a telephone call is received from an-other party. Other party address register 357 obtains the other party's telephone's number. Either prior to answering, while conversing or after hang-up, the user triggers deploy trigger 394. System 10 responds to trigger 394 as described-above in response to trigger 393. One or more sendings are delivered. The delivered sendings provide a review for the user. From the review, the user can decide to trigger post trigger 444 to select one (or more) of the one or more reviewed sendings for posting. GUI 210 can respond to a sending selection by instructing provider 375 to provide the selected sending to web-site poster 374.

Inventoried sending reviewer 447 can include a picker provided review 449. Picker provided review 449 functions to operate in conjunction with a picker to provide a review of a sending. An exemplary picker provided review 449 is depicted in FIG. 2h, shown as Pi 449 located at sending picker 385. The exemplary review 449 can employ a picker, for example sending picker 385, to provide a review of a sending to a user.

As an example of operation, reviewer 448 can operate in conjunction with sendings picker 385. As one example of operation, a telephone call is received from an-other party (or the other party is dialed). Other party address register 357 obtains the other party's telephone's number. Responsive to a signal representing detection of the incoming call (or of the dialed number), register 357 provides the obtained number to registry 350 and registry 350 responds by forwarding the registration number to GUI 210 of each sending found in inventory 324 registered to that telephone number. GUI 210 then employs the registration number information to display picker 385 icon array 352, array 352 comprising one icon representing each forwarded registration number. The icons displayed can comprise the date registered and a representation of the represented sending. The representation can be a miniature of the image sending, a frame from the video, the title of the song (audio), the beginning words of the text message etc. For this example, the call is answered (either by called party or by user).

In a first example, while conversing, from viewing the displayed icons the user decides to post one of the sendings represented by one of the displayed icons. The user touches post trigger icon 442 followed by the icon representing the selected sending. Acting as trigger 444, GUI 210 responds to the touched icon 442 followed by the touch picker 385 icon by forwarding the registration number of the sending to provider 375 and instructing provider 375 to provide the sending. Provider 375 responds by obtaining and dispatching the sending to web-site poster 374.

In a second example, while conversing, from viewing the displayed icons the user decides he'd like a more in-depth review of a particular icon represented sending. The user touches post trigger icon 442 twice followed by touching the particular icon. GUI 210 responds to the twice touched icon 442 followed by the touch icon of picker 385 by forwarding the registration number of the selected sending to provider 375 and instructing provider 375 to obtain and dispatch the sending. Provider 375 responds by obtaining and dispatching the sending to a delivery available to the user. For example, if the sending is audio, provider 375 can dispatch the sending to speaker 362. For the speaker 362 example, the user is enabled to listen to the audio sending. The user decides to post the sending. To do so, the user again twice touches icon 442. GUI 210 responds to the twice-touched icon 442 by forwarding the registration number of the more in-depth reviewed sending to provider 375 and instructing provider 375 to provide the sending. Provider 375 responds by obtaining and dispatching the sending to web-site poster 374.

Inventoried sending reviewer 447 can include a call-up provided review 451. Call-up provided review 451 functions to employ a call-up to provide a review of a sending. An exemplary call-up provided review 451 is depicted in FIG. 2h, shown as CR 451 located at sendings call-up 396. The exemplary review 451 can employ a call-up, for example sendings call-up 396, to provide a review of a sending to a user.

As an example of operation, reviewer 448 can operate in conjunction with sendings call-up 396. As one example of operation, the user employs sendings call-up 396 by entering a telephone number, for example of a familiar party. Call-up 396 requests from registry 350 the registration numbers of all sendings found in inventory 324 registered to the entered number. Registry 350 provides the requested registration numbers. GUI 210 then employs the registration number information to display one icon to represent each forwarded registration number. The icons displayed can comprise the date registered and a representation of the represented sending. The representation can be a miniature of the image sending, a frame from the video, the title of the song (audio), the beginning words of the text message etc. For this example, the call is answered (either by called party or by user).

In a first example, from viewing the displayed icons the user decides to post one of the sendings represented by one of the displayed icons. The user touches post trigger icon 442 followed by the icon representing the selected sending. Acting as trigger 444, GUI 210 responds to the touched icon 442 followed by the touch call-up 396 icon by forwarding the registration number of the sending to provider 375 and instructing provider 375 to provide the sending. Provider 375 responds by obtaining and dispatching the sending to web-site poster 374.

In a second example, from viewing the displayed icons the user decides he'd like a more in-depth review of a particular icon represented sending. The user touches post trigger icon 442 twice followed by touching the particular icon. GUI 210 responds to the twice-touched icon 442 followed by the touch call-up 396 icon by forwarding the registration number of the selected sending to provider 375 and instructing provider 375 to obtain and dispatch the sending. Provider 375 responds by obtaining and dispatching the sending to a delivery available to the user. For example, if the sending is a video, provider 375 can dispatch the sending to video display 368. For the display 368 example, the user is enabled to view/watch the video for a duration to make his posting decision. The user decides to post the sending. The user again twice touches icon 442. GUI 210 responds to the twice-touched icon 442 by forwarding the registration number of the more in-depth reviewed sending to provider 375 and instructing provider 375 to provide the sending. Provider 375 responds by obtaining and dispatching the sending to web-site poster 374.

The exemplary inventory review poster 440 includes web-site poster 374 (described prior). Web-site poster 374 functions to post sendings to an internet web-site. An exemplary post trigger 444 is depicted in FIG. 2h. The exemplary post trigger 447 can include GUI 210. GUI 210 is configured to be capable of being placed in electronic communication with circuitry and/or programming to post a sending to an internet web-site. This example of poster 374 can post, for example: an audio sending, a text message sending, an image sending, a video sending, a combination video/audio sending or other. As an example, an inventory reviewer 447 can provide a review of an inventoried sending to a user. Upon seeing and/or hearing the sending from the provided review, a user can employ a post trigger 444 to trigger the posting of the sending. A triggered trigger 447 can instruct provider 375 to provide the sending to web-site poster 374. Provider 375 can provide the sending by employing file dispatcher 347 to dispatch the sending to web-site poster 374. Poster 374 can post the sending to an internet web-site by delivering the sending inclusive of an internet address for receipt at an internet web-site, said receipt at an internet web-site can be via an internet service provider and can be via the internet. Said internet service provider can be accessed by poster 374 via service provider 121 or via a wifi internet connection or via internet access provided by provider 121 or via some other pathway or service provider 121 can be the internet service provider. Web-site poster 374 includes a web-site poster addresser 381 and can include one or more of a manual poster 453 and an auto poster 454 (poster addresser 381, a manual poster 453 and auto poster 454 described prior).

An eighth example of this second embodiment is illustrated as system 10ll in FIG. 2h. This exemplary system 10ll includes sendings receiver 340, sendings registry 350, storage 370, sendings provider 375, deliverer 360, delivery trigger 390 and inventory review poster 440, and can include other party address register 357, all shown located at a telephone 27ll. This eighth example can comprise the first, second, third, fourth, fifth, sixth or seventh example (and can comprise a combining of the first, second, third, fourth, fifth, sixth and/or seventh examples), and further configured to include review poster 440. Review poster 440 includes post trigger 444, sending review 441 and include internet poster 374. This eighth example can be further configured to include one or more of: sendings picker 385; deliverer picker 377; sendings call-up 396; sendings identifier 345; user-selected sendings supplier 380; and a configurator 395.

For this eighth example, sendings receiver 340 includes at least one of telephone receiver 344, email receiver 351 and internet receiver 409. Sendings registry 350 includes inventory 324 and includes automatic register 401 and inventory 324. Sendings provider 375 includes sendings obtainer 335 and sendings dispatcher. Deliverer 360 includes one or more of: speaker 362; display 361; text message display 366; image display 367; video display 368; email delivery 363; web-site poster 374; service provider delivery 369; delivery port 364; ring-back delivery 391; ring-back forward delivery 433; and ring-tone delivery 434. Delivery trigger 390 can include at least one of linked trigger 393 and user-deploy trigger 394. Telephone 27jj comprises mobile phone 165.

(Registry 350 can include user-selected default 410. Obtainer 335 can include prioritizer 341. Dispatcher 336 can include arranger 337. Arranger 337 can include one or more of: gallery 342; sequencer 348; and repeater 392. Identifier 345 can include one or more of: universal identifier 349; special address identifier 437; manual identifier 403; requested sendings identifier 355; and auto-requester 365. System 10ll can include telephone 27ll and, thus, can include phone 165. System 10ll can include caller I.D. circuitry 20. Circuitry 20 can include GUI 210 to serve as display 21 to display caller I.D. information to the user.)

For this eighth example, sendings receiver 340 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. Delivery trigger 390 can be electrically connected to (or connectable to) sendings provider 375. Operating as trigger 444, GUI 210 can be electrically connected to (or connectable to) sendings provider 375.

For this eighth example, inventory review poster 440 includes circuitry and/or programming to enable review and posting of inventoried sendings. Poster 440 enables the user to review inventoried sendings, for example sendings found in inventory 324, enables the user to select a reviewed sending and posts the selected sending to a web-site. Poster 440 includes post trigger 444, inventoried sending reviewer 447 and web-site poster 374.

This second embodiment can include a configurator 395. Configurator 395 functions to enable a user to configure operation. An exemplary configurator 395 is depicted in FIG. 2i. The exemplary configurator 395 can include circuitry and/or programming to enable a user to configure operation. The exemplary configurator 395 can include one or more of: a configuration selector 389, an enabler 373 and a data entry 407. The exemplary configurator 395 can provide a user with options to select from to configure system operation. For example, configurator 395 can enable a user to configure the system to operate as any of the prior-described embodiments (systems 10ee through 10kk). Configurator 395 is depicted in FIG. 2i employed with an embodiment comprising a combining of systems 10ee through 10kk. Configurator 395 can include GUI 210. To operate as configurator 395, GUI 210 is configured to be capable of being placed in electronic communication with circuitry and/or programming to enable a user to configure operation. GUI 210 can operate as one or more of: configuration selector 389, enabler 373 and data entry 407. (Configurator 395 is shown electrically connected to sendings receiver 340, sendings registry 350, storage 370, sendings provider 375, deliverer 360, delivery trigger 390, sendings identifier 345 and sendings supplier 380 with those components electrically interconnected as shown: receiver 340 electrically connected to identifier 345, identifier 345 connected to registry 350, registry 350 connected to storage 370 and to provider 375, provider 375 connected to deliverer 360 and trigger 390 connected to provider 375. In this configuration, configurator 395 can provide instruction to the connected-to components (e.g. program routines, enable and/disable components etc.) and the components can electrically interact to implement system operation. In another configuration example, configurator 395 can be electrically to the components as shown and the components can electrically interact via their common connection to configurator 395.)

Configurator 395 can include a configuration selector 389. Configuration selector 389 functions to enable a user to select a configuration. An exemplary selector 389 is depicted in FIG. 2i, shown as Con. Sel. 389 located at GUI 210. The exemplary selector 389 can enable a user to select a configuration. Selector 389 can then implement the configuration selected by the user by enabling and/or disabling one or more components and/or one or more operating routines. The exemplary selector 389 can include GUI 210. To operate as selector 389, GUI 210 can include circuitry and/or programming to enable a user to select a configuration. GUI 210 can provide a plurality of configurations for the user to select a configuration from. Each of the plurality of configurations can comprise a unique combination of components and/or operating routines. GUI 210 can be electrically connected to (or connectable to) one or more of: sendings receiver 340; sendings registry 350; storage 370; sendings provider 375; deliverer 360; and delivery trigger 390 and to one or more of: picker 377; picker 385; call-up 396; identifier 345; sendings supplier 380; and review poster 440.

Selector 389 can provide a plurality of configurations, for example, by varying: the components employed in the system, operating routines, the cadence (timing) of the interaction of components, mathematics variables employed, and duration lengths. The following are examples of varying the components employed. Configurator 395 can vary employment combinations of: picker 377, picker 385, call-up 396, identifier 345 and supplier 380 seventeen different ways (seventeen combinations); receiver 340 components: telephone receiver 344, email receiver 351 and Internet receiver 409 (seven combinations); identifier 345 components: identifiers 422, 399 and 397; and, triggers 393 and 394. Configurator 395 can vary the operating routines of one or more of (components employed by the above components): receiver 340; identifier 345; registry 350; sendings supplier 380; storage 370; sendings provider 375; deliverer 360; delivery trigger 390; sendings picker 385; deliverer picker 377; call-up 396; identifier 345; supplier 380; and configurator 395. Configurator 395 can vary the operating routines of one or more of: GUI 210; requested identifier 355; automatic register 401; user-selected default 410; sendings selector 425; sendings registry 405; linked trigger 393; deploy trigger 394; prioritizer 341; arrangers 342 and 348; dispatchers 338, 339, 343, 346 and 347; displays 366, 367 and 368; deliverers 362, 391, 364, 369, 374, 363, 433 and 434; type picker 354; class picker 406; message picker 411; deliverer picker 412; configurator selector 425; enabler 373; and data entry 407.

An example to illustrate the large number of configurations that configurator 395 could provide for the user to choose from will now be given. An embodiment of system 10 includes sendings receiver 340, sendings registry 350, storage 370, sendings provider 375, deliverer 360 and delivery trigger 390 and can include deliverer picker 377, sendings picker 385, sendings call-up 396, sendings identifier 345 and sendings supplier 380. “Included” components can be combined to the “can include” components in 26 different configurations. (Configuration examples: the includes plus picker 377, the includes plus picker 385, the includes plus picker 377 plus call-up 396, etc.) A system comprising just the includes can be configured to provide at least 5098 different response combinations as discussed prior for system 10ee. Multiplying the 26 different configurations by 5098 different responses suggests 131,448 different overall configurations that configurator 395 can provide (without figuring in cadence, mathematics variables and duration lengths). These 131,448 combinations represent the combining of only the major system components. In other words, this second embodiment can be configured tens of thousands of ways.

Configurator 395 can include an enabler 373. Enabler 373 functions to enable a user to enable and/or disable functionality. An exemplary enabler 373 is depicted in FIG. 2i, shown as Enabler 373, shown located at GUI 210. The exemplary enabler 373 can enable a user to enable and/or disable one or more components and/or operating routines. The exemplary enabler 373 can include GUI 210. To operate as enabler 373, GUI 210 can include circuitry and/or programming to enable a user to enable and/or disable functionality. GUI 210 can provide the status of components and/or program routines to a user and can enable the user to enable and/or disable said components and/or operating routines. GUI 210 can be electrically connected to (or connectable to) one or more of: sendings receiver 340, sendings registry 350, storage 370, sendings provider 375, deliverer 360 and delivery trigger 390 and to one or more of picker 377, picker 385, call-up 396, identifier 345, sendings supplier 380 and review poster 440.

Enabler 373 can enable a user to enable and/or disable and/or to enable/disable program routines employed by, for example: receiver 340, identifier 345, registry 350, sendings supplier 380, storage 370, sendings provider 375, deliverer 360, delivery trigger 390, sendings picker 385, deliverer picker 377, call-up 396, identifier 345, supplier 380, configurator 395. The following are examples of components employed by the above components that enabler 373 can enable a user to enable and/or disable and/or to enable/disable program routines employed by: GUI 210, requested identifier 355, automatic register 401, user-selected default 410, sendings selector 425, sendings registry 405, linked trigger 393, deploy trigger 394, prioritizer 341, arrangers 342 and 348, dispatchers 338, 339, 343, 346 and 347, displays 366, 367 and 368, deliverers 362, 391, 364, 369, 374, 363, 433 and 434, type picker 354, class picker 406, message picker 411, deliverer picker 412, configurator selector 425, enabler 373 and data entry 407.

Configurator 395 can include a data entry 407. Data entry 407 functions to enable a user to enter information. An exemplary data entry 407 is depicted in FIG. 2i, shown as D. Entry 407, shown located at GUI 210. The exemplary data entry 407 can provide data entry facility to enable the user to enter information. The exemplary data entry 407 can include GUI 210. To operate as entry 407, GUI 210 can include circuitry and/or programming to enable a user to enter information. GUI 210 can provide for review of prior-entered existing information and can provide a keyboard for the user to enter information. GUI 210 can be electrically connected to (or connectable to) one or more of: sendings receiver 340; sendings registry 350; storage 370; sendings provider 375; deliverer 360; and delivery trigger 390 and to one or more of picker 377; picker 385; call-up 396; identifier 345; supplier 380; and review poster 440.

Data entry 407 can enable a user to enter, for example, one or more of: beginning and end times for telephone call time window 422; beginning and end times and/or dates for time of day time window 399; addressing codes for special identifier 437; addressing for one or more of addressers 386, 381 and 379; system cadence parameters; mathematics variables; and duration lengths.

An example of GUI 210 operating as selector 387, enabler 373 and entry 407 will now be given. A “configurator” option is included on an opening display on GUI 210. The user touches the “configurator” icon. A next screen presents three options: “selector”, “enabler” and “data entry”. As a first example, the user touches the “selector” icon. A next screen presents a plurality of operation configurations for the user to pick from. The user picks (touches) one of the configuration icons. GUI 210 engages the components and/or programming to implement the picked configuration.

As a second example, the user touches the “enabler” icon. A next screen presents components and operation routines available for the user to enable and/or disable and presents the present status of each. The user picks (touches) one of the component icons or operation routine icons. GUI 210 responds by changing the status of the component or routine accordingly (e.g. if on, GUI 210 changes to off).

As a third example, the user touches the “data entry” icon. A next screen presents routines that employ user-entered variables. For example the next screen can present: “telephone call time window”, “time of day time window”, “special identifier”, “provider delivery addresser”, “web-site poster addresser” and “email delivery addresser”. For this example, the user touches the “provider delivery addresser” icon. A next screen presents prior-entered existing information (e.g. last telephone number entered) and a keyboard for the user to enter addressing (e.g. a telephone number). The user enters a number. Subsequently, GUI 210 employs the entered number to address a sending for delivery by service provider 121.

A ninth example of this second embodiment is illustrated as system 10mm in FIG. 2i. This exemplary system 10mm includes sendings receiver 340, sendings registry 350, storage 370, sendings provider 375, deliverer 360, delivery trigger 390 and configurator 395, and can include other party address register 357, all shown located at a telephone 27mm. This ninth example can comprise the first, second, third, fourth, fifth, sixth or seventh example (and can comprise a combining of the first, second, third, fourth, fifth, seventh and/or eighth examples), and further configured to include configurator 395. Configurator 395 can include one or more of configuration selector 389, enabler 373 and data entry 407. This ninth example can be further configured to include one or more of sendings picker 385; deliverer picker 377; sendings call-up 396; sendings identifier 345; user-selected sendings supplier 380; and inventory review poster 440.

For this ninth example, sendings receiver 340 includes at least one of telephone receiver 344, email receiver 351 and internet receiver 409. Sendings registry 350 includes inventory 324 and can include automatic register 401. Sendings provider 375 includes sendings obtainer 335 and sendings dispatcher. Deliverer 360 includes one or more of: speaker 362; display 361; text message display 366; image display 367; video display 368; email delivery 363; web-site poster 374; service provider delivery 369; delivery port 364; ring-back delivery 391; ring-back forward delivery 433; and ring-tone delivery 434. Delivery trigger 390 can include at least one of linked trigger 393 and user-deploy trigger 394. Telephone 27jj comprises mobile phone 165.

(Registry 350 can include user-selected default 410. Obtainer 335 can include prioritizer 341. Dispatcher 336 can include arranger 337. Arranger 337 can include one or more of gallery 342; sequencer 348; and repeater 392. Identifier 345 can include one or more of: universal identifier 349; special address identifier 437; manual identifier 403; requested sendings identifier 355; and auto-requester 365. System 10mm can include telephone 27mm and, thus, can include phone 165. System 10mm can include caller I.D. circuitry 20. Circuitry 20 can include GUI 210 to serve as display 21 to display caller I.D. information to the user.)

For this ninth example, sendings receiver 340 can be electrically connected to (or connectable to) sendings registry 350. Sendings registry 350 can be electrically connected to (or connectable to) storage 370. Sendings provider 375 can be electrically connected to (or connectable to) sendings registry 350 and can be electrically connected to (or connectable to) deliverer 360. Delivery trigger 390 can be electrically connected to (or connectable to) sendings provider 375. Operating as configurator 395, GUI 210 can be electrically connected to (or connectable to) sendings receiver 340, sendings registry 350, storage 370, sendings provider 375, deliverer 360 and delivery trigger 390 and to one or more of picker 377, picker 385, call-up 396, identifier 345 and supplier 380.

For this ninth example, configurator 395 includes one or more of: a configuration selector 389; an enabler 373; and a data entry 407. Configurator 395 provides a user with options to select from to configure system operation. Configurator 395 includes GUI 210. To operate as configurator 395, GUI 210 includes circuitry and/or programming to enable a user to configure operation. GUI 210 operates as one or more of configuration selector 389, enabler 373 and data entry 407.

A first example of operation of this ninth example of the second embodiment (system 10mm) will now be given. This example comprises a combining of the first, second, third, fourth and fifth examples and further configured to include configurator 395. For this example, configurator 395 includes configuration selector 389, enabler 373 and data entry 407.

A “configurator” option is included on an opening display on GUI 210. The user touches the “configurator” icon. A next screen presents three options: “selector”, “enabler” and “data entry”. The user touches the “selector” icon. A next screen presents a plurality of configurations for the user to pick from. The plurality of configurations comprises the prior-given examples of operation of this second embodiment: 1EX1, 1EX2, 1EX3, 1EX4, 1EX5, 1EX6, 1EX7, 1EX8, 2EX1, 2EX2, 2EX3, 2EX4, 2EX5, 3EX1, 3EX2, 3EX3, 4EX1, 4EX2, 4EX3, 5EX1, 5EX2, 5EX3, 5EX4 and 5EX5. The user picks (touches) one of the configuration icons. For example, the user picks 2EX2. GUI 210 responds to the user pick by engaging the components and/or programming to implement 2EX2, in other words to implement the second example of operation for the second example (system 10ff) of this second embodiment. Subsequently, sendings are provided and delivered as described in the second example of operation for the second example.

A second example of operation of this ninth example of the second embodiment (system 10mm) will now be given. For this example, system 10mm can comprise the first, second, third, fourth, fifth, sixth or seventh example (and can comprise a combining of the first, second, third, fourth, fifth, sixth and/or seventh examples), and further configured to include configurator 395. For this example, configurator 395 includes configuration selector 389, enabler 373 and data entry 407.

A “configurator” option is included on an opening display on GUI 210. The user touches the “configurator” icon. A next screen presents three options: “selector”, “enabler” and “data entry”. The user touches the “selector” icon. A next screen presents a plurality of configurations for the user to pick from. The plurality of configurations can comprise, for example: a first icon representing a basic configuration including receiver 340, registry 350, storage 370, provider 375, deliverer 360, delivery trigger 390 and configurator 395; a second icon representing the basic configuration plus register 357; a third icon representing basic plus picker 385, a fourth icon representing basic plus call-up 396, a fifth icon representing basic plus identifier 345, a sixth icon representing basic plus supplier 380, a seventh icon representing basic plus poster 440, eighth icon—basic plus register 357 plus picker 385, ninth icon—basic plus register 357 plus call-up 396, etc.

The user selects (touches) one of the configuration icons. For example, the user selects the third icon. GUI 210 responds by implementing a component configuration comprising receiver 340, registry 350, storage 370, provider 375, deliverer 360, delivery trigger 390, configurator 395 and picker 385 and by presenting a next screen. In the next screen, GUI 210 presents a plurality of enabler options available for incorporation with the selected third icon configuration. The plurality of enabler options can comprise icons, for example: “identifier”, “link trigger”, “user trigger”, “speaker type”, “display”, “ring-back delivery”, “port”, “web-site poster”, “ring-back forward delivery”, “type picker”, “class picker” and “Finished”.

The user selects (touches) one of the enabler option icons. For example, the user selects “web-site poster”. GUI 210 responds by enabling ring-back delivery. GUI 210 presents a next screen. In the next screen, GUI 210 again presents the plurality of enabler options available for incorporation with the selected third icon configuration (along with indication that web-site poster has been enabled). The user selects (touches) one of the enabler option icons. For example, the user selects “Finished”. In a next screen, GUI 210 presents data entry options available for incorporation with the selected third icon configuration and the selected web-site poster. The data entry options can be, for example: “web-site poster addressing” and finished. For example, the user selects “web-site poster addressing”. GUI 210 presents a next screen comprising a keypad and a “Finished” icon. The user can employ the keypad to enter an address when completed can touch “Finished” GUI 210 stores the entered address and presents a next screen presenting “Thank You!”. Subsequently, provider 375 can dispatch sendings to web-site poster 374 addressed to the entered address.

A tenth example of this second embodiment is illustrated as system 10nn in FIG. 2j. This example includes all of the components illustrated in FIG. 10i with the exception of configurator 395. In this configuration, absent configurator 395 enabling a user to configure operation, system 10 can comprise a fixed configuration for operation. This embodiment can comprise a combining of systems 10ee through system 10ll. This embodiment can provide a combination of all of the prior described functionality of systems 10ee through 10ll.

In summary, the second embodiment (FIGS. 2a through 2j) preferably operates by: receiving sendings; inventorying each received sending; storing each inventoried sending; providing one or more sending responsive to a triggering and; delivering the provided one or more sending. The second embodiment can preferably additionally operate by one or more of: enabling a user to pick a sending from a plurality of sendings to pick from; enabling a user to call up a sending; identifying a sending; enabling employment of user-selected sendings; supplying sendings for posting, and, enabling a user to configure operation.

Commencer 325 has been depicted in FIGS. 1a through 1d comprising a diagrammatic block. Commencer 325 has been described comprising user interface 99. Interface 99 as disclosed can comprise circuitry and/or programming. However, commencer 325 as disclosed merely houses user interface 99 or detector 311 and, thus, commencer has been included not as an operational component but, instead, to describe the operations of user interface 99 or detector 311 relative to the associated embodiment.

Described prior sendings supplied by user-selected sendings supplier 425 can be inventoried and stored. Said information can be re-selected and again supplied by user-selected sendings supplier 425 to be inventoried and stored, re-selecting to include selecting a new/next/subsequent choice of sending. A user can select sendings from any number of sources such as: libraries on the internet via a computer or a WiFi connection (if system 10 is WiFi enabled) or provider 121, a music player, a recording device, libraries stored in handling system 10 itself, libraries stored in mobile phone 165, libraries stored at service provider 121. (Said libraries on the internet may be found on a service provider web site, a telephone manufacturer web site, a music web site or other. The stored information can also be stored on one or more memory devices which can be made accessible to the user via a service provider. The stored information can be stored elsewhere, for example, elsewhere at system 10 or elsewhere at telephone 27, or other.)

Handling systems 10aa through 10nn can reside with and as the property of the telephone user as illustrated in FIGS. 1a through 2j. Alternately, handling systems 10aa through 10nn can lend similar benefit to the user when provided by telephone service provider 121.

The embodiments of telephone call handling system 10 herein disclosed in FIGS. 1a through 1d are shown as functional when located between service provider 121 and telephone 27 with control buttons and display 21 located at telephone 27. The embodiments of system 10 disclosed in FIGS. 2a through 2j are shown functional when located at telephone 27 (phone 165) with the functionality of control buttons and display provided by a graphic user interface also located at telephone 27. (Voice recognition of voice instruction can be employed in place of or in addition to said buttons or GUI 210.)

Additionally, system 10 can be located otherwise. For example, system 10 can be located at service provider 121 with control buttons and display 21 (and/or GUI 210) located at telephone 27. For example, one or more of the components of system 10 can be located at provider 121 with the remainder of the components located at telephone 27 with control buttons and display 21 (and/or GUI 210) located at telephone 27. For example, system 10 can be located in-part at the base of a cordless telephone and in-part at the cordless telephone itself. For example, system 10 can be located in-part at a service provider 121, in-part located between service provider 121 and telephone 27 and with control buttons and display 21 (and/or GUI 210) located at telephone 27. For example, system 10 can be located in-part at a service provider 121 and in-part located between service provider 121 and telephone 27, with control buttons and display 21 (and/or GUI 210) located between service provider 121 and telephone 27 and with control buttons and display (and/or GUI 210) located at telephone 27. For example, system 10 can be located in-part at a service provider 121, in-part located between service provider 121 and telephone 27, in-part at telephone 27 and with control buttons and display 21 (and/or GUI 210) located at telephone 27. For example, service provider 121 can provide phone service along with cable television service. A television screen can then comprise display 21 and system 10 can be located, for example, at telephone 27 (or at a cable control box or at other). Telephone 27 can be electrically connected to (or connectable to) a cable control box (user's home) and control buttons (and/or GUI 210) can be located at telephone 27 and/or can be located on a remote control associated with the cable box and/or can be located at the cable box (or other cable/phone configurations).

Telephone 27 can comprise a corded landline telephone, a cellular telephone, a cordless landline phone, or other. Any embodiment herein disclosed employing (or operating in conjunction with) a landline telephone can be configured to employ (or to operate in conjunction) with a cellular telephone. Any embodiment herein disclosed employing (or operating in conjunction) with a cellular telephone can be configured to employ (or operate in conjunction) with a landline telephone.

It is understood that the above examples of the various embodiments provided for herein can be implemented using alternative means and structures to provided essentially equivalent functionality, and that the scope of the present invention is not to be limited by these examples. As an example, the specific content of messages which can be provided to a caller by the systems described herein can vary from the given examples, without varying from the general scope of a respective embodiment. Further, the functionality provided by the interface 31 (i.e., of generating an off-hook signal in order to enable outgoing transmissions of information to the caller) can be accomplished using other known circuitry and/or software implementations. In general, the systems described herein include circuitry and/or software implementations to enable information to be sent to a caller telephone without necessarily placing the called phone in a call-answered condition.

I claim:

1. A telephone call handling system, the system comprising:
a sendings receiver configured to receive sendings sent from an other party's telephone via a telephone service;
a sendings registry configured to automatically inventory the received sendings;
a storage configured to store the inventoried sendings;
a sendings provider configured to provide at least one of the inventoried sendings;
a deliverer configured to deliver the provided sendings; and
a delivery trigger configured to initiate the provider to provide the at least one of the inventoried and stored sendings.

2. The telephone system of claim 1 and wherein the delivery trigger is further configured to be triggered by a user.

3. The telephone system of claim 1 and wherein the system further includes caller I.D. circuitry to provide caller I.D. information to the user and the user can trigger the trigger based on the caller I.D. information.

4. The telephone system of claim 1 and wherein the delivery trigger is further configured to be triggered linked to an activity.

5. The telephone system of claim 1 and wherein the sendings provider comprises a prioritizer to prioritize the providing of at least one of the inventoried sendings.

6. The telephone system of claim 1 and wherein the system further comprises a sending review poster to supply sendings for posting at an internet website.

7. The telephone system of claim 1 and wherein the system further comprises at least one of: a sendings picker, a deliverer picker, a sendings call-up, a sendings identifier, a user-selected sendings supplier, a inventory review poster and a configurator.

8. The telephone system of claim 7 and wherein the sendings identifier comprises a universal identifier to identify a feature that can be employed absent any specialized hardware and/or programming at the sending device.

9. The telephone system of claim 7 and wherein the sendings identifier comprises a requested sendings identifier to identify a requested sending.

10. The telephone system of claim 7 and wherein the sendings picker comprises at least one of: a sendings type picker and a sendings class picker.

11. A method for delivering sendings, the method comprising:
receiving sendings sent from an other party's telephone via a telephone service;
inventorying the received sendings automatically;
storing the inventoried sendings;
providing at least one of the inventoried sendings, said providing initiated by a trigger; and
delivering the provided sending or sendings.

12. The method of claim 11 and wherein the providing at least one of the inventoried sendings, said providing initiated by a trigger further comprises enabling a user to trigger the trigger.

13. The method of claim 11 and wherein the method further comprise providing caller I.D. information to the user enabling the user to trigger the trigger based on the caller I.D. information.

14. The method of claim 11 and wherein the providing at least one of the inventoried sendings, said providing initiated by a trigger further comprises triggering the trigger linked to an activity.

15. The method of claim 11 and wherein the providing of at least one of the inventoried sendings is prioritized.

16. The method of claim 11 and wherein the method further comprises supplying sendings for posting on an internet website.

17. The method of claim 11 and further comprising at least one of: enabling a user to pick a sending from a plurality of sendings to pick from; enabling a user to call up a sending; identifying a sending; enabling employment of user-selected sendings; and, enabling a user to configure operation.

18. The method of claim 17 and wherein identifying a sending further comprises identifying a feature that can be employed absent any specialized hardware and/or programming at the sending device.

19. The method of claim 17 and wherein identifying a sending further comprises identifying a requested sending.

20. The telephone system of claim 17 and wherein enabling a user to pick a sending further comprises at least one of: enabling a user to pick a type of sending and enabling a user to pick a class of sending.
